(19) United States
(12) Patent Application Publication
(10) Pub. No.: US 2026/0158489 A1
(43) Pub. Date: Jun. 11, 2026

(54) PSEUDO FLOW CELLS

(71) Applicant: 10x Genomics, Inc., Pleasanton, CA (US)

(72) Inventors: Martin Sauzade, Pleasanton, CA (US); Francis Cui, Oakland, CA (US); Yiran Zhang, Castro Valley, CA (US)

(21) Appl. No.: 19/410,729

(22) Filed: Dec. 5, 2025

Related U.S. Application Data
(60) Provisional application No. 63/728,517, filed on Dec. 5, 2024.
(60) Provisional application No. 63/740,056, filed on Dec. 30, 2024.

(51) Int. Cl. B01L 3/00

(52) U.S. Cl. CPC B01L 3/502715; B01L 2200/025; B01L 2200/16; B01L 2300/0663; B01L 2300/0816; B01L 2300/0877; B01L 2300/168

(57) ABSTRACT

The system comprises a flow cell body, first reservoir, and a second reservoir. The flow cell body comprises a bottom layer and a top layer defining a fluidic channel therebetween. The fluidic channel extends along the flow cell body and has an inlet at a first side of the flow cell body and an outlet at a second side of the flow cell body, and a central portion disposed therebetween. The first reservoir is disposed proximate to and in fluidic communication with the inlet. The first reservoir includes at least one sidewall formed in a portion of the top layer of the flow cell body that defines an opening configured to receive at least one reagent. The second reservoir is formed in the top layer and comprises a base that is optically clear. The bottom layer is configured to receive a substrate having a biological sample disposed thereon.

### CROSS-REFERENCE TO RELATED APPLICATIONS

This application claims the benefit of priority to U.S. Provisional App. No. 63/728,517, filed on Dec. 5, 2024, and U.S. Provisional App. No. 63/740,056, filed on Dec. 30, 2024. The entire contents of each are hereby incorporated by reference in their respective entireties.

### FIELD

The present disclosure relates to systems and devices for delivering a liquid reagent to a sample and/or detecting the near-depletion of a liquid reagent in a reservoir of a pseudo flow cell.

### BACKGROUND

Many biomedical applications rely on high-throughput assays of biological samples contacted with one or more reagents using flow devices (e.g., open well flow cells and closed flow cells). For example, in both research and clinical applications, high-throughput assays using target-specific reagents for analyzing molecules present in a biological sample can provide information for various applications. Reducing the volume of reagent(s) employed can significantly reduce cost, and cycle time (i.e., less volume of liquid is required to be delivered to, and removed, the tissue sample). Some exemplary fluidic systems are disclosed in U.S. Pat. Nos. 8,629,264 and 10,710,076, the entire contents of which are hereby incorporated by reference.

Interfacing of dozens of unique reagents with a flow cell is a challenging problem that is often solved by a succession of stream selectors and valves. However, stream selectors and valves are costly and are failure-prone devices that result in large dead volumes. Moreover, these approaches are not found as off-the-shelf components for systems using more than about 20-30 reagents. Thus, nullifying gains offered by flow cell approaches because they demand higher volumes of reagent.

Moreover, some flow cells include a trough into which a liquid reagent may be dispensed prior to flowing the liquid reagent through the flow cell. Detection of the near-depletion of reagents in the trough can reduce the amount of reagent(s) employed and prevent air from entering the flow cell.

Accordingly, there exists a need for a method and system for reducing the volume of reagents required to contact a sample during in situ analysis while allowing for high-resolution imaging of samples. Additionally, there exists a need for a method and system to detect the near-depletion of reagents in flow cells having troughs.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a pseudo flow cell device comprising a flow cell body, first reservoir, and a second reservoir. The flow cell body comprises a bottom layer and a top layer defining a fluidic channel therebetween. The fluidic channel extends along the flow cell body and has an inlet at a first side of the flow cell body and an outlet at a second side of the flow cell body, and a central portion disposed therebetween. The central portion has a height of about 20 μm to about 300 μm and a volume of about 50 μl to about 200 μl. The inlet has a first width. The first reservoir is disposed proximate to and in fluidic communication with the inlet. The first reservoir includes at least one sidewall formed in a portion of the top layer of the flow cell body that defines an opening configured to receive at least one reagent. The opening has a second width that is larger than the first width. The first reservoir has a volume of about 50 μl to about 10 ml, preferably about 1 ml to about 5 ml, and more preferably about 2 ml to about 5 ml. The second reservoir is formed in the top layer. The second reservoir comprises a base that is optically clear such that imaging (e.g., using an epifluorescence microscope) may be performed to illuminate and image target analytes within the sample. The second reservoir has a volume of about 0.2 ml to about 10 ml, preferably about 1 ml to about 10 ml, and may be configured to receive an imaging fluid (e.g., water or oil) into which an objective is immersed or dipped. The base of the second reservoir comprises an optically clear area of about 2 cm² to about 10 cm². The bottom layer is configured to receive a substrate (e.g., a glass slide) having a sample (e.g., a biological sample, one or more cells, one or more tissue sections, one or more hydrogels) disposed thereon such that the sample is positioned within the central portion of the fluidic channel (e.g., directly under the optically clear area of the top layer).

In some embodiments, at least a portion of the top layer of the flow cell body defines a planar surface.

In some embodiments, the base of the second reservoir defines a planar surface.

In some embodiments, the first reservoir is disposed above the inlet.

In some embodiments, a volume of the fluidic channel is about equal to a volume of the first reservoir.

In some embodiments, the first reservoir comprises a volume of about 100 μl to about 150 μl.

In some embodiments, the reservoir is configured to at least partially receive a pipettor, the pipettor dispensing the at least one reagent.

In some embodiments, the outlet is disposed above the central portion of the fluidic channel.

In some embodiments, the outlet is oriented substantially parallel to the inlet.

In some embodiments, the outlet is horizontally aligned with the central portion of the fluidic channel.

In some embodiments, the top layer of the flow cell body is removably coupled to the bottom layer of the flow cell body.

In some embodiments, the device further comprises a sensor disposed along the fluidic channel.

The disclosed subject matter also includes a system comprising a flow cell body, first reservoir, a second reservoir, and a reagent displacement mechanism. The flow cell body comprises a bottom layer and a top layer defining a fluidic channel therebetween. The fluidic channel extends along the flow cell body and has an inlet at a first side of the flow cell body and an outlet at a second side of the flow cell body, and a central portion disposed therebetween. The central portion has a height of about 20 μm to about 300 μm and a volume of about 50 μl to about 200 μl. The inlet has a first width. The first reservoir is disposed proximate to and in fluidic communication with the inlet. The first reservoir includes at least one sidewall formed in a portion of the top layer of the flow cell body that defines an opening configured to receive at least one reagent. The opening has a second width that is larger than the first width. The first reservoir has a volume of about 50 μl to about 10 ml, preferably about 1 ml to about 5 ml, and more preferably about 2 ml to about 5 ml. The second reservoir is formed in the top layer. The second reservoir comprises a base that is optically clear such that imaging (e.g., using an epifluorescence microscope) may be performed to illuminate and image target analytes within the sample. The second reservoir has a volume of about 0.2 ml to about 10 ml, preferably about 1 ml to about 10 ml, and may be configured to receive an imaging fluid (e.g., water or oil) into which an objective is immersed or dipped. The base comprises an optically clear area of about 2 cm² to about 10 cm². The bottom layer is configured to receive a substrate (e.g., a glass slide) having a sample (e.g., a biological sample, one or more cells, one or more tissue sections, one or more hydrogels) disposed thereon such that the sample is positioned within the central portion of the fluidic channel (e.g., directly under the optically clear area of the top layer).

In some embodiments, the system further comprises a reagent dispensing mechanism configured to dispense the at least one reagent into the first reservoir.

In some embodiments, the reagent dispensing mechanism comprises a pipette.

In some embodiments, the reagent displacement mechanism comprises a peristaltic pump.

In some embodiments, the reagent displacement mechanism comprises a syringe pump.

In some embodiments, the reagent displacement mechanism is disposed downstream from and in fluid communication with the outlet.

In some embodiments, the reagent displacement mechanism includes a pivot table. The pivot table is configured to incline the inlet of the flow cell body relative to the outlet of the flow cell body, such that gravitational force assists the flow of the at least one reagent from the inlet to the outlet.

In some embodiments, the inclination angle is from about 0 degree to about 90 degrees.

In some embodiments, the system further comprises a waste container in fluid communication with the reagent displacement mechanism. The waste container is disposed downstream of the outlet and configured to receive the at least one reagent.

In some embodiments, the system further comprises an imaging device comprising an objective lens. The objective lens is configured to image the biological sample from above the flow cell body.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present disclosure and may illustrate one or more embodiment(s) or example(s) of the present disclosure in whole or in part.

FIG. 1A is a schematic representation of a side view of an exemplary device, in accordance with an embodiment of the present disclosure.

FIG. 1B is a schematic representation of a side view of an exemplary device and imaging device, in accordance with an embodiment of the present disclosure.

FIG. 1C is a schematic illustration of different types of objective lens, in accordance with an embodiment of the present disclosure.

FIG. 2A is a schematic representation of a side view and cross-sectional view of another exemplary device, in accordance with an embodiment of the present disclosure.

FIG. 2B is a schematic representation of a side view of an exemplary device and imaging device, in accordance with an embodiment of the present disclosure.

FIG. 3 is a schematic representation of a side view of an exemplary device on a pivot table, in accordance with an embodiment of the present disclosure.

FIG. 4 is an illustration of a side view of an inclined configuration of an exemplary device, in accordance with an embodiment of the present disclosure.

FIG. 5A and FIG. 5B are illustrations of exemplary configurations for a pivot table, in accordance with an embodiment of the present disclosure.

FIG. 6A-FIG. 6C are schematic representations of a side view of an exemplary system, in accordance with an embodiment of the present disclosure.

FIG. 7A and FIG. 7B are schematic representations of a side view of another exemplary system, in accordance with an embodiment of the present disclosure.

FIG. 8 is a schematic representation of a side view of an exemplary device, in accordance with an embodiment of the present disclosure.

FIGS. 9A-9D are schematic representations of a side view of an exemplary system in a coupled configuration in accordance with embodiments of the present disclosure.

FIGS. 10A-10C are schematic representations of a side view of an exemplary system in a coupled configuration in accordance with embodiments of the present disclosure.

FIGS. 11A-11B are schematic representations of a side view of a second exemplary system including a beam break sensor in accordance with embodiments of the present disclosure.

FIG. 12 is a schematic representation of a side view of a third exemplary system including a float in accordance with the present disclosure.

FIG. 13 is a schematic representation of a side view of a fourth exemplary system including conductive plates in accordance with embodiments of the present disclosure.

FIGS. 14A-14B are schematic representations of a side view of a fifth exemplary system including a conductive tip in accordance with embodiments of the present disclosure.

FIG. 14C is a graphical representation of the measured capacitance of a conductive tip as a function of liquid level in accordance with embodiments of the present disclosure.

FIG. 15A-15B are schematic representations of a side view of a sixth exemplary system including a fluidic channel in accordance with embodiments of the present disclosure.

### DETAILED DESCRIPTION

### Definitions

To facilitate the understanding of this disclosure, a number of terms are defined below. Terms defined herein have meanings as commonly understood by a person of ordinary skill in the areas relevant to the disclosure. Terms such as “a”, “an,” and “the” are not intended to refer to only a singular entity, but include the general class of which a specific example may be used for illustration. The terminology herein is used to describe specific embodiments of the disclosure, but their usage does not limit the disclosure, except as outlined in the claims.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The term “about,” as used herein, refers to ±10% of a recited value.

As used herein, any values provided in a range of values include both the upper and lower bounds, and any values contained within the upper and lower bounds.

The term “biological particle,” as used herein, generally refers to a discrete biological system derived from a biological sample. The biological particle may be a virus. The biological particle may be a cell or derivative of a cell. The biological particle may be an organelle from a cell. Examples of an organelle from a cell include, without limitation, a nucleus, a mitochondrion, a ribosome, a Golgi apparatus, an endoplasmic reticulum, a chloroplast, an endocytic vesicle, an exocytic vesicle, a vacuole, and a lysosome. The biological particle may be a rare cell from a population of cells. The biological particle may be any type of cell, including without limitation prokaryotic cells, eukaryotic cells, bacterial, fungal, plant, mammalian, or other animal cell type, mycoplasmas, normal tissue cells, tumor cells, or any other cell type, whether derived from single cell or multicellular organisms. The biological particle may be a constituent of a cell. The biological particle may be or may include DNA, RNA, organelles, proteins, or any combination thereof. The biological particle may be or may include a matrix (e.g., a gel or polymer matrix) including a cell or one or more constituents from a cell (e.g., cell bead), such as DNA, RNA, organelles, proteins, or any combination thereof, from the cell. The biological particle may be obtained from a tissue of a subject. The biological particle may be a hardened cell. Such hardened cell may or may not include a cell wall or cell membrane. The biological particle may include one or more constituents of a cell but may not include other constituents of the cell. An example of such constituents is a nucleus or an organelle. A cell may be a live cell. The live cell may be capable of being cultured, for example, being cultured when enclosed in a gel or polymer matrix or cultured when including a gel or polymer matrix.

The term “fluidically connected”, as used herein, refers to a direct connection between at least two device elements, e.g., a channel, reservoir, etc., that allows for fluid to move between such device elements without passing through an intervening element.

The term “genome,” as used herein, generally refers to genomic information from a subject, which may be, for example, at least a portion or an entirety of a subject's hereditary information. A genome can be encoded either in DNA or in RNA. A genome can include coding regions that code for proteins as well as non-coding regions. A genome can include the sequence of all chromosomes together in an organism.

For example, the human genome has a total of 46 chromosomes. The sequence of all of these together may constitute a human genome.

The term “in fluid communication with”, as used herein, refers to a connection between at least two device elements, e.g., a channel, reservoir, etc., that allows for fluid to move between such device elements with or without passing through one or more intervening device elements.

The term “macromolecular constituent,” as used herein, generally refers to a macromolecule contained within or from a biological particle. The macromolecular constituent may include a nucleic acid. In some cases, the biological particle may be a macromolecule. The macromolecular constituent may include DNA or a DNA molecule. The macromolecular constituent may include RNA or an RNA molecule. The RNA may be coding or non-coding. The RNA may be messenger RNA (mRNA), ribosomal RNA (rRNA) or transfer RNA (tRNA), for example. The RNA may be a transcript. The RNA molecule may be (i) a clustered regularly interspaced short palindromic (CRISPR) RNA molecule (crRNA) or (ii) a single guide RNA (sgRNA) molecule. The RNA may be small RNA that are less than 200 nucleic acid bases in length, or large RNA that are greater than 200 nucleic acid bases in length. Small RNAs may include 5.8S ribosomal RNA (rRNA), 5S rRNA, transfer RNA (tRNA), microRNA (miRNA), small interfering RNA (siRNA), small nucleolar RNA (snoRNAs), Piwi-interacting RNA (piRNA), tRNA-derived small RNA (tsRNA) and small rDNA-derived RNA (srRNA). The RNA may be double-stranded RNA or single-stranded RNA. The RNA may be circular RNA. The macromolecular constituent may include a protein. The macromolecular constituent may include a peptide. The macromolecular constituent may include a polypeptide or a protein. The polypeptide or protein may be an extracellular or an intracellular polypeptide or protein. The macromolecular constituent may also include a metabolite. These and other suitable macromolecular constituents (also referred to as analytes) will be appreciated by those skilled in the art (see U.S. Pat. Nos. 10,011,872 and 10,323,278, and PCT Publication No. WO 2019/157529, each of which is incorporated herein by reference in its entirety).

The term “particulate component of a cell” refers to a discrete biological system derived from a cell or fragment thereof and having at least one dimension of 0.01 μm (e.g., at least 0.01 μm, at least 0.1 μm, at least 1 μm, at least 10 μm, or at least 100 μm). A particulate component of a cell may be, for example, an organelle, such as a nucleus, an exosome, a liposome, an endoplasmic reticulum (e.g., rough or smooth), a ribosome, a Golgi apparatus, a chloroplast, an endocytic vesicle, an exocytic vesicle, a vacuole, a lysosome, or a mitochondrion.

The terms “sample,” “tissue sample,” and “biological tissue sample” as used herein, refers to material from a subject, such as a biopsy, core biopsy, tissue section, needle aspirate, or fine needle aspirate or skin sample. The biological tissue sample may be derived from another sample. The biological sample may be a nucleic acid sample or protein sample. The sample may be a liquid sample, such as a blood sample, urine sample, or saliva sample. The sample may be a skin sample. The sample may be a cheek swab. The sample may be a plasma or serum sample. The sample may include a biological particle, e.g., a cell or virus, or a population thereof, or it may alternatively be free of biological particles. A cell-free sample may include polynucleotides. Polynucleotides may be isolated from a bodily sample that may be selected from the group consisting of blood, plasma, serum, urine, saliva, mucosal excretions, sputum, stool, and tears.

The term “sequencing,” as used herein, generally refers to methods and technologies for determining the sequence of nucleotide bases in one or more polynucleotides. The polynucleotides can be, for example, nucleic acid molecules such as deoxyribonucleic acid (DNA) or ribonucleic acid (RNA), including variants or derivatives thereof (e.g., single stranded DNA). Sequencing can be performed by various systems currently available, such as, without limitation, a sequencing system by ILLUMINA®, Pacific Biosciences (PACBIO®), Oxford NANOPORE®, or Life Technologies (ION TORRENT®). Alternatively, or in addition, sequencing may be performed using nucleic acid amplification, polymerase chain reaction (PCR) (e.g., digital PCR, quantitative PCR, or real time PCR), or isothermal amplification. Such systems may provide a plurality of raw genetic data corresponding to the genetic information of a subject (e.g., human), as generated by the systems from a sample provided by the subject. In some examples, such systems provide sequencing reads (also “reads” herein). A read may include a string of nucleic acid bases corresponding to a sequence of a nucleic acid molecule that has been sequenced. In some situations, systems and methods provided herein may be used with proteomic information.

The term “subject,” as used herein, generally refers to an animal, such as a mammal (e.g., human) or avian (e.g., bird), or other organism, such as a plant. The subject can be a vertebrate, a mammal, a mouse, a primate, a simian or a human. Animals may include, but are not limited to, farm animals, sport animals, and pets. A subject can be a healthy or asymptomatic individual, an individual that has or is suspected of having a disease (e.g., cancer) or a pre-disposition to the disease, or an individual that is in need of therapy or suspected of needing therapy. A subject can be a patient.

The term “inlet” and “port” as used herein, generally refers to an aperture, orifice or channel extending through at least a portion of a device layer.

Reference will now be made in detail to exemplary embodiments of the disclosed subject matter, an example of which is illustrated in the accompanying drawings. The method and corresponding steps of the disclosed subject matter will be described in conjunction with the detailed description of the system.

The methods, assemblies, and systems presented herein relate to a pseudo flow cell including a closed flow cell with an inlet reservoir configured to reduce a volume of reagent required to fully contact (e.g., submerge) a sample (e.g., one or more cells, one or more tissue samples, one or more hydrogels) positioned on a substrate (e.g., a glass slide or bottom layer of the closed flow cell). The volume of the inlet reservoir is greater than (e.g., by an order of magnitude) the volume of the flow cell chamber around the sample. In some embodiments, the closed flow cell may be reversible in that two or more pieces (e.g., a top, a bottom, a substrate with a sample, and a gasket) may be assembled together (e.g., adhered to one another) to form the closed flow cell and subsequently disassembled after analysis (e.g., in situ analysis) is performed. The system is a “pseudo” flow cell in that, unlike typical flow cells, reagents are tubed out and dispensed in (e.g., via a pipette or other dispensing mechanism). The flow cell includes the inlet reservoir into which reagents are dispensed at a first end of the flow cell and an outlet through which the reagents exit at a second end of the flow cell. The reagent is pumped from the inlet reservoir such that the reagent flows past and contacts the sample within a chamber of the flow cell and exits through the outlet (e.g., to a waste container). In some embodiments, the reagent is allowed to sit within the chamber for a predetermined period of time to allow for any reactions to occur while the sample is in contact with the reagent (i.e., the reagent is not removed from the chamber until after a suitable amount of time). Reducing the volume around the sample by use of a closed flow cell system (in contrast to an open well in which a sample is positioned) reduces the volume of reagent(s) needed for each cycle of a plurality of imaging and fluidics cycles during analysis of biological molecules, such as RNAs and/or proteins, and provides significant cost savings when using expensive reagents (e.g., one or more fluorescently-labelled antibodies, one or more fluorescently-labelled oligonucleotides, or other fluorescently labelled markers adapted to generate a light signal for the detection of a target biological molecule in the biological sample) and can also reduce cycle time, as less time is needed to dispense and remove the reagent(s) employed.

### Device 100

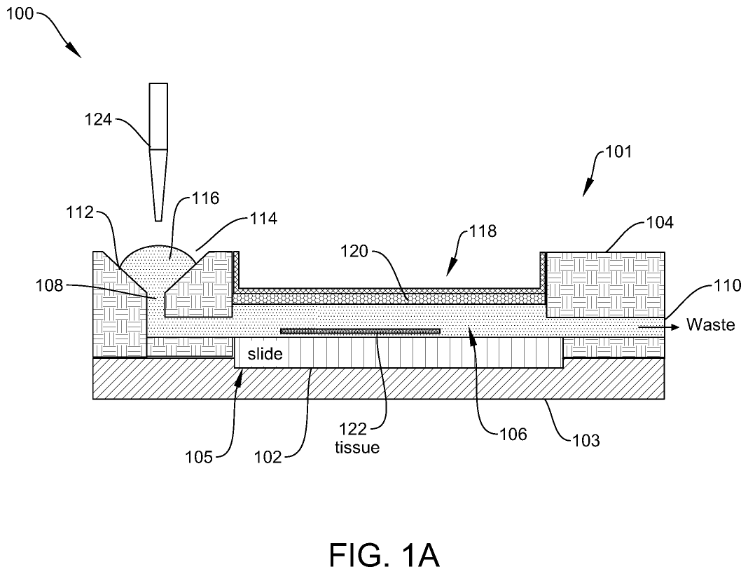

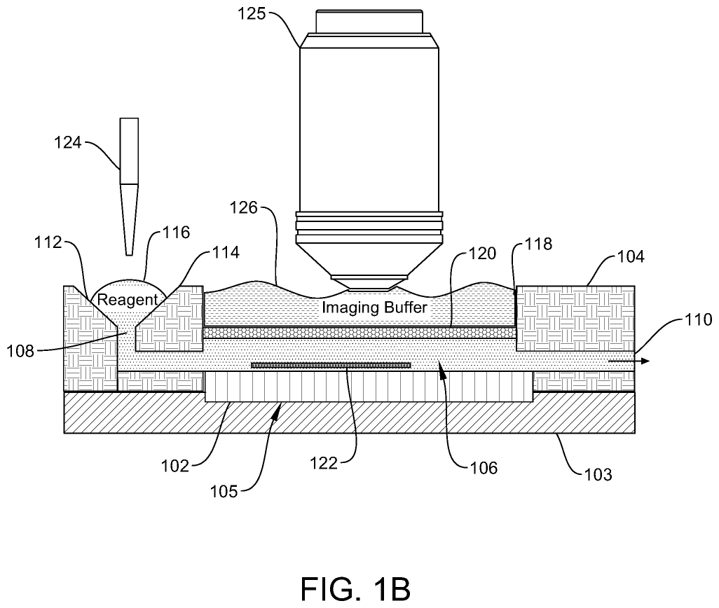

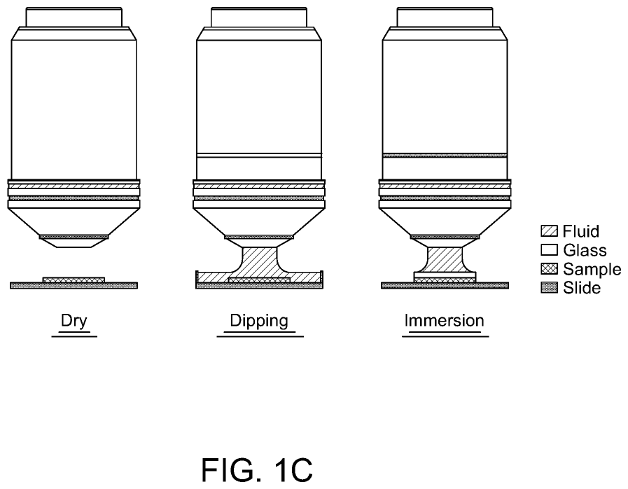

FIG. 1A is a schematic representation of a side view of an exemplary device. As shown in FIG. 1A, the device 100 is a closed flow cell that includes a flow cell body 101 having a first reservoir 112 (fluidically coupled to a chamber in which the sample is positioned) and a second reservoir 118 (formed on the top layer of the device). The flow cell body 101 includes a bottom layer 103 and a top layer 104 which define a fluidic channel 106 therebetween. In some embodiments, the top layer 104 is permanently coupled to the bottom layer 103 (i.e., the pseudo flow cell permanently remains in the coupled configuration after assembly). In some embodiments, the top layer is reversibly coupled to the bottom layer 103 in that, prior to an experiment or analysis run (e.g., analysis on an optofluidic instrument having a plurality of fluidic and imaging cycles), the pseudo flow cell is reversibly assembled with a substrate having a sample positioned thereon (i.e., the pseudo flow cell is in the coupled configuration) and, after the experiment or analysis run, the pseudo flow cell can be disassembled to access the substrate and sample (i.e., the pseudo flow cell is in the uncoupled configuration). In some embodiments, the top layer 104 is a removable top layer (i.e., can be positioned over a substrate and sample and cycled between the coupled and uncoupled configurations during an experiment or analysis run). In some embodiments, the top layer 104 is formed as a lid.

In some embodiments, the pseudo flow cell is a reversible flow cell that is assembled by positioning the substrate 102 (having the sample 122 positioned thereon) on the bottom layer 103 and the top layer 104 on the bottom layer 103. In some embodiments, a gasket (not shown) is positioned between the bottom layer 103 and the top layer 104 (e.g., to seal the components and prevent leaking). In some embodiments, the bottom layer 103, top layer 104, and/or the gasket are bonded and/or adhered to one another (e.g., via an adhesive liquid or adhesive strip). In some embodiments, the bonding and/or adhesive is not permanent (i.e., the components are capable of being disassembled). In some embodiments, once assembled, the pseudo flow cell is a permanently assembled closed flow cell and is not capable of being disassembled (without causing damage to the closed flow cell).

When implemented as a reversible flow cell, the flow cell body 101 has a coupled configuration (e.g., as shown in FIG. 1A, when the top layer 104 is coupled with the bottom layer 103, forming the closed pseudo flow cell body 101 during analysis of target analytes) and an uncoupled configuration (after disassembly, when the top layer 104 is positioned away from the bottom layer 103, revealing the substrate and sample). In some embodiments, the bottom layer 103 and the top layer 104 are stackable. For example, the top layer 104 can be reversibly coupled to the bottom layer 103 by pressing the top layer and bottom layer together to form a seal. In some embodiments, a user can insert a substrate 102 (e.g., glass slide) between the top and bottom layer and manually align and press the top layer 104 onto the bottom layer 103 together. In some embodiments, a mechanical instrument (e.g., an optofluidic instrument) can be used to align and press the top layer 104 and bottom layer 103 together.

In some embodiments, in the coupled configuration, at least a portion of the bottom surface of the top layer 104 contacts the top surface of the bottom layer 103 (e.g. around a perimeter of the top and bottom layers). In some embodiments, in the coupled configuration, a portion of the top layer 104 contacts the substrate 102. In some embodiments, the bottom layer 103 and the top layer 104 form a fluid-tight seal in the coupled configuration. In some embodiments, a sealing component (e.g., a gasket, adhesive, low tack tape) is used to form the fluid-tight seal (e.g., around the fluidic channel 106) between the top layer 104 and bottom layer 103 or the top layer 104 and substrate 102 (depending on where the sealing component is disposed). In some embodiments, the height of the sealing component determines the height of the fluidic channel 106. In some embodiments, the sealing component defines sidewalls of the fluidic channel 106. In some aspects, this can ensure consistent and repeatable dimensions for the flow cell across multiple uses (e.g., repeated coupling and uncoupling of the top layer to reversibly form the closed flow cell). The sealing component can be configured to compress when the flow cell body is in the coupled configuration. The sealing component can be positioned on (e.g., is affixed to) at least one of the bottom layer 103, the substrate 102, or the top layer 104. For example, the sealing component can be disposed on the substrate 102 such that the sealing component wraps around at least a portion of the substrate 102 (e.g., along the longitudinal side of the substrate). In another example, a groove (e.g., a half-dovetail groove) may be formed in the bottom surface of the top layer 104 such that a gasket may be inserted and secured therein. In some embodiments, the height of the gasket determines the height of the fluidic channel 106 (i.e., the distance between the bottom surface of the top layer 104 and the bottom layer 103). In yet another example, a sealing component can be disposed on the bottom layer 103 such that the sealing component wraps around the bottom layer 103 and encloses an area surrounding the substrate 102.

In some embodiments, an outer edge of the sealing component aligns with an edge of the substrate 102. In some embodiments, an outer edge of the sealing component is spaced inwardly from an outer edge of the substrate 102 (e.g., spaced inwardly from a portion of the substrate containing a barcode or labeling). In some embodiments, an outer edge of the sealing component aligns with an edge of the bottom layer 103. In some embodiments, an outer edge of the sealing component is spaced inwardly from an outer edge of the bottom layer 103. In some embodiments, an outer edge of the sealing component aligns with an edge of the top layer 104. In some embodiments, the outer edge of the sealing component is spaced inwardly from an outer edge of the top layer 104.

In some embodiments, one or more hard stops (not shown) extend down from the bottom surface of the top layer 104 to thereby define a height of the reversible, closed flow cell body. In some embodiments, the one or more hard stops are integrally formed with the top layer 104. In some embodiments, the one or more hard stops are separate from, and attached to, the top layer 104.

The fluidic channel 106 (e.g., a rectangular fluidic channel) extends (e.g., longitudinally) along the flow cell body 101 and includes an inlet 108 (e.g., a circular or rectangular inlet) at a first side of the flow cell body, an outlet 110 (e.g., a circular outlet, a rectangular outlet) at a second side of the flow cell body, and a central portion between the inlet and the outlet. A portion of the fluidic channel 106 extends through the thickness of the top layer 104. In some embodiments, the first side of the flow cell body is disposed (e.g., longitudinally) opposite of the second side. In some embodiments, the inlet 108 is perpendicular to the outlet 110 (e.g., as shown in FIG. 1A). In some embodiments, the outlet 110 is oriented parallel or substantially parallel (e.g., with deviations of less than 10 degrees from true parallelism) to the inlet 108. In some embodiments, the outlet 110 is disposed above the central portion of the fluidic channel. In some embodiments, the outlet 110 of the fluidic channel 106 is horizontally aligned with the central portion of the fluidic channel 106 (e.g., as shown in FIG. 1A). In some embodiments, the central portion of the fluidic channel has a volume of about 50 μL to about 200 μL. In some embodiments, the central portion of the fluidic channel has a height of about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 100 μm, about 105 μm, about 110 μm, about 115 μm, about 120 μm, about 125 μm, about 130 μm, about 135 μm, about 140 μm, about 145 μm, about 150 μm, about 155 μm, about 160 μm, about 165 μm, about 170 μm, about 175 μm, about 180 μm, about 185 μm, about 190 μm, about 195 μm, about 200 μm, about 205 μm, about 210 μm, about 215 μm, about 220 μm, about 225 μm, about 230 μm, about 235 μm, about 240 μm, about 245 μm, about 250 μm, about 255 μm, about 260 μm, about 265 μm, about 270 μm, about 275 μm, about 280 μm, about 285 μm, about 290 μm, about 295 μm, about 300 μm. In some embodiments, the central portion of the fluidic channel has a height of about 25 μm to about 300 μm. In some embodiments, the central portion of the fluidic channel has a height of about 100 μm to about 200 μm. In some embodiments, a sensor (e.g., a pressure sensor, a flow meter sensor, optical sensor) is disposed along the fluidic channel 106 (e.g., at the inlet or at the outlet).

In some embodiments, a waste container is in fluidic communication with the outlet 110 and receives the one or more liquid reagents flowed out through the outlet. Tube connectors and/or tubing (e.g., flexible tubing) can be used to fluidically couple the outlet 110 and the waste container. Tubing can be routed from the outlet 110 to the waste container, thereby defining a fluidic pathway between the two elements. In some embodiments, the outlet 110 provides an interface for connecting with tubing

The bottom layer 103 includes a body having a top surface, a bottom surface, and a thickness therebetween. The bottom layer 103 is configured to receive a substrate 102 (e.g., a glass slide, microscope slide, cover glass, cover slip) with one or more samples 122 (e.g., biological tissue sample, a hydrogel having analytes affixed therein) disposed on the substrate. The substrate 102 is removably coupled to the bottom layer 103. In the coupled configuration, the sample 122 (e.g., biological sample) is positioned within the central portion of the fluidic channel 106. In some embodiments, the bottom layer has a planar top surface. In some embodiments, the bottom layer 103 includes a recess 105 (e.g., a rectangular recess), for example, as shown in FIG. 1A, which defines an interior surface sized and shaped to receive the substrate 102. A recess as used herein is a cavity or indentation formed in the surface of a component and having a depth. In some embodiments, the depth of the recess 105 is approximately the height of the substrate 102. The bottom layer 103 can be formed of one or more materials, including, but not limited to, a metal or metal alloy (e.g., aluminum, brass, copper, stainless steel, etc.) or a polymer (e.g., acrylic, polycarbonate, polypropylene, polyvinyl chloride, etc.). In some embodiments, at least a portion of the bottom layer 103 is optically transparent. In some embodiments, the bottom layer 103 includes an aperture extending through the thickness of the layer and positioned such that, when the substrate 102 is disposed on the bottom layer 103, it extends over the aperture.

The top layer 104 includes a body having a top surface, a bottom surface, and a thickness therebetween. The top layer 104 can be formed of one or more materials, including, but not limited to, a metal or metal alloy (e.g., aluminum, brass, copper, stainless steel, etc.) or a polymer (e.g., acrylic, polycarbonate, polypropylene, polyvinyl chloride, etc.). In some embodiments, at least a portion of the top layer 104 defines a planar surface. The top layer 104 includes a first reservoir 112 (e.g., a conical or rectangular trough) and a second reservoir 118. The first reservoir 112 includes at least one sidewall formed in a portion of the top layer 104. The first reservoir 112 can be sized and shaped to at least partially receive a reagent dispensing mechanism 124 (e.g., pipette, fluid pump, nozzle, or a syringe with a needle) configured to dispense liquid reagent. The at least one sidewall can taper from the first opening 114 to the inlet 108 of the fluidic channel 106. In some embodiments, the width or diameter of the first opening 114 is larger than the width or diameter of the inlet 108. In some embodiments, the first opening 114 and the inlet 108 have uniform dimensions. In some embodiments, the first reservoir 112 is configured to hold a fluid volume about equal to the volume of the fluidic channel 106. In some embodiments, the first reservoir 112 is configured to hold a fluid volume of about 50 μL. In some embodiments, the first reservoir 112 is configured to hold a fluid volume of about 100 to about 150 μL. In some embodiments, the first reservoir 112 is configured to hold a fluid volume of about 200 μL. In some embodiments, the first reservoir 112 is configured to hold a fluid volume of up to about 500 μL. In some embodiments, the first reservoir 112 is configured to hold a fluid volume of up to about 50 μL to about 500 μL. In some embodiments, the first reservoir 112 is configured to hold a fluid volume of up to about 100 μL to about 400 μL. In some embodiments, the first reservoir 112 is configured to hold a fluid volume of up to about 100 μL to about 300 μL. In some embodiments, the first reservoir 112 is configured to hold a fluid volume of up to about 100 μL to about 200 μL. The first reservoir 112 can be in fluid communication with the surrounding environment (e.g., ambient air). The first reservoir 112 is disposed proximate to (e.g., disposed above) and in fluidic communication with the inlet 108.

In the coupled configuration, the first reservoir 112, inlet 108, and outlet 110 are in fluidic communication. One or more liquid reagents can be introduced (e.g., using a reagent dispensing mechanism) into the first reservoir 112 and flowed from the inlet 108 through the fluidic channel and out through the outlet 110. A pipette (e.g., manual or automatic (electronic) pipette), nozzle, or a syringe with a needle can be used to deliver at least one liquid reagent to the first reservoir 112. Other reagent dispensing mechanisms (e.g., syringe pump, piston pump, diaphragm pump, gear pump, positive displacement pump) can be used to deliver at least one liquid reagent to the first reservoir 112.

In some embodiments, the first reservoir 112 includes a membrane (e.g., a pierceable septum membrane) disposed over the first opening 114. The membrane can be shaped and sized to completely cover the first opening 114 of the first reservoir 112, providing a physical barrier that reduces loss of liquid by evaporation. In some embodiments, the membrane extends into the first reservoir 112. The membrane can be formed of one or more materials including, but not limited to, flexible materials such as rubber and silicone. The membrane allows for the introduction or withdrawal of liquids while maintaining an airtight and/or leak-proof seal. In some embodiments, a pipette tip or needle tip is configured to penetrate through the thickness of the membrane. In some embodiments, the membrane is configured to reseal once the tip is removed.

In some embodiments, at least a portion of the top layer 104, such as the bottom surface, is coated with a chemical layer (e.g., a hydrophilic coating, a hydrophobic coating) that modifies surface wettability. In some embodiments, at least a portion of the top layer 104, such as the bottom surface, is formed of a material (e.g., a hydrophilic material, hydrophobic material) that modifies surface wettability. Modifying the surface wettability of the top layer 104 can prevent bubble deformation and/or carryover (e.g., transfer of residual liquid reagent and/or sample from one substrate to another substrate). A hydrophilic material and/or hydrophilic coating may prevent bubble deformation. A hydrophobic material and/or hydrophobic coating may prevent carryover.

The second reservoir 118 is formed in the top layer 104, defining an interior volume with sidewalls and an optically clear base 120 (e.g., cover slip, a glass slide). The second reservoir 118 beneficially includes sidewalls that have a positive height (i.e., the top surface of the top layer is not entirely flat) such that the second reservoir is configured to contain a specific volume of liquid, e.g., for imaging with a water immersion objective. Without sidewalls for containing a volume of liquid (e.g., on a flat surface), liquid may spill over or run across the surface of the top layer, making imaging unable to be performed and potentially resulting in a failed experiment/analysis. In some embodiments, the second reservoir 118 is configured to hold a fluid volume of about 1 ml to about 30 ml. In some embodiments, the second reservoir 118 is configured to hold a fluid volume of about 1 ml to about 20 ml. In some embodiments, the second reservoir 118 is configured to hold a fluid volume of about 1 ml to about 10 ml. In some embodiments, the second reservoir 118 is configured to hold a fluid volume of about 1 ml to about 5 ml. In some embodiments, the second reservoir 118 is configured to hold a fluid volume of about 2 ml to about 6 ml. In some embodiments, the second reservoir 118 is configured to hold a fluid volume of about 5 ml to about 10 ml. In some embodiments, the second reservoir 118 is configured to hold a fluid volume of about 10 ml to about 20 ml. In some embodiments, the second reservoir 118 is configured to hold a fluid volume of about 1 ml, about 2 ml, about 3 ml, about 4 ml, about 5 ml, about 6 ml, about 7 ml, about 8 ml, about 9 ml, or about 10 ml. In some embodiments, the second reservoir 118 is configured to hold a fluid volume of at least 1 ml, at least 2 ml, at least 3 ml, at least 4 ml, at least 5 ml, at least 6 ml, at least 7 ml, at least 8 ml, at least 9 ml, or at least 10 ml. In some embodiments, the base 120 defines a planar surface. In some embodiments, the base 120 is integral with the top layer 104. In some embodiments the base 120 is separate from the top layer 104. For example, the top layer 104 can include notches configured to receive and align the base 120 such that it is substantially parallel with the substrate 102 and positioned above the biological sample 122. The base 120 defines an imageable area over which an imaging device (e.g., objective lens part of an optical system in an optofluidic instrument) can be used to image the biological sample. In some embodiments, the imageable area is smaller than the optically clear area of the base 120. In some embodiments, the optically clear area of the base 120 is about 2 cm². In some embodiments, the optically clear area of the base 120 is about 3 cm². In some embodiments, the optically clear area of the base 120 is about 5 cm². In some embodiments, the optically clear area of the base 120 is about 10 cm². In some embodiments, the optically clear area of the base 120 is about 2 cm² to about 10 cm². In some embodiments, the interior side walls of the second reservoir 118 have an inner wall angle that matches an angle of the objective, allowing for increased travel distance of the objective when immersed in the second reservoir 118.

In the coupled configuration, the second reservoir 118 is positioned above the central portion of the fluidic channel 106, allowing for unobstructed access to the sample 122 (e.g., biological sample) for visualization, illumination, and/or imaging (e.g., by an epifluorescence optical system). FIG. 1B shows a schematic illustration of an imaging device positioned over the device 100. In some embodiments, the imaging device includes an objective lens 125 which is part of an optical system in an optofluidic instrument. The objective lens 125 can be positioned above the optically clear base 120. The objective lens 125 can move along the x-, y-, and z-axes, enabling traversal of the imageable area of the base 120. In some embodiments, the second reservoir 118 is filled with a buffer reagent 126 (e.g., using a reagent dispensing mechanism). In some embodiments, the objective lens 125 extends within the second reservoir 118. In some embodiments, the objective lens 125 (e.g., water immersion objective, oil immersion objective, etc.) is immersed within a buffer reagent 126 (e.g., imaging buffer, immersion buffer, oil, etc.) contained in the second reservoir 118. FIG. 1C is a schematic illustration of different types of objective lens that can be used to image the biological sample, including a dry objective lens, a dipping objective lens, and an immersion objective. Water immersion objectives perform better (e.g., have increased optical resolution) than other objectives by immersing both the lens and the biological sample in a liquid having higher refractive index than air, thereby increasing the numerical aperture of the objective lens and providing higher quality imaging. Additional buffer reagent (e.g., imaging buffer, immersion buffer) can be added to the second reservoir 118, if needed, so that the objective lens 125 can be immersed in the liquid during imaging. Reagent 116 (e.g., imaging buffer) can be disposed within the fluidic channel during imaging of the sample 122 (e.g., biological sample).

### Operation of Device 100

In operation, the bottom layer 103 and the top layer 104 are configured to move relative to one another between a coupled (closed flow cell body) configuration and an uncoupled configuration (with the top layer 104 positioned away from the bottom layer 103). The top layer 104 can be aligned above the bottom layer 103 (containing the substrate 102). For example, an outer edge (e.g., the outermost edge) of the bottom surface of the top layer 104 can be aligned with the outer edge (e.g., the outermost edge) of the bottom layer 103. The top layer 104 and/or the bottom layer 103 can be configured to move (e.g. translate) along one or more directions (e.g., x-, y-, and z-axis). For example, the top layer 104 and/or substrate 102 can be configured to move only in the z-direction (towards and away from the other component). In some embodiments the top layer 104 is lowered, while the bottom layer 103 (containing the substrate 102) remains stationary, to bring the top layer 104 and bottom layer 103 into sealing engagement. In some embodiments, the top layer 104 is stationary, while the bottom layer 103 (containing the substrate 102) is elevated to bring the top layer and bottom layer 103 into sealing engagement. Prior to coupling the bottom layer 103 and the top layer 104, the substrate 102 is positioned on the bottom layer 103 (e.g., inserted into the recess 105). If the sealing component is disposed on the substrate 102, the closed flow cell body is reversibly formed when the top layer 104 is brought into contact with the sealing component on the substrate 102. If the sealing component is disposed on the bottom surface of the top layer 104, the closed flow cell body is reversibly formed when the top layer 104 (having the gasket disposed on a bottom surface thereof, e.g., in a groove formed in the bottom of the top layer 104) is brought into contact with the substrate 102 and/or the bottom layer 103. If the sealing component is disposed on the bottom layer 103, the closed flow cell body is reversibly formed when the top layer 104 is brought into contact with the sealing component on the bottom layer 103.

For example, and without limitation, the top layer 104 can be coupled to a structure having a base and a stage coupled to the base (on which the bottom layer 103 and substrate 102 are positioned). In some embodiments, the bottom layer 103 is integral with the stage. In some embodiments, the bottom layer 103 is separate from the stage. The moveable stage can be mounted on a linear rail system serving as a rail guide for the stage. The moveable stage can be driven (e.g., lead screw driven) by an actuator which can automatically or manually be adjusted to vary the position of the stage (e.g., along x-, y-, and z-axis). In some embodiments, the top layer 104 is coupled to the base such that the top layer 104 is positioned above the substrate 102 and bottom layer 103 (positioned on the stage).

By way of example, one or more actuators (e.g., motor) can be operably coupled to at least one of a stage (on which the bottom layer 103 holding the substrate 102 is positioned) and the top layer 104. A first actuator (e.g., motor) can be operably coupled to the top layer 104 and configured to translate the top layer 104 in a direction towards the substrate 102. Additionally or alternatively, a second actuator (e.g., motor) can be operably coupled to a stage (on which the bottom layer 103 holding a substrate 102 is positioned) and configured to translate the bottom layer 103 and substrate 102 in a direction towards the top layer 104. In some embodiments, the top layer 104 can be lowered vertically. Additionally (e.g., simultaneously) or alternatively, the bottom layer 103 and the substrate 102 can be raised vertically.

In some embodiments, the top layer 104 is pivotably coupled (e.g., to the base) such that, in the uncoupled configuration, the top layer 104 is disposed at an angle (e.g., an angle about 1 degree to about 45 degrees) relative to the bottom layer 103 and the substrate 102. As the device transitions from an uncoupled configuration to a coupled configuration, the top layer 104 pivots from an angled orientation (with respect to the horizontal axis) to a flat or parallel orientation. This can minimize gaps that may trap air and lead to bubble formation.

In the uncoupled configuration, the top layer 104 and the bottom layer 103 are spaced at a distance from each other. The top layer 104 can be raised vertically to retract the top layer 104 from the bottom layer 103, thereby releasing the sealing engagement between the top layer and the bottom layer (when the seal is formed between them) or between the top layer and the substrate 102 (when the seal is formed between them). Additionally (e.g., simultaneously) or alternatively, the bottom layer 103 can be lowered vertically to release the sealing engagement between the top layer and the bottom layer or the top layer and the substrate (depending on which elements are sealed with each other in the coupled configuration).

### Device 200

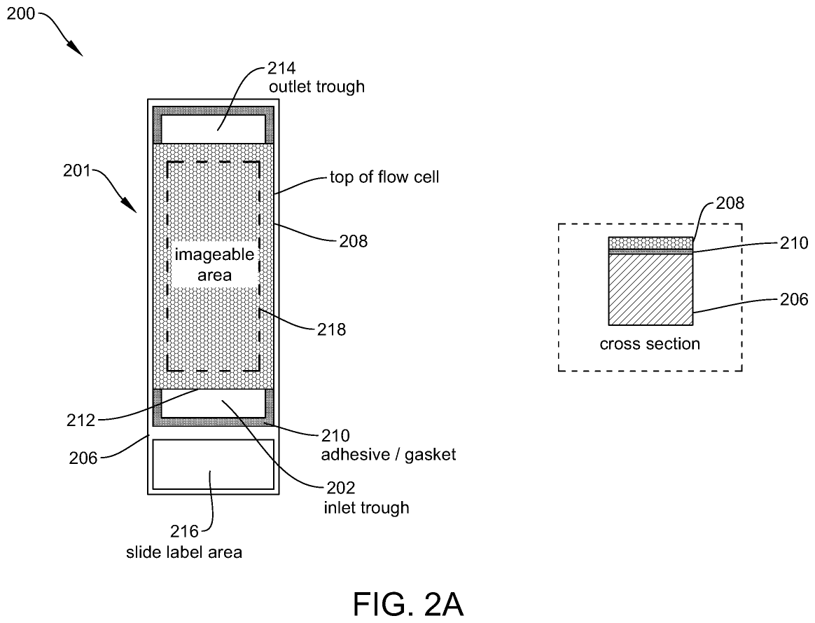

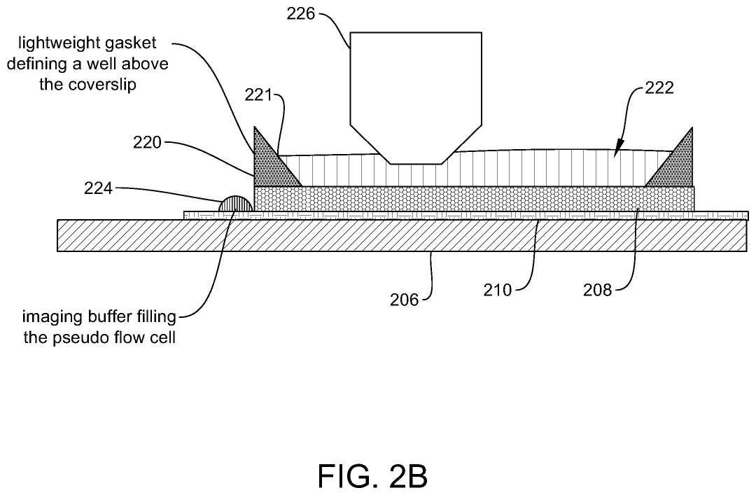

FIG. 2A is a schematic representation of a top view and cross-sectional view of an exemplary device. As shown in FIG. 2A, device 200 includes a flow cell body 201 and a first reservoir 202. The flow cell body 201 includes a bottom layer 206 and a top layer 208 which define a fluidic channel (not shown) between them. The bottom layer 206 and the top layer 208 are planar bodies. In some embodiments, the top layer 208 and the bottom layer 206 are optically clear. In some embodiments, the top layer 208 is a cover slip. In some embodiments, the bottom layer 206 is a glass slide.

The flow cell body includes a coupled configuration (when the top layer 208 is coupled with the bottom layer 206, forming the closed flow cell body) and an uncoupled configuration (when the top layer 208 is positioned away from the bottom layer 206). In some embodiments, the bottom layer 206 and the top layer 208 are stackable. The top layer 208 is reversibly coupled to the bottom layer 206 by pressing the top layer and bottom layer together to form a seal. In some embodiments, a user can manually align and press the top layer 208 and the bottom layer 206 together. In some embodiments, a mechanical instrument can be used to align and press the top layer 208 and bottom layer 206 together.

A sealing component (e.g., a gasket, adhesive, low tack tape) can be used to form the fluid-tight seal (e.g., around the fluidic channel) between the bottom layer 206 and the top layer 208, thereby defining an interior volume of the closed flow cell body. The fluidic channel (e.g., a rectangular fluidic channel) extends (e.g., longitudinally) along the flow cell body and includes an inlet 212, an outlet 214, and a central portion (e.g., rectangular portion) between the inlet and outlet. The inlet 212 (e.g., a circular or rectangular inlet) is disposed at a first side of the flow cell body and the outlet 214 (e.g., a circular outlet, a rectangular outlet) is disposed at a second side of the flow cell body. In some embodiments, the first side of the flow cell body is disposed (e.g., longitudinally) opposite of the second side. In some embodiments, the inlet 212 and outlet 214 are horizontally aligned with the central portion of the fluidic channel. In some embodiments, the inlet 212 and outlet 214 are perpendicular to each other. In some embodiments, the central portion of the fluidic channel has a volume of about 50 μL to about 200 μL. In some embodiments, the central portion of the fluidic channel has a height of about 20 μm to about 300 μm. In some embodiments, a sensor (e.g., a pressure sensor, a flow meter sensor, optical sensor) is disposed along the fluidic channel 106.

The sealing component 210 (e.g., a gasket, adhesive, low tack tape) is disposed on the bottom layer 206 such that the sealing component wraps around the bottom layer 206 and encloses an area larger than the area of the top layer 208. For example, as shown in FIGS. 2A and 2B, the sealing component 210 wraps around the bottom layer 206 and defines sidewalls of the first reservoir 202, the central portion of the fluidic channel, and around the outlet 214. In some embodiments, the height of the sealing component determines the height of the fluidic channel (i.e., the distance between the bottom surface of the top layer 208 and the bottom layer 206). In some aspects, this can ensure consistent and repeatable dimensions for the flow cell across multiple uses (e.g., repeated coupling and uncoupling of the top layer to reversibly form the closed flow cell). In some embodiments, the first reservoir 202 is configured to hold a fluid volume about equal to the volume of the fluidic channel. In some embodiments, the first reservoir 202 is configured to hold a fluid volume of about 50 μL to about 200 μL. In some embodiments, the second reservoir 221 is configured to hold a fluid volume of about 0.2 mL to about 30 mL. In some embodiments, the second reservoir 221 is configured to hold a fluid volume of about 0.2 mL to about 20 mL. In some embodiments, the second reservoir 221 is configured to hold a fluid volume of about 0.2 mL to about 10 mL. In some embodiments, the second reservoir 221 is configured to hold a fluid volume of about 0.2 mL to about 5 mL.

In some embodiments, an outer edge of the sealing component 210 aligns with an edge of the bottom layer 206. In some embodiments, an outer edge of the sealing component 210 is spaced inwardly from an outer edge of the substrate (e.g., spaced inwardly from a portion of the bottom layer 206 containing a label/barcode area 216). In some embodiments, an outer edge of the sealing component 210 aligns with an edge of the top layer 208. In some embodiments, the outer edge of the sealing component 210 is spaced inwardly from an outer edge of the top layer 104.

In the coupled configuration, the first reservoir 202, inlet 212, and outlet 214 are in fluidic communication. One or more liquid reagents can be introduced (e.g., using a reagent dispensing mechanism) into the first reservoir 202 and flowed from the inlet 212 through the fluidic channel and out through the outlet 214.

In some embodiments, a waste container is in fluidic communication with the outlet 214 and receives the one or more liquid reagents flowed out through the outlet. Tube connectors and/or tubing (e.g., flexible tubing) can be used to fluidically couple the outlet 214 and the waste container. Tubing can be routed from the outlet 214 to the waste container, thereby defining a fluidic pathway between the two elements. In some embodiments, the outlet 214 provides an interface for connecting with tubing.

The top layer 208 defines an imageable area 218 (indicated with a dashed line in FIG. 2) over which an imaging device (e.g., objective lens part of an optical system in an optofluidic instrument) can be used to image a biological sample disposed on the bottom layer 206. In some embodiments, the imageable area 218 is smaller than the optically clear area of the top layer 208. In some embodiments, the optically clear area of the base 120 is about 2 cm² to about 5 cm².

In some embodiments, a well wall 220 (e.g., a lightweight gasket) is disposed on the top layer 208 such that the well wall and top layer form a second reservoir 221 capable of containing a predetermined amount of fluid. The well wall 220 includes at least one side wall, forming an enclosed structure (e.g., a rectangular structure) with an open top end and an open bottom end. The bottom end of the well wall 220 rests on the top layer 208, with the side walls extending upwardly from the top layer, thereby defining an open well through which a liquid dispensing mechanism can dispense a buffer reagent 222 (e.g., imaging buffer, immersion buffer). In some embodiments, the well wall 220 has an inner wall angle that matches an angle of an objective lens 226.

FIG. 2B shows a schematic illustration of an imaging device positioned over the top layer 208 of the device 200. In some embodiments, the imaging device includes an objective lens 226 which is part of an optical system in an optofluidic instrument. The objective lens 226 can move along the x-, y-, and z-axes, enabling traversal of the imageable area 218 of the top layer 208. In some embodiments, the objective lens 226 extends within the second reservoir 221. In some embodiments, the objective lens 226 (e.g., water immersion objective) is immersed within a buffer reagent 222 (e.g., imaging buffer, immersion buffer) contained in the second reservoir 221. Additional buffer reagent (e.g., imaging buffer, immersion buffer) can be added to the open well, if needed, so that the objective 226 can be immersed in the liquid during imaging. Reagent 224 (e.g., imaging buffer) can be disposed within the fluidic channel during imaging of the biological sample.

### Reagent Displacement Mechanism

A reagent displacement mechanism (e.g., pipette, nozzle, peristaltic pump, syringe pump, piston pump, diaphragm pump, gear pump, pivot table) is used to flow one or more liquid reagents from the inlet (e.g., inlet 108, 212) through the fluidic channel to the outlet (e.g., outlet 110, 214). The reagent displacement mechanism flows liquid reagent through the fluidic channel of the flow cell body, while simultaneously displacing the liquid level of the reagent in the first reservoir (e.g., first reservoir 112, 202) in response to fluid flow through the fluidic channel. When a first reagent disposed in the first reservoir (e.g., first reservoir 112, 202) depletes or nearly depletes (e.g., the trailing edge of the liquid reagent is at or a predetermine height above the outlet), a second reagent can be dispensed into the first reservoir. In this way, there is no air gap introduced between reagents. This creates a continuous liquid interface between the first reagent and the second reagent. The second reagent is similarly flowed through the fluidic channel using the reagent displacement mechanism.

In some embodiments, a sensor (e.g., an optical sensor) is disposed at or predetermined height above the inlet of the fluidic channel and is configured to detect the liquid of the reagent when liquid level reaches the sensor. The sensor may be in electronic communication with an indicator configured to produce a signal (e.g., visual signal and/or audio signal) when the liquid level (e.g., the liquid interface) depletes to a level detectable by the sensor. In some embodiments, the signal indicates to a user the depletion of the reagent within the first reservoir. The user may then fill the first reservoir with reagent. In some embodiments, the detection of the liquid level at the sensor deactivates the reagent displacement mechanism. In some embodiments, when the liquid level rises above the level of the sensor, the reagent displacement mechanism is activated.

### System 300

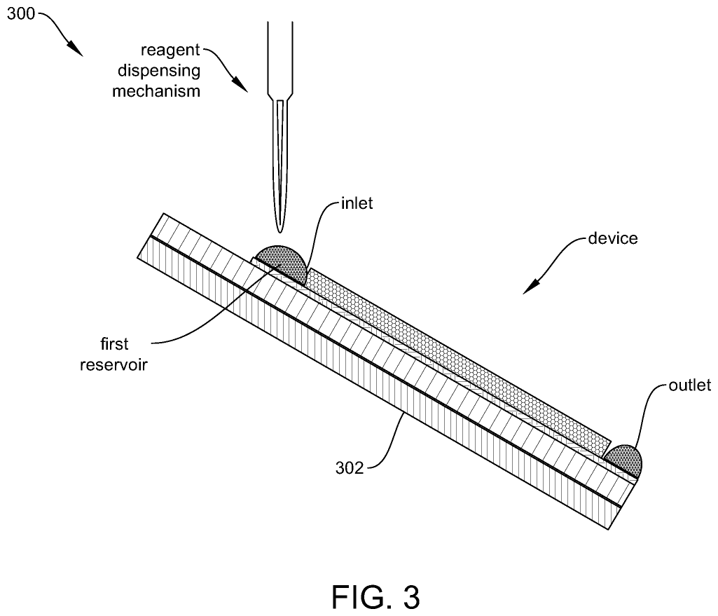

FIG. 3 is a schematic representation of a side of an exemplary system 300 in an inclined configuration, with the outlet positioned lower than the inlet. As shown in FIG. 3, the system 300 includes a device (e.g., device 100, 200), a reagent dispensing mechanism, and a reagent displacement mechanism 302 configured to flow a volume of one or more reagents through the flow cell body of the device (i.e., from the first reservoir to the inlet, through the fluidic channel, and out through to the outlet).

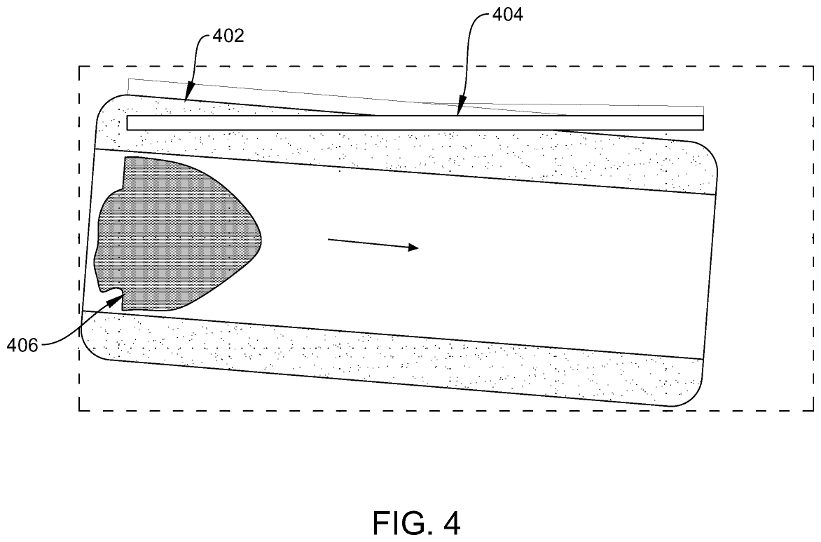

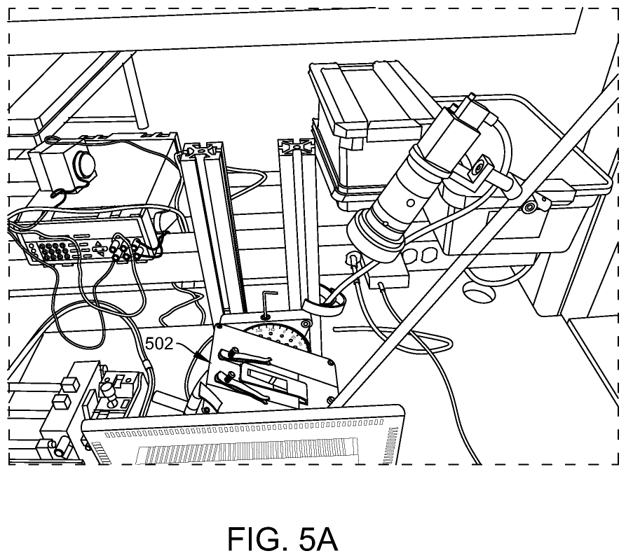

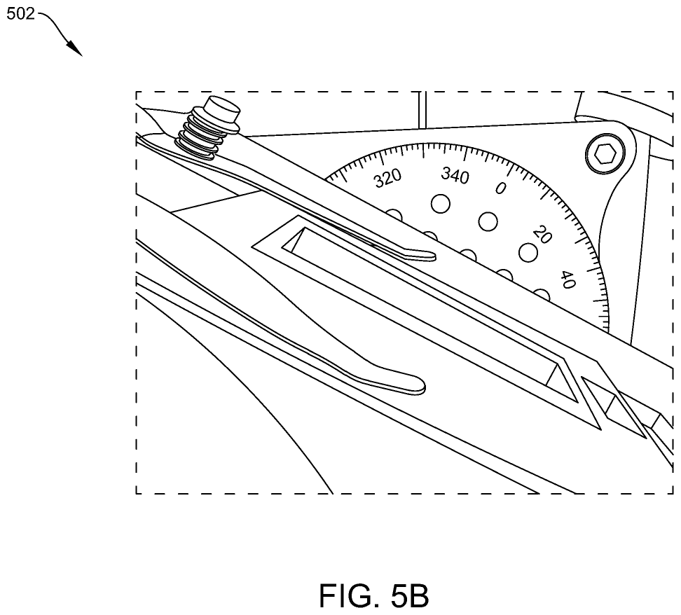

In some embodiments, the reagent displacement mechanism includes a pivot table configured to incline the inlet of the flow cell body (e.g., of device 100, 200) relative to the outlet (e.g., as shown in FIG. 3 and FIG. 4). FIG. 4 is an illustration of a side of an exemplary device 402 in an inclined configuration, with the flow direction of reagent 406 indicated. The horizontal reference line 404 is shown for orientation. By adjusting the angle of the inlet relative to the outlet (i.e., the angle of inclination), the pivot table leverages gravitational force to drive and/or assist in the flow of the one or more reagents through the fluidic channel. In some embodiments, the angle of inclination is about 0 degrees to about 90 degrees. The pivot table is an adjustable component that can rotate around a central pivot point, allowing it to change the angle of the flow cell body. By adjusting the angle of the flow cell body, gradually or via stepped intervals, the pivot table can also control the flow rate of the reagent through the fluidic channel. Increasing the angle of inclination can accelerate the flow of the reagent, while decreasing it can slow down the reagent flow. FIGS. 5A-5B are illustrations of a flow cell body mounted on an exemplary pivot table. The pivot table 502 includes a flat plate mounted to a stable frame and a dial (featuring markings for various angles) configured to adjust the angle of the flat plate. A manual or motorized mechanism can be used to control the pivot angle. The device can be mounted to and secured on the flat plate of the pivot using mounts (e.g., clamps, bracket mounts, elastic strap, screws, bolts, nuts, etc.).

### System 600

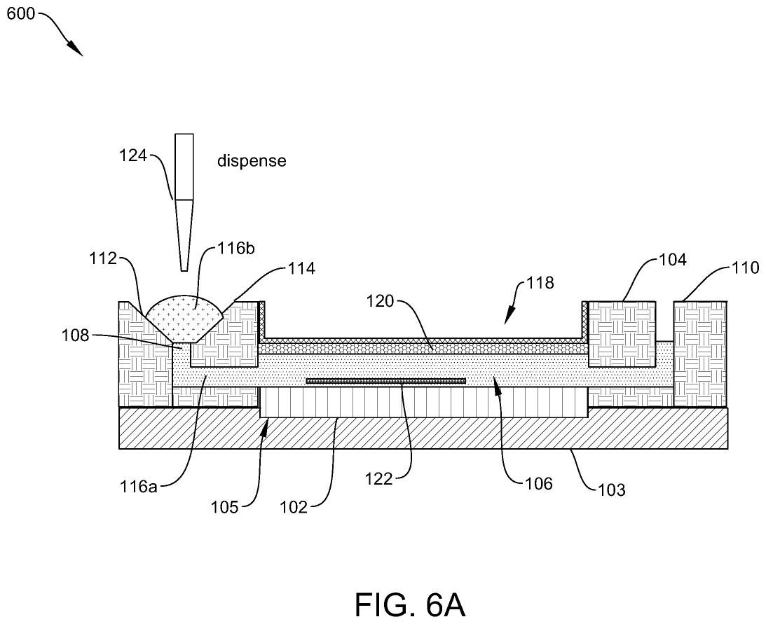

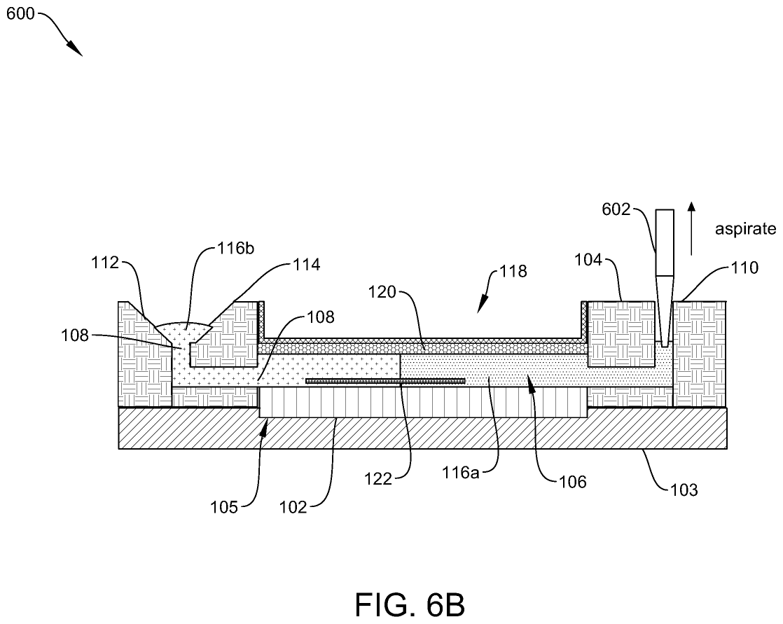

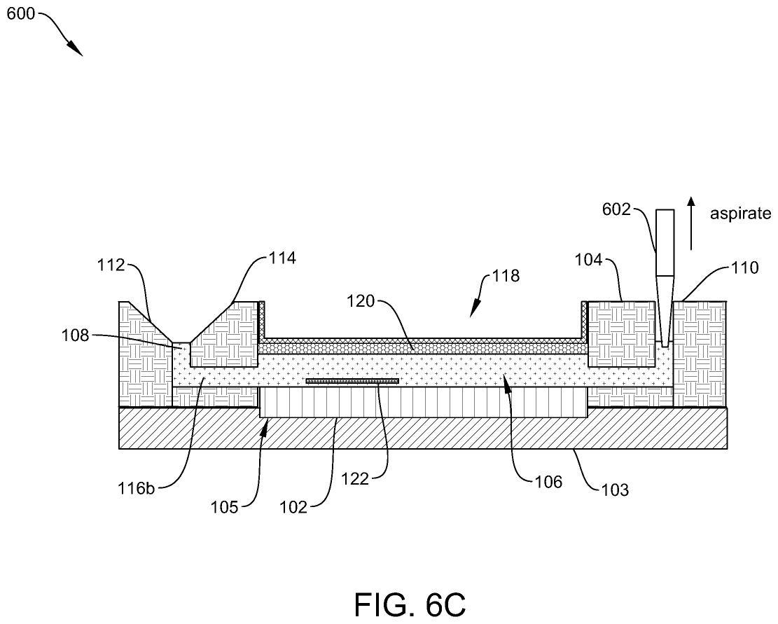

FIG. 6A-FIG. 6C are schematic representations of a side view of an exemplary system 600. As shown in FIG. 6A-FIG. 6C, the system 600 includes a device (e.g., device 100), a reagent dispensing mechanism 124, and a reagent displacement mechanism 602 configured to flow a volume of one or more reagents from the first reservoir 112, to the inlet 108, through the fluidic channel 106, and out through to the outlet 110.

In some embodiments, the reagent displacement mechanism 602 is a pipette (e.g., automatic (electronic pipette), manual pipette). In some embodiments, the reagent displacement mechanism 602 includes an aspirating nozzle. In some embodiments, the reagent displacement mechanism 602 includes a needle and syringe. In some embodiments, the reagent displacement mechanism 602 is held stationary and longitudinally extends into the fluidic inlet 108. In some embodiments, the reagent displacement mechanism 602 is moved relative to the device. In some embodiments, the system further comprises a waste container where liquid reagent 116 can be dispensed.

FIG. 6A-FIG. 6C illustrate a sequence of illustrations of an exemplary workflow of system 600. FIG. 6A illustrates a reagent 116a disposed within the fluidic channel 106 and a reagent 116b in the first reservoir 112. A pipette (e.g., manual or automatic (electronic), nozzle, or a syringe with a needle can be used to deliver at least one liquid reagent to the first reservoir 112 through the first opening 114. Other reagent dispensing mechanisms (e.g., syringe pump, peristaltic pump, piston pump, diaphragm pump, gear pump, positive displacement pump) can be used to deliver at least one liquid reagent to the first reservoir 112. FIG. 6B illustrates a reagent displacement mechanism 602 extending into the outlet 110 and aspirating the liquid reagent 116a. The arrow in the fluidic channel 106 shows the general flow direction of the reagent. The second reagent is similarly flowed through the fluidic channel with the reagent displacement mechanism (e.g., as shown in FIG. 6C).

### System 700

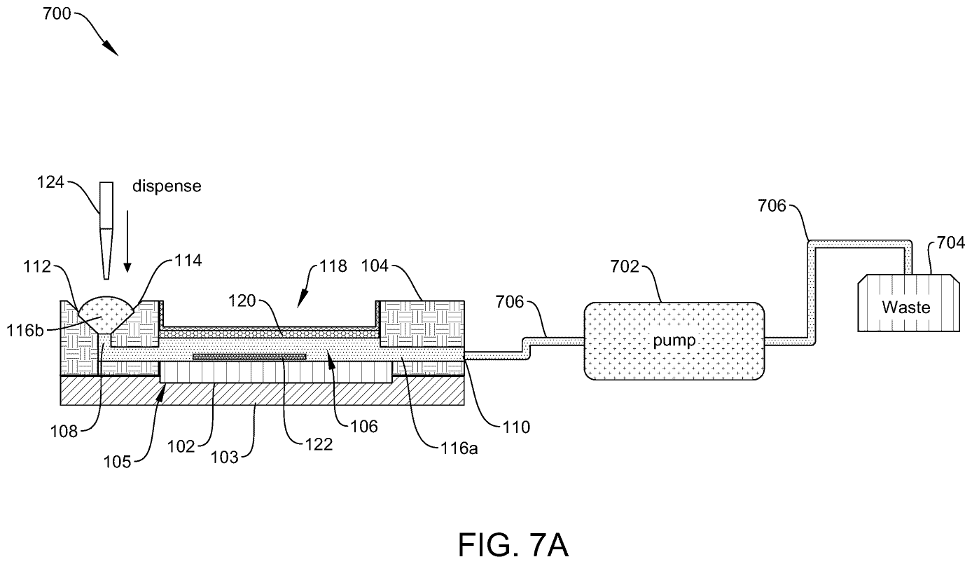

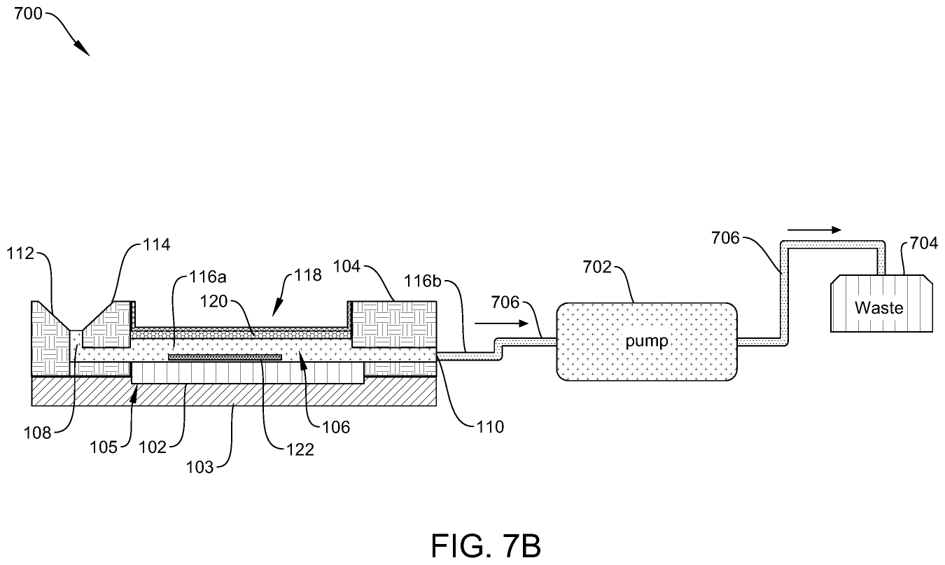

FIG. 7A-FIG. 7B are schematic representations of a side view of an exemplary system 700. As shown in FIG. 7A-FIG. 7B, the system 700 includes a device (e.g., device 100), reagent dispensing mechanism 124, and a reagent displacement mechanism 702 configured to flow a volume of one or more reagents from the first reservoir 112, to the inlet 108, through the fluidic channel 106, and out through to the outlet 110. The reagent displacement mechanism 702 is a fluid pump (e.g., syringe pump, peristaltic pump, piston pump, diaphragm pump, gear pump, positive displacement pump).

In some embodiments, the reagent displacement mechanism 702 is disposed downstream from and in fluidic communication with the outlet (e.g., as shown in FIG. 7A-FIG. 7B). In some embodiments, tubing 706 can be used to fluidically couple the reagent displacement mechanism and the outlet 110, thereby defining a fluidic pathway between the two elements. In some embodiments, a waste container 704 configured to receive the liquid reagent 116 is downstream from and fluidically coupled to the reagent displacement mechanism 702.

In some embodiments, the reagent displacement mechanism 702 generates a negative pressure (e.g., a pressure lower than the pressure external to the flow cell body), effectively drawing the liquid reagent from the first reservoir 112, through the fluidic channel 106, and out through the outlet 110. The negative pressure generated by the reagent displacement mechanism 702 can be adjusted to control the flow rate of the liquid reagent. By increasing the level of negative pressure, the reagent displacement mechanism 702 can draw liquid more rapidly, increasing the flow rate. Conversely, by decreasing the level of negative pressure, the reagent displacement mechanism 702 generates a weaker vacuum effect, slowing down the flow rate.

In some embodiments, the reagent displacement mechanism 702 is disposed upstream from and in fluidic communication with the inlet 108, while the waste container 704 is disposed downstream from and in fluidic communication with the outlet 110. In some embodiments, tubing 706 can be used to fluidically coupled the reagent displacement mechanism and the inlet 108, thereby defining a fluidic pathway between the two elements. In some embodiments, the reagent displacement mechanism 702 generates a positive pressure to inject liquid reagent and flow it from the first reservoir 112, through the fluidic channel 106, and out through the outlet 110. The positive pressure generated by the reagent displacement mechanism 702 can be adjusted to control the flow rate of the liquid reagent.

FIG. 7A-FIG. 7B illustrate a sequence of illustrations of an exemplary workflow of system 700. FIG. 7A illustrates a reagent 116a disposed within the fluidic channel 106 and a reagent 116b in the first reservoir 112. The reagent displacement mechanism 702 flows liquid reagent through the fluidic channel of the flow cell body, while simultaneously displacing the liquid level of the reagent in the first reservoir 112 in response to fluid flow. When the liquid level of the first reagent 116a in the first reservoir 112 is at the inlet 108 or a predetermined height above the inlet 108, a second reagent 116b can be dispensed into the reservoir 112, creating a continuous liquid interface between the first reagent 116a and the second reagent 116b. The second reagent 116B is similarly flowed through the fluidic channel using the reagent displacement mechanism 702 (e.g., as shown in FIG. 7B). In some embodiments, the reagent displacement mechanism 702 is inactivated (e.g., the flow rate is at or about 0) when the liquid level of the reagent is at the inlet 108 or a predetermined distance above the inlet 108. In some embodiments, when the liquid level rises above the level of the sensor, the reagent displacement mechanism 702 is activated.

### Exemplary Workflow of Systems

The replacement of a liquid reagent with another, after it has flowed through the flow cell body, can be referred to as a fluid exchange. Following a fluid exchange, the biological sample can be incubated (e.g., on the substrate 102 or bottom layer 206). In some embodiments, a second liquid reagent can be flowed through the flow cell body after the first liquid reagent. In some embodiments, multiple liquid reagents can be sequentially flowed one after another through the closed flow cell body prior to incubation of the sample. The liquid reagent can remain within the fluidic channel for a specified period of time. The biological sample can be incubated on the substrate by adjusting the temperature of the top layer (e.g., top layer 104, 208), the bottom layer (e.g., bottom layer 103, 206), or both, allowing for heating or cooling as necessary. A heating element and/or cooling element can be coupled to the flow cell body (e.g., coupled to the bottom surface of the bottom layer 103, 206 and/or coupled to the top layer 104, 208). Additionally or alternatively, the liquid reagent can be heated or cooled prior to flowing through the closed flow cell. During incubation, the reagent displacement mechanism can be disabled.

Multiple fluid exchanges and incubations can be performed. Each fluid exchange can adjust the chemical environment, while subsequent incubations can facilitate reactions or interactions with the sample. By way of example, different liquid reagents can be exchanged individually, with an incubation occurring after each exchange. In another example, the same liquid reagent can be exchanged and incubated multiple times with a given sample. In some embodiments, the same liquid reagent can be exchanged multiple times before incubation. In some embodiments, the same liquid reagent is exchanged only once prior to incubation, followed by a subsequent exchange after incubation. Following fluid exchange(s) and/or incubation(s), the biological sample can be imaged. A buffer reagent can be dispensed in the second reservoir (e.g., second reservoir 118, 221) of the device, after which an objective lens (e.g., objective lens 125, 226) can be immersed in the buffer reagent.

Washing buffers can be flowed through the flow cell between fluid exchanges and/or incubations to remove unbound substances, contaminants, salt build-ups, or excess reagents. Water (deionized water, RNase free water, etc.) and/or imaging buffer (e.g., 5% glycerol solution) may be added periodically around the flow cell body to regulate the concentration of solution and/or clean the surfaces of the top layer, bottom layer, and other components that come into contact with reagents.

In some embodiments, the same liquid reagent can be exchanged one or more times. In some embodiments, the liquid reagent is flowed from the outlet (e.g., outlet 110, 214) to the first reservoir (e.g., first reservoir 112, 202). For example, and without limitation, if the reagent displacement mechanism includes a pivot table, the angle of inclination of the pivot table can be adjusted such that the inlet (e.g., inlet 108, 212) is positioned lower than the outlet (e.g., outlet 110, 214). The gravitational force acting on the liquid reagent creates a pressure differential that facilitates the movement of the reagent back through the closed flow cell body. This can minimize waste and conserve the liquid reagent. In another example, if the reagent displacement mechanism includes a pipette or a fluid pump, fluid exchange can occur by aspirating the reagent through the outlet and then dispensing the reagent (e.g., the same aspirated reagent volume) through the opening of the first reservoir. The reagent displacement mechanism may be configured to aspirate liquids from the outlet and dispense liquids into the first reservoir.

### System 800

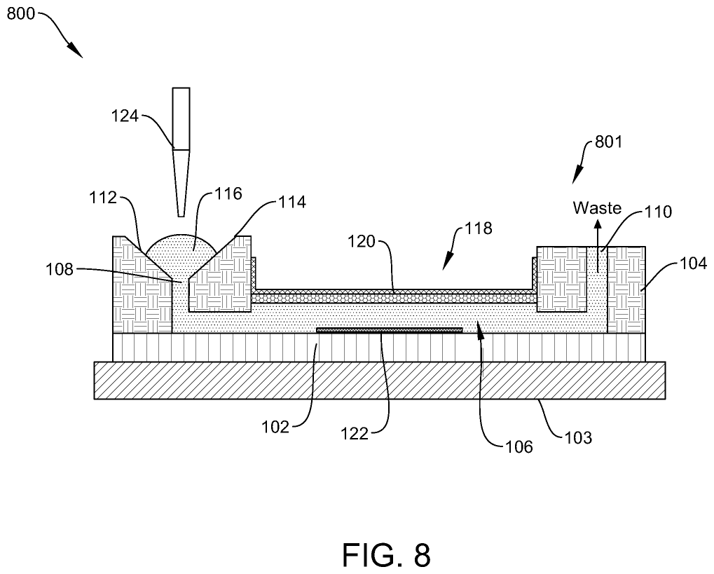

FIG. 8 is a schematic representation of a side view of an exemplary device 800. As shown in FIG. 8, the device 800 is substantially similar to the device of FIG. 1A and includes a flow cell body 801, having a first reservoir 112 and a second reservoir 118. However, in FIG. 8, a top layer 104 is positioned directly on top of a substrate having a sample positioned thereon to thereby define a fluidic channel 106 between the top layer 104 and the substrate. As shown in FIG. 8, the substrate 102 is positioned on the bottom layer for support. In various embodiments, the bottom layer 103 includes a Z-stage configured to raise and lower the flow cell body. In various embodiments, the bottom layer includes an XY stage configured to translate the flow cell body in X and/or Y directions.

Similar to FIG. 1A, the flow cell body includes a coupled configuration (e.g., when the top layer 104 is aligned about a vertical (or Z-axis) and coupled with the substrate 102, forming the closed flow cell body) and an uncoupled configuration (when the top layer 104 is positioned away from the bottom layer 103). In some embodiments, the substrate 102 and the top layer 104 are stackable. For example, the top layer 104 can be reversibly coupled to the substrate 102 by pressing the top layer 104 and substrate 102 together to form a seal. In some embodiments, a mechanical instrument (e.g., an optofluidic instrument) can be used to align and press the top layer 104 and substrate 102 together.

In some embodiments, in the coupled configuration, at least a portion of the bottom surface of the top layer 104 contacts the top surface of the substrate 102 (e.g. around a perimeter of the top layer 104 and substrate 102). In some embodiments, in the coupled configuration, a portion of the top layer 104 contacts the substrate 102. In some embodiments, the substrate 102 and the top layer 104 form a fluid-tight seal in the coupled configuration. In some embodiments, a sealing component (e.g., a gasket, adhesive, low tack tape) is used to form the fluid-tight seal (e.g., around the fluidic channel 106) between the top layer 104 and substrate 102. In some embodiments, the height of the sealing component determines the height of the fluidic channel 106. In some embodiments, the sealing component defines sidewalls of the fluidic channel 106. In some aspects, this can ensure consistent and repeatable dimensions for the flow cell across multiple uses (e.g., repeated coupling and uncoupling of the top layer to reversibly form the closed flow cell). The sealing component can be configured to compress when the flow cell body is in the coupled configuration. The sealing component can be positioned on (e.g., is affixed to) at least one of the substrate 102 or the top layer 104. For example, the sealing component can be disposed on the substrate 102 such that the sealing component wraps around at least a portion of the substrate 102 (e.g., along the longitudinal side of the substrate). In another example, a groove (e.g., a half-dovetail groove) may be formed in the bottom surface of the top layer 104 such that a gasket may be inserted and secured therein. In some embodiments, the height of the gasket determines the height of the fluidic channel 106 (i.e., the distance between the bottom surface of the top layer 104 and the top surface of the substrate 102).

In some embodiments, an outer edge of the sealing component aligns with an edge of the substrate 102. In some embodiments, an outer edge of the sealing component is spaced inwardly from an outer edge of the substrate 102 (e.g., spaced inwardly from a portion of the substrate containing a barcode or labeling). In some embodiments, an outer edge of the sealing component aligns with an edge of the top layer 104. In some embodiments, the outer edge of the sealing component is spaced inwardly from an outer edge of the top layer 104.

In some embodiments, one or more hard stops (not shown) extend down from the bottom surface of the top layer 104 to thereby define a height of the reversible, closed flow cell body. In some embodiments, the one or more hard stops are integrally formed with the top layer 104. In some embodiments, the one or more hard stops are separate from, and attached to, the top layer 104.

The fluidic channel 106 (e.g., a rectangular fluidic channel) extends (e.g., longitudinally) along the flow cell body and includes an inlet 108 (e.g., a circular or rectangular inlet) at a first side of the flow cell body, an outlet 110 (e.g., a circular outlet, a rectangular outlet) at a second side of the flow cell body, and a central portion between the inlet and the outlet. A portion of the fluidic channel 106 extends through the thickness of the top layer 104. In some embodiments, the first side of the flow cell body is disposed (e.g., longitudinally) opposite of the second side. In some embodiments, the inlet 108 is perpendicular to the outlet 110. In some embodiments, the outlet 110 is oriented parallel or substantially parallel (e.g., with deviations of less than 10 degrees from true parallelism) to the inlet 108, as shown in FIG. 8. In some embodiments, the outlet 110 is disposed above the central portion of the fluidic channel. In some embodiments, the outlet 110 of the fluidic channel 106 is horizontally aligned with the central portion of the fluidic channel 106. In some embodiments, the central portion of the fluidic channel has a volume of about 50 μL to about 200 μL. In some embodiments, the central portion of the fluidic channel has a height of about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 100 μm, about 105 μm, about 110 μm, about 115 μm, about 120 μm, about 125 μm, about 130 μm, about 135 μm, about 140 μm, about 145 μm, about 150 μm, about 155 μm, about 160 μm, about 165 μm, about 170 μm, about 175 μm, about 180 μm, about 185 μm, about 190 μm, about 195 μm, about 200 μm, about 205 μm, about 210 μm, about 215 μm, about 220 μm, about 225 μm, about 230 μm, about 235 μm, about 240 μm, about 245 μm, about 250 μm, about 255 μm, about 260 μm, about 265 μm, about 270 μm, about 275 μm, about 280 μm, about 285 μm, about 290 μm, about 295 μm, about 300 μm. In some embodiments, the central portion of the fluidic channel has a height of about 25 μm to about 300 μm. In some embodiments, the central portion of the fluidic channel has a height of about 100 μm to about 200 μm. In some embodiments, a sensor (e.g., a pressure sensor, a flow meter sensor, optical sensor) is disposed along the fluidic channel 106 (e.g., at the inlet or at the outlet).

In some embodiments, a waste container is in fluidic communication with the outlet 110 and receives the one or more liquid reagents flowed out through the outlet. Tube connectors and/or tubing (e.g., flexible tubing) can be used to fluidically couple the outlet 110 and the waste container. Tubing can be routed from the outlet 110 to the waste container, thereby defining a fluidic pathway between the two elements. In some embodiments, the outlet 110 provides an interface for connecting with tubing

The bottom layer 103 includes a body having a top surface, a bottom surface, and a thickness therebetween. The bottom layer 103 is configured to receive a substrate 102 (e.g., a glass slide, microscope slide, cover glass, cover slip) with one or more samples 122 (e.g., biological tissue sample, a hydrogel having analytes affixed therein) disposed on the substrate 102. The substrate 102 is positioned on (or removably coupled to) the bottom layer 103. In the coupled configuration, the sample 122 (e.g., biological sample) is positioned within the central portion of the fluidic channel 106. In some embodiments, the bottom layer has a planar top surface. In some embodiments, the bottom layer 103 includes a recess 105 (e.g., a rectangular recess), which defines an interior surface sized and shaped to receive the substrate 102. A recess as used herein is a cavity or indentation formed in the surface of a component and having a depth. In some embodiments, the depth of the recess 105 is approximately the height of the substrate 102. The bottom layer 103 can be formed of one or more materials, including, but not limited to, a metal or metal alloy (e.g., aluminum, brass, copper, stainless steel, etc.) or a polymer (e.g., acrylic, polycarbonate, polypropylene, polyvinyl chloride, etc.). In some embodiments, at least a portion of the bottom layer 103 is optically transparent. In some embodiments, the bottom layer 103 includes an aperture extending through the thickness of the layer and positioned such that, when the substrate 102 is disposed on the bottom layer 103, it extends over the aperture.

The top layer 104 includes a body having a top surface, a bottom surface, and a thickness therebetween. The top layer 104 can be formed of one or more materials, including, but not limited to, a metal or metal alloy (e.g., aluminum, brass, copper, stainless steel, etc.) or a polymer (e.g., acrylic, polycarbonate, polypropylene, polyvinyl chloride, etc.). In some embodiments, at least a portion of the top layer 104 defines a planar surface. The top layer 104 includes a first reservoir 112 (e.g., a conical or rectangular trough) and a second reservoir 118. The first reservoir 112 includes at least one sidewall formed in a portion of the top layer 104. The first reservoir 112 can be sized and shaped to at least partially receive a reagent dispensing mechanism 124 (e.g., pipette, fluid pump, nozzle, or a syringe with a needle) configured to dispense liquid reagent. The at least one sidewall can taper from the first opening 114 to the inlet 108 of the fluidic channel 106. In some embodiments, the width or diameter of the first opening 114 is larger than the width or diameter of the inlet 108. In some embodiments, the first opening 114 and the inlet 108 have the uniform dimensions. In some embodiments, the first reservoir 112 is configured to hold a fluid volume about equal to the volume of the fluidic channel 106. In some embodiments, the first reservoir 112 is configured to hold a fluid volume of about 50 μL. In some embodiments, the first reservoir 112 is configured to hold a fluid volume of about 100 to about 150 μL. In some embodiments, the first reservoir 112 is configured to hold a fluid volume of about 200 μL. In some embodiments, the first reservoir 112 is configured to hold a fluid volume of up to about 500 μL In some embodiments, the first reservoir 112 is configured to hold a fluid volume of up to about 50 μL to about 500 μL. In some embodiments, the first reservoir 112 is configured to hold a fluid volume of up to about 100 μL to about 400 μL. In some embodiments, the first reservoir 112 is configured to hold a fluid volume of up to about 100 μL to about 300 μL. In some embodiments, the first reservoir 112 is configured to hold a fluid volume of up to about 100 μL to about 200 μL. The first reservoir 112 can be in fluid communication with the surrounding environment (e.g., ambient air). The first reservoir 112 is disposed proximate to (e.g., disposed above) and in fluidic communication with the inlet 108.

In the coupled configuration, the first reservoir 112, inlet 108, and outlet 110 are in fluidic communication. One or more liquid reagents can be introduced (e.g., using a reagent dispensing mechanism) into the first reservoir 112 and flowed from the inlet 108 through the fluidic channel and out through the outlet 110. A pipette (e.g., manual or automatic (electronic) pipette), nozzle, or a syringe with a needle can be used to deliver at least one liquid reagent to the first reservoir 112. Other reagent dispensing mechanisms (e.g., syringe pump, piston pump, diaphragm pump, gear pump, positive displacement pump) can be used to deliver at least one liquid reagent to the first reservoir 112.

In some embodiments, the first reservoir 112 includes a membrane (e.g., a pierceable septum membrane) disposed over the first opening 114. The membrane can be shaped and sized to completely cover the first opening 114 of the first reservoir 112, providing a physical barrier that reduces loss of liquid by evaporation. In some embodiments, the membrane extends into the first reservoir 112. The membrane can be formed of one or more materials including, but not limited to, flexible materials such as rubber and silicone. The membrane allows for the introduction or withdrawal of liquids while maintaining an airtight and/or leak-proof seal. In some embodiments, a pipette tip or needle tip is configured to penetrate through the thickness of the membrane. In some embodiments, the membrane is configured to reseal once the tip is removed.

In some embodiments, at least a portion of the top layer 104, such as the bottom surface, is coated with a chemical layer (e.g., a hydrophilic coating, a hydrophobic coating) that modifies surface wettability. In some embodiments, at least a portion of the top layer 104, such as the bottom surface, is formed of a material (e.g., a hydrophilic material, hydrophobic material) that modifies surface wettability. Modifying the surface wettability of the top layer 104 can prevent bubble deformation and/or carryover (e.g., transfer of residual liquid reagent and/or sample from one substrate to another substrate). A hydrophilic material and/or hydrophilic coating may prevent bubble deformation. A hydrophobic material and/or hydrophobic coating may prevent carryover.

The second reservoir 118 is formed in the top layer 104, defining an interior volume with sidewalls and an optically clear base 120 (e.g., cover slip, a glass slide). In some embodiments, the second reservoir 118 is configured to hold a fluid volume of about 1 mL. In some embodiments, the second reservoir 118 is configured to hold a fluid volume of about 10 mL. In some embodiments, the second reservoir 118 is configured to hold a fluid volume of about 30 mL. In some embodiments, the base 120 defines a planar surface. In some embodiments, the base 120 is integral with the top layer 104. In some embodiments the base 120 is separate from the top layer 104. For example, the top layer 104 can include notches configured to receive and align the base 120 such that it is substantially parallel with the substrate 102 and positioned above the sample 122 (e.g., biological sample). The base 120 defines an imageable area over which an imaging device (e.g., objective lens part of an optical system in an optofluidic instrument) can be used to image the biological sample. In some embodiments, the imageable area is smaller than the optically clear area of the base 120. In some embodiments, the optically clear area of the base 120 is about 2 cm². In some embodiments, the optically clear area of the base 120 is about 3 cm². In some embodiments, the optically clear area of the base 120 is about 5 cm². In some embodiments, the optically clear area of the base 120 is about 10 cm². In some embodiments, the optically clear area of the base 120 is about 2 cm² to about 10 cm².In some embodiments, the interior side walls of the second reservoir 118 have an inner wall angle that matches an angle of the objective, allowing for increased travel distance of the objective when immersed in the second reservoir 118.

In the coupled configuration, the second reservoir 118 is positioned above the central portion of the fluidic channel 106, allowing for unobstructed access to the sample 122 (e.g., biological sample) for visualization.

In some embodiments, a well wall (e.g., a lightweight gasket) is disposed around the base 120, thereby defining an open well capable of containing a predetermined amount of fluid. In some embodiments, the well wall has an inner wall angle that matches an angle of the objective lens.

### System 1100, 1200

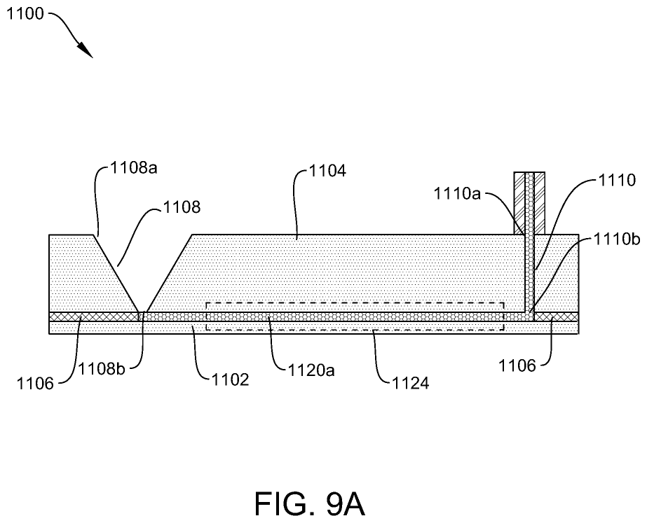

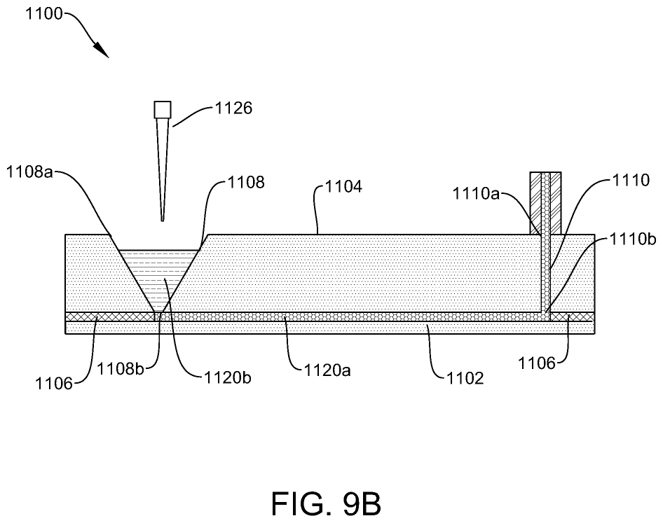

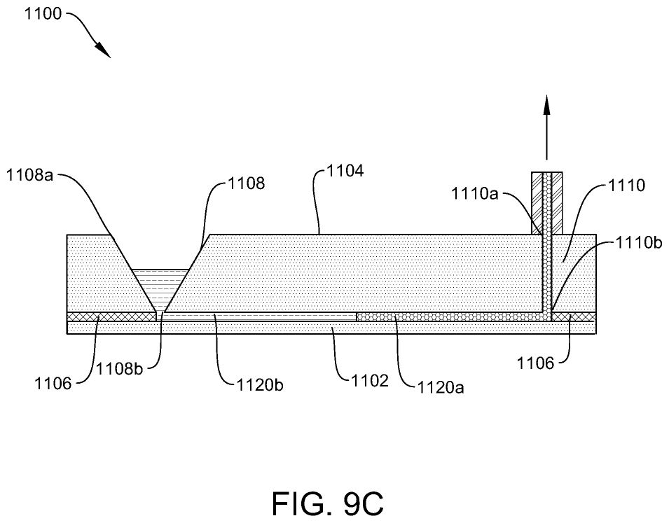

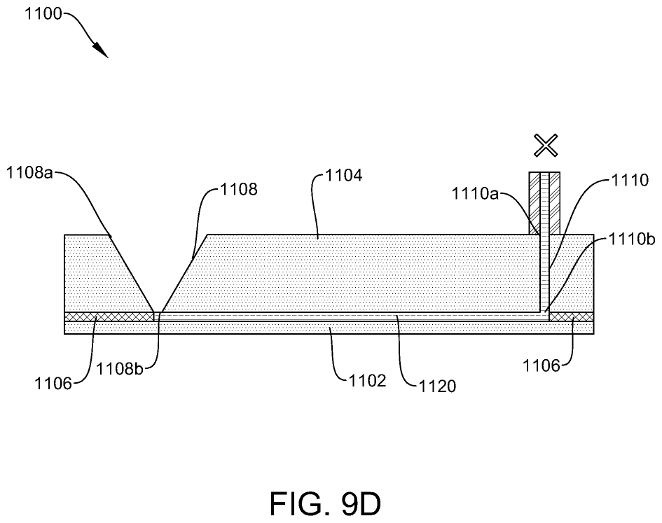

FIGS. 9A-9D are schematic representations of a side view of a system 1100 for delivering one or more reagents to one or more samples in a pseudo flow cell. The system 1100 may be implemented substantially similarly to the pseudo flow cells described and illustrated above (e.g., in FIGS. 1A-1B) and may include any combination (or all) of the same components. As shown in FIGS. 9A-9D, the system 1100 includes a bottom layer 1102, a top layer 1104, and a gasket 1106. In particular, FIGS. 9A-9D illustrate the delivery of a first reagent 1120a followed by a second reagent 1120b into the pseudo flow cell. A substrate (e.g., glass slide) is configured to receive one or more samples and may be positioned on the bottom layer 1102, as described and illustrated in the figures (e.g., FIGS. 1A-1B). In some embodiments, the substrate is a standard glass microscope slide. In some embodiments, because a vast majority of archival samples are positioned and stored on standard microscope slides, the top layer 1104 and bottom layer 1102 are adapted (e.g., sized) for standard microscope slides. The top layer 1104 includes a body having a top surface, a bottom surface, and a thickness therebetween. The top layer 1104 can be formed of one or more materials, including but not limited to a metal or metal alloy (e.g., aluminum, brass, copper, stainless steel, etc.), or a polymer (e.g., acrylic, polycarbonate, polypropylene, polyvinyl chloride, polyether ether ketone (PEEK), etc.). In some embodiments, the top layer 1104 is formed as a lid.

When a gasket is used between the top layer and the bottom layer, the gasket 1106 forms a fluid-tight seal between the top layer 1104 and the bottom layer 1102, thereby defining a closed flow cell volume therebetween when the gasket 1106 is in contact with the bottom layer 1102 and the top layer 1104. In some embodiments, the gasket 1106 is positioned on (e.g., is affixed to) the bottom layer. In some embodiments, the gasket 1106 is positioned on the bottom surface of the top layer 1104. For example, a groove (e.g., a half-dovetail groove) may be formed in the bottom surface of the top layer 1104 such that the gasket 1106 may be inserted and secured therein. In some embodiments, the height of the gasket 1106 can determine the height of the pseudo flow cell (i.e., the distance between the bottom surface of the top layer 1104 and the top surface of the bottom layer 1102) when in the coupled configuration.

The top layer 1104 includes a first reservoir 1108 disposed proximate a first side of the top layer 1104 and a fluidic outlet 1110 disposed proximate a second side of the top layer 1104. In some embodiments, the first side of the top layer 1104 is disposed (e.g., longitudinally) opposite of the second side. The first reservoir 1108 can be configured to receive and hold a volume of a liquid reagent(s). In some embodiments, the first reservoir 1108 has a volume of about 50 μl to about 10 ml. In some embodiments, the first reservoir 1108 has a volume of about 2 ml to about 5 ml. In some embodiments, the first reservoir has a volume of about 3 ml.

In some embodiments, an outer edge of the gasket 1106 aligns with an edge of the top layer 1104. In some embodiments, the outer edge of the gasket 1106 is spaced inwardly from an outer edge of the top layer 1104.

The top layer 1104 can be aligned above the bottom layer 1102. For example and without limitation, an outer edge (e.g., the outermost edge) of the bottom surface of the top layer 1104 can be aligned with the area enclosed by the gasket 1106. In another example without limitation, an outer edge (e.g., the outermost edge) of the bottom surface of the top layer 1104 can be aligned with the outer edge of the gasket 1106. If the gasket 1106 is disposed on the bottom layer 1102, the top layer 1104 and the gasket 1106 form a seal with the bottom layer when the top layer 1104 contacts the gasket 1106. If the gasket 1106 is disposed on the bottom surface of the top layer 1104, the top layer 1104 and the gasket 1106 form a seal with the bottom layer 1102 when the gasket 1106 contacts the bottom layer 1102.

The top layer 1104 may be similar or the same as any of the top layers described and illustrated above (e.g., top layer 104 in FIGS. 1A-1B). For example, the top layer 1104 may include a second reservoir that is an open well configured to hold a liquid (e.g., an imaging fluid) and with an optically clear bottom for illuminating and imaging the sample.

In some embodiments, at least a portion of the top layer 1104, such as the bottom surface, is coated with a chemical layer (e.g., a hydrophilic coating, a hydrophobic coating) that modifies surface wettability. In some embodiments, at least a portion of the top layer 1104, such as the bottom surface, is formed of a material (e.g., a hydrophilic material, hydrophobic material) that modifies surface wettability. Modifying the surface wettability of the top layer 1104 can prevent bubble deformation and/or carryover (e.g., transfer of residual liquid reagent and/or sample from one substrate to another substrate). A hydrophilic material and/or hydrophilic coating may prevent bubble deformation, for example, when coupling the top layer 1104 and the bottom layer 1102. A hydrophobic material and/or hydrophobic coating may prevent carryover. In some embodiments, the top layer has corrosion resistant properties (i.e., the top layer material is corrosion resistant) and/or a corrosion resistant coating, depending on the anticipated reagents (e.g., salt solutions, high pH reagents, low pH reagents, etc.) with which the top layer will come into contact.

Still referring to FIGS. 9A-9D, and in greater detail, the first reservoir 1108 can extend from the top surface to the bottom surface of the top layer 1104. The longitudinal axis of the first reservoir 1108 can be substantially perpendicular to the top surface of the top layer 1104. The first reservoir 1108 can include a first opening 1108a on the top surface of the top layer 1104 and a second opening 1108b on the bottom surface of the top layer 1104. In some embodiments, the first reservoir 1108 (e.g., trough) is configured to hold a fluid volume of about 50 μl to about 500 μl. In some embodiments, the first reservoir 1108 (e.g., trough) is configured to hold a fluid volume of about 100 μl to about 300 μl. In some embodiments, the first reservoir 1108 is configured to hold a fluid volume of about 200 μl. In some embodiments, the first reservoir 1108 is configured to hold a fluid volume of about 50 μl to about 10 ml. In some embodiments, the first reservoir 1108 is configured to hold a fluid volume of about 2 ml to about 5 ml. In some embodiments, the first reservoir 1108 is configured to hold a fluid volume of about 5 ml, about 4 ml, about 3 ml, about 2 ml, or about 1 ml. In some embodiments, the first reservoir 1108 is configured to hold a fluid volume of at least 5 ml, at least 4 ml, at least 3 ml, at least 2 ml, or at least 1 ml. A pipette or a syringe with a needle can be used to deliver at least one liquid reagent to the first reservoir 1108. Other liquid dispensing devices (e.g., syringe pumps) can be used to deliver at least one liquid reagent to the first reservoir 1108.

In some embodiments, both the first opening 1108a and the second opening 1108b of the first reservoir 1108 can be substantially rectangular with rounded ends, with the first opening 1108a wider than the second opening 1108b. The first reservoir 1108 can taper from the first opening 1108a on the top surface of the top layer 1104 to the second opening 1108b on the bottom surface of the top layer 1104. In some embodiments, the first opening 1108a and the second opening 1108b have uniform dimensions.

In some embodiments, the first reservoir 1108 includes a trough (e.g., a circular, conical or rectangular trough) configured to hold a fluid volume. In some embodiments, the trough is configured to hold a fluid volume of about 50 μl to about 10 ml. In some embodiments, the trough is configured to hold a fluid volume of about 3 ml to about 5 ml. In some embodiments, the trough is configured to hold a fluid volume of about 50 μl to about 500 μl. In some embodiments, the trough is configured to hold a fluid volume of about 100 μl to about 300 μl. In some embodiments, the trough is configured to hold a fluid volume of about 200 μl. In some embodiments, the trough is configured to hold a fluid volume of about 5 ml, about 4 ml, about 3 ml, about 2 ml, or about 1 ml. Both the first opening 1108 a and the second opening 1108b of the first reservoir 1108 can be substantially circular, with the first opening 1108a having a larger diameter than the second opening 1108b. The trough can be shaped and sized to at least partially receive the tip 1126 of a pipettor. A pipette or a syringe with a needle can be used to deliver at least one liquid reagent to the first reservoir 1108. Other liquid dispensing devices (e.g., syringe pumps) can be used to deliver at least one liquid reagent to the first reservoir 1108.

In some embodiments, the first reservoir 1108 comprises a membrane (e.g., pierceable septum membrane) disposed over the first opening 1108a. The membrane can be shaped and sized to cover (e.g., circumferentially cover) the first opening 1108a of the first reservoir 1108, providing a physical barrier that reduces loss of liquid by evaporation. The membrane can be formed of one or more materials including but not limited to flexible materials such as rubber and silicone. The membrane can allow for the introduction or withdrawal of liquids while maintaining an airtight and/or leak-proof seal. A pipette tip or needle tip can penetrate through the thickness of the membrane. In some embodiments, the membrane is configured to reseal once the tip is removed.

The fluidic outlet 1110 can extend from the top surface to the bottom surface of the top layer 1104. The longitudinal axis of the fluidic outlet 1110 can be substantially perpendicular to the top surface of the top layer 1104. The fluidic outlet 1110 can include a first opening 1110a on the top surface of the top layer 1104 and a second opening 1110b on the bottom surface of the top layer 1104. In some embodiments, both the first opening 1110a and the second opening 1110b of the fluidic outlet 1110 can be substantially rectangular with rounded ends. The first opening 1110a and the second opening 1110b can have substantially uniform dimensions (e.g., equal widths) or different dimensions. In some embodiments, both the first opening 1110a and the second opening 1110b of the fluidic outlet 1110 are substantially circular. The first opening 1110a and the second opening 1110b can have substantially equal diameters or different diameters.

In some embodiments, the fluidic outlet 1110 comprises a trough (e.g., a circular, conical, or rectangular trough). In some embodiments, the first reservoir 1108 (e.g., the first opening 1108a and/or the second opening 1108b) has a larger cross-sectional area than the fluidic outlet 1110 (e.g., the first opening 1110a and/or the second opening 1110b).

A fluid pump (e.g., a vacuum pump, syringe pump, positive displacement pump, centrifugal pump, axial flow pump, etc.) can be positioned downstream and in fluid communication with the fluidic outlet 1110. In some embodiments, the fluid pump is configured to control pressure (e.g., generate a negative pressure) to drive fluid flow. In some embodiments, the fluid pump is configured to control flow rate to drive fluid flow (e.g., syringe pump, peristaltic pump, piezoelectric pump, piston pump, etc.). The fluid pump can be configured to flow at least one reagent from the first reservoir 1108 and through the closed flow cell when the system is in a coupled configuration. Tube connectors and/or tubing (e.g., flexible tubing) can be used to fluidically couple the fluid pump and the fluidic outlet 1110. In some embodiments, the fluidic outlet 1110 provides an interface for connecting with tubing. The tubing can be routed from the fluidic outlet 1110 to the fluid pump, thereby defining a fluidic pathway between the two elements. Tubing can be made of one or more materials including but not limited to silicone, polyvinyl chloride, thermoplastic elastomers, polyethylene, nylon, polyurethane.

A valve (e.g., a two-way valve, directional control valve, solenoid valve, iris valve, ball valve, needle valve) can be fluidically coupled between the fluid pump and the fluidic outlet 1110. In some embodiments, the valve is used to open or close the fluidic pathway between the fluid pump and the fluidic outlet 1110, thereby regulating the flow of fluid. In some embodiments, the valve is used to control the direction of the flow in the fluidic pathway (between the fluid pump and the fluidic outlet 1110). In some embodiments, the valve is a plurality of valves.

### Operation of System 1100, 1200

In operation, the top layer 1104 and the bottom layer 1102 form a closed flow cell defining a small volume around the sample. For example, the volume is about 50 μl to about 100 μl, about 50 μl to about 200 μl, about 50 μl to about 300 μl, about 50 μl to about 400 μl, about 50 μl to about 500 μl, about 100 μl to about 200 μl, about 100 μl to about 250 μl, about 100 μl to about 300 μl, about 100 μl to about 350 μl, about 100 μl to about 400 μl, about 100 μl to about 500 μl, about 150 μl to about 200 μl, about 150 μl to about 250 μl, about 150 μl to about 300 μl, about 150 μl to about 350 μl, about 150 μl to about 400 μl, about 150 μl to about 500 μl. The volume of the closed flow cell is a volume enclosed by the bottom layer 1102 and the bottom surface of the top layer 1104 (and, in embodiments with a gasket, also enclosed by gasket 1106). When the pseudo flow cell is assembled, an outer edge of top layer 1104 can be aligned with the outer edge of the gasket 1106 and/or the top layer 1104.

In some embodiments, the gasket 1106 is configured to compress after the system is assembled (e.g., if an external clamping force is applied to the pseudo flow cell). In some embodiments, the height of the gasket 1106 can determine the overall height (and thus the internal fluidic volume) of the closed flow cell. In some embodiments, in the coupled configuration, a distance between the bottom layer 1102 and the bottom surface of the top layer 1104 is about 50 μm to about 200 μm. In other embodiments, in the coupled configuration, the distance between the bottom layer 1102 and the bottom surface of the top layer 1104 is about 75 μm to about 150 μm. In some embodiments, the distance between the bottom layer 1102 and the bottom surface of the top layer 1104 is about 50 μm to about 100 μm. In some embodiments, the distance between the bottom layer 1102 and the bottom surface of the top layer 1104 is about 50 μm to about 75 μm. In some embodiments, the distance between the bottom layer 1102 and the bottom surface of the top layer 1104 is about 25 μm to about 100 μm. In some embodiments, the distance between the bottom layer 1102 and the bottom surface of the top layer 1104 is about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, about 150 μm, about 155 μm, about 160 μm, about 165 μm, about 170 μm, about 175 μm, about 180 μm, about 185 μm, about 190 μm, about 195 μm, about 200 μm.

In the coupled configuration, the first reservoir 1108 and the fluidic outlet 1110 are in fluid communication. A liquid reagent can be introduced into the closed flow cell via the first reservoir 1108 and subsequently flowed through the closed flow cell and out through the fluidic outlet 1110 using a fluid pump, such as vacuum pump. The first reservoir 1108 can be in fluid communication with the surrounding environment (e.g., ambient air). The vacuum pump can generate a negative pressure (e.g., a pressure lower than the pressure external to the system 1100), effectively drawing the liquid reagent from the first reservoir 1108 (e.g., a trough containing the liquid reagent) into the closed flow cell and towards the fluidic outlet 1110. The negative pressure generated by the vacuum pump can be adjusted to control the flow rate of the liquid reagent. By increasing the level of negative pressure, the vacuum pump can draw liquid more rapidly, increasing the flow rate. Conversely, by decreasing the level of negative pressure, the vacuum pump generates a weaker vacuum effect, slowing down the flow rate. A weak vacuum effect can be applied to the system when it is in the coupled configuration and there is a liquid reagent 1120 disposed in the closed flow cell. This weak vacuum pressure can balance with capillary pressure, effectively pinning the liquid reagent proximate a first side of the top layer 1104 (e.g., proximate the second opening 1108b of the first reservoir 1108). The weak vacuum effect can prevent migration of the liquid reagent away from the sample area (i.e., area where the samples are located). The weak vacuum effect can maintain contact between the liquid reagent and the surfaces of the closed flow cell (i.e., the bottom layer 1102 and the top layer 1104). In some embodiments, the weak vacuum effect is configured to empty the contents of the first reservoir 1108, preparing the first reservoir 1108 for the next reagent to be received within minimal to no carryover.

For example and without limitation, after the pseudo flow cell is formed, one or more samples (e.g., biological tissue samples) positioned on the substrate on the bottom layer 1102 are disposed within a region 124 (e.g., a region between the first reservoir 1108 and the fluidic outlet 1110) of the closed flow cell. A first reagent 1120a is dispensed into the first reservoir 1108 and flowed (e.g., drawn via a vacuum) into the closed flow cell where the reagent can react with the one or more samples disposed on the substrate on the bottom layer 1102 (e.g., as illustrated in FIG. 9A). The first reagent 1120a is flowed (from trough 1108 and into the closed flow cell chamber) such that the liquid level within the first reservoir 1108 depletes until it is proximal to the second opening 1108b (e.g., as illustrated in FIG. 9B). After the first reagent is depleted from the first reservoir 1108, a second reagent 1120b can be dispensed into the first reservoir 1108 (e.g., via a pipette), creating a continuous liquid interface between the first reagent 1120a and the second reagent 1120b (e.g., as illustrated in FIG. 9C). In this way, there is no air gap introduced between reagents. The second reagent 1120b is similarly flowed such that its liquid level within the first reservoir 1108 depletes proximal to the second opening 1108b. The flow of the reagent(s) is ceased when the liquid level of a reagent in the first reservoir 1108 nearly, but not completely, depletes (e.g., the liquid level of the reagent is proximal to the second opening 1108b or at the second opening 1108b).

In some embodiments, the flow of the reagent(s) is ceased when the liquid volume of the reagent 1120 in the first reservoir 1108 is depleted to a predetermined threshold liquid volume. Thus, in accordance with an aspect of the disclosure, some amount of reagent (e.g., less than 2 μl) remains within the inlet trough 1108, thereby preventing the drawing air into the flow cell and forming bubbles, as air bubble can prevent fluid from contacting all or a portion of the sample thus causing failure of an analysis experiment.

In some embodiments, the flow of the reagent(s) is ceased by automatically inactivating a fluid pump. In some embodiments, the flow of the reagent(s) is ceased by activating a valve. In some embodiments, the valve is activated to close the fluidic pathway between the fluidic outlet 1110 and the fluid pump, thereby preventing flow of the liquid reagent(s).

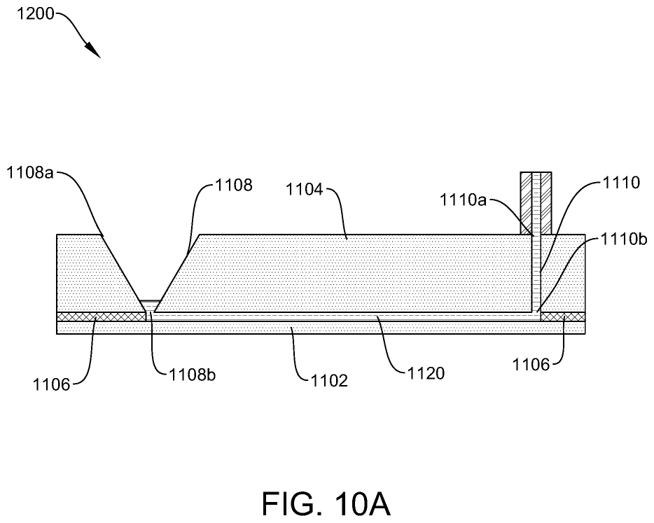

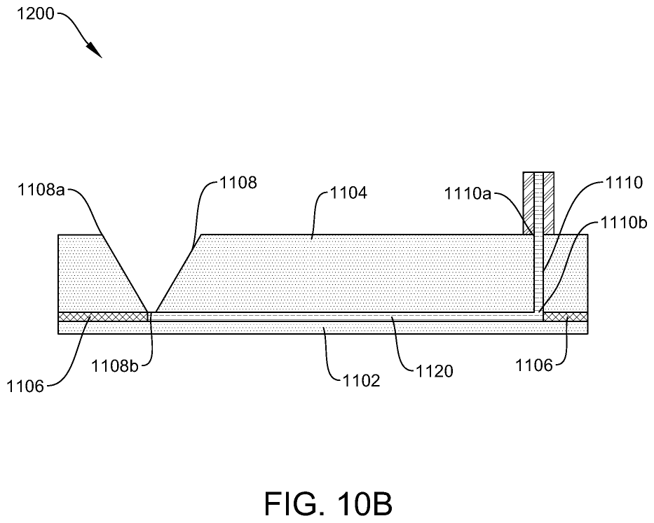

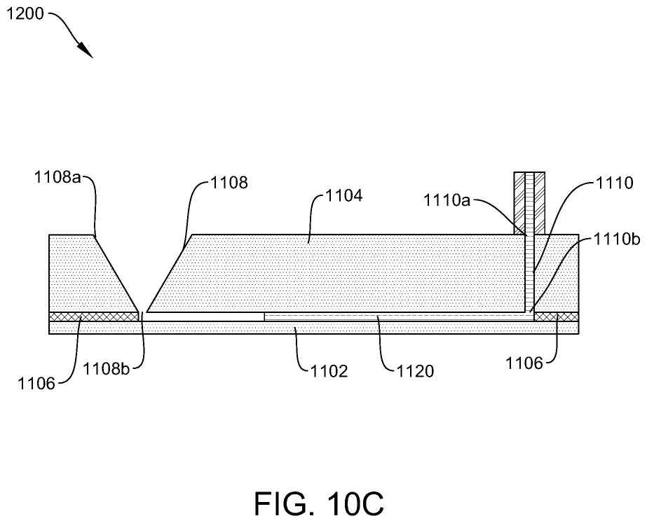

Referring now to FIGS. 10A-10C, schematic representations of a side view of an exemplary system 1200 are shown. In some embodiments, the flow of the reagent(s) is ceased when the liquid level of the reagent 1120 in the first reservoir 1108 is at the second opening 1108b (e.g., as illustrated in FIG. 9B). The system 1200 may be implemented substantially similarly to the pseudo flow cells described and illustrated above (e.g., in FIGS. 1A-1B) and may include any combination (or all) of the same components. In some embodiments, the flow of the reagent(s) is ceased when the liquid level of the reagent 1120 in the first reservoir 1108 is a distance above the second opening 1108b (e.g., as illustrated in FIG. 10A).

Referring to FIG. 10C, when the trailing edge of the reagent 1120 is within the closed flow cell (i.e., the fluid pump continues to flow reagent(s) regardless of the liquid level of a reagent in the first reservoir 1108), air is drawn into the closed flow cell. Introducing air into the closed flow cell can cause bubbles to be retained in or around the sample(s) on the bottom layer 1102, thus an aspect of the present disclosure prevents formation of air bubbles within the flow cell.

In some embodiments, a flow triggering element is used to detect when the liquid level of a reagent (contained in the first reservoir 1108) is at the second opening 1108b, or proximal to the second opening 1108b. The flow triggering element can be configured to detect a first event (e.g., when the liquid level of a reagent is at a first location in the first reservoir 1108 or when the liquid level of the reagent has passed the first location in the first reservoir 1108) and cease the flow of reagent(s) when the first event is detected. The first location can be at the second opening 1108b of the first reservoir 1108 or a distance above the second opening. The detection of the first event can trigger a cease of the flow of reagent(s), which can include inactivating a fluid pump. A fluid pump, in fluid communication with the fluidic outlet 1110, can be operably connected to the flow triggering element. In this way, operation of the fluid pump and the fluid flow can be controlled based on the detection of the first event. The flow of the reagent(s) can automatically resume when the first event is no longer detected (i.e., the liquid level of a reagent in the first reservoir 1108 is above the first location) by the flow triggering element. The flow triggering element can activate the fluid pump when the first event is no longer detected.

In some embodiments, the flow triggering element provides a signal to a control module that is configured to control motion of a pipette and cause the pipette to draw the next reagent in a sequence of reagents (e.g., reagents stored on a reagent deck away from the system 1200) with which the sample is to be contacted. The pipette then transports the next reagent over to the system and dispenses the next reagent into the first reservoir 1108 (e.g., inlet of the trough) in preparation for the next reagent to be flowed through the closed flow cell to contact the sample.

### System 1300

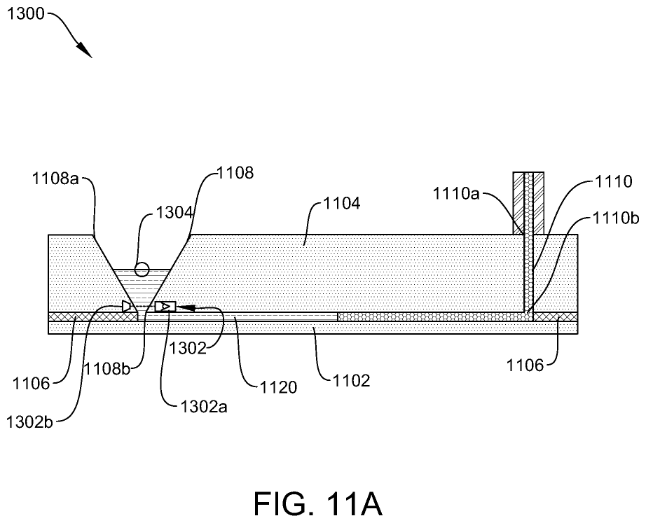

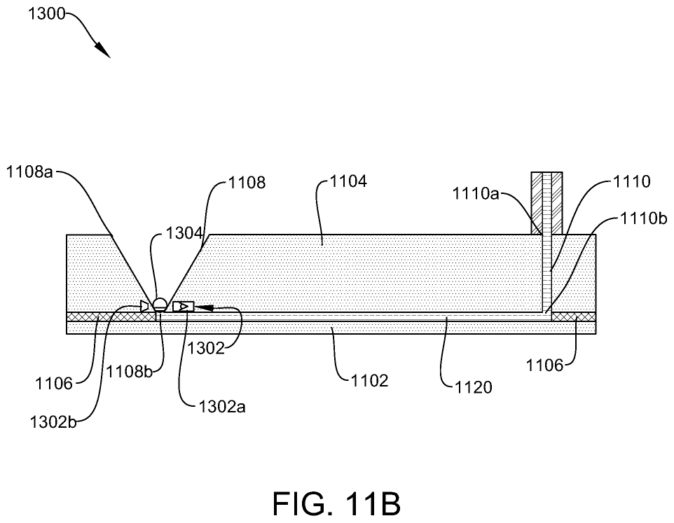

Referring now to FIGS. 11A and 11B, and in brief overview, an exemplary system 1300 includes a bottom layer 1102, a top layer 1104, a gasket 1106 (optional), a fluid pump, and a flow triggering element 1302 (including an optical sensor and a float 1304). The system 1300 may be implemented substantially similarly to the pseudo flow cells described and illustrated above (e.g., in FIGS. 1A-1B) and may include any combination (or all) of the same components. The fluid pump (e.g., vacuum pump, syringe pump, positive displacement pump, centrifugal pump, axial flow pump, etc.) is positioned downstream and in fluid communication with the fluidic outlet 1110. The fluid pump is configured to flow at least one reagent 1120 from the first reservoir 1108 through the closed flow cell and out through the fluidic outlet 1110 when the system is in a coupled configuration. A float 1304 is disposed within a reagent in the first reservoir 1108 and is configured to float at the liquid interface of the reagent (e.g., the float 1304 is buoyant in each reagent that is dispensed into the first reservoir 1108).

In some embodiments, the flow triggering element 1302 is an optical sensor. In some embodiments, the optical sensor is a digital optical sensor (e.g., a beam break optical sensor, a reflective optical sensor) or an analog optical sensor (e.g., a light dependent resistor). In some embodiments, the optical sensor (including an emitter 1302a and receiver 1302b) is positioned at or proximal to the second opening 1108b of the first reservoir 1108. In some embodiments, the optical sensor is integrated within the top layer 1104. The emitter 1302a is aligned with the receiver 1302b and positioned around the first reservoir 1108, such that an optical beam generated by the emitter 1302a is directed transversally across the first reservoir 1108 and received by the receiver 1302b. The optical beam can be a beam of light transmittable through one or more media (e.g., gas and/or liquid), such as an infrared beam, visible light beam, or an ultraviolet beam. In some embodiments, the receiver 1302b is configured to detect transmitted light, reflected light, and/or scattered light. In some embodiments, the receiver 1302b is configured to convert the detected light into an electrical signal that can be used to determine the presence of the float 1304. In some embodiments, the fluid pump is operably connected (e.g., through a controller) to the flow triggering element 1302. In some embodiments, the electrical signal is transmitted to a controller (e.g., a Proportional-Integral-Derivative controller) configured to interpret the electrical signal and trigger an operation of the fluid pump (e.g., vary the flow rate of the pump, inactivate the fluid pump, maintain the fluid pump activated, or reactivate the fluid pump). In this way, the electrical signals from the optical sensor automatically adjust the pump's operation and, consequently, the fluid flow through the closed flow cell.

### Operation of System 1300

In operation, the float 1304 is disposed within a reagent 1120 contained in the first reservoir 1108 and is configured to remain at the liquid interface of the reagent 1120. In some embodiments, the float 1304 is inserted into the first reservoir 1108 (e.g., by a user) at the beginning of every new instrument run (and removed at the end of a run). The fluid pump flows liquid from the first reservoir 1108, through the closed flow cell, and out through the fluidic outlet 1110, responsively displacing the liquid level (i.e., liquid interface) of the reagent in the first reservoir 1108, along with the float 1304, towards the second opening 1108b.

In some embodiments, the flow rate of the fluid pump is varied in response to the electrical signal (i.e., the light intensity detected by the receiver 1302b). In some embodiments (e.g., where an analog optical sensor is used), the controller can vary the flow rate gradually. In some embodiments (e.g., if the electrical signal from the optical sensor is binary), the controller operates in a discrete manner, where the fluid pump is either fully activated or inactivated, without modulation of the flow rate between the two states. The fluid pump is inactivated (i.e., flow is ceased) when the optical sensor detects the float 1304 (e.g., when the float 1304 at least partially obstructs the beam, when the float 1304 completely obstructs the beam). The fluid pump remains activated or is reactivated when the optical sensor does not detect the float 1304 (i.e., the float and liquid level are above the beam). Detection of the float 1304 by the optical sensor indicates when the liquid level of the reagent (contained in the first reservoir 1108) is either proximal to or at the second opening 1108b (i.e., signifying near depletion of the reagent).

In some embodiments, a liquid dispensing system (e.g., pipettor, one or more syringe pumps with tubing leading to the first reservoir 1108) can be used to dispense a volume of reagent into the first reservoir 1108, causing the float 1304 (with the liquid interface of the reagent) to displace above the optical beam, triggering reagent flow through the flow cell to resume. In some embodiments, the liquid dispensing system dispenses a precise amount of fluid into the first reservoir 1108 so that the reagent completely fills the volume of the closed flow cell before the reagent flow is shut off.

In some embodiments, the optical sensor is a beam break sensor and the float 1304 is opaque. The float 1304 can optically block the beam (generated by the emitter 1302a) from reaching the receiver 1302b when the float 1304 at least partially obstructs the transversal path of the beam across the first reservoir 1108. In some embodiments, the receiver 1302b detects transmitted light. In some embodiments, the receiver 1302b generates an electrical binary signal, indicating either that the beam is intact (i.e., when the float does not optically block the beam) or that it is interrupted (i.e., when the float at least partially optically blocks the beam), and triggering activation or inactivation of the fluid pump accordingly. The flow of the reagent(s) ceases when the beam break sensor detects that the beam is at least partially blocked or only when the beam is completely blocked. The flow of the reagent(s) automatically resumes when the beam break sensor detects that the beam is completely unblocked (e.g. subsequent reagent is loaded into the opening trough 1108 to raise the buoyant float 1304).

In some embodiments, the optical sensor is a reflective optical sensor and the float 1304 is either reflective or opaque. In some embodiments, the float 1304 reflects and/or optically blocks (e.g., completely block or partially block) the optical beam. Light intensity can be reduced when the float 1304 at least partially physically obstructs the optical beam. In some embodiments, the receiver 1302b generates an electrical signal (e.g., an analog electrical signal or a binary electrical signal) based on the light intensity detected, indicating the presence or absence of the float 1304.

In some embodiments, the flow of the reagent(s) ceases when the reflective optical sensor detects a light intensity below a predetermined threshold and can automatically resume when the light intensity exceeds the predetermined threshold. In some embodiments, the predetermined threshold is established by calibrating the reflective optical sensor with the reagent present in the first reservoir 1108. When the reagent is in the first reservoir 1108, a baseline light intensity can be measured, and the predetermined threshold can be automatically or manually set based on the baseline light intensity.

In some embodiments, the flow rate of the fluid pump is varied in response to the electrical signal generated by the optical sensor. In such embodiments, the flow rate of the fluid pump is gradually decreased as the light intensity detected by the receiver 1302b decreases from a baseline light intensity. This decrease in light intensity continues until the detected light intensity stabilizes, at which point it reaches a plateau due to complete obstruction of the optical beam by the float 1304 and reagent flow into the closed flow cell ceases. In some embodiments, the flow rate is gradually increased as the light intensity detected by the receiver 1302b increases from the low plateau to the baseline light intensity as the float 1304 rises with the liquid level of the reagent. This increase in light intensity continues until the detected light intensity stabilizes, at which point it reaches a plateau, indicating that the float 1304 is above the optical beam. Fluid can be dispensed into the first reservoir 1108 to displace the liquid level and the float 1304 above the optical beam.

In some embodiments, the light intensity detected by the receiver 1302b triggers either activation or inactivation of the fluid pump, without modulation of the flow rate. In such embodiments, the flow only ceases when the light intensity stabilizes at a low plateau, indicating that the float 1304 completely obstructs the optical beam. The flow resumes when the light intensity stabilizes at a high plateau, indicating that the liquid level and the float 1304 are completely above the optical beam.

In some embodiments, the optical sensor is an analog optical sensor and the receiver 1302b continuously measures the intensity of the light that is reflected back or transmitted through the reagent. The float 1304 can reflect and/or optically block (e.g., completely block or partially block) the optical beam when the float 1304 at least partially obstructs the beam's transversal path across the first reservoir 1108. The receiver 1302b can generate an analog electrical signal proportional to the intensity of the light detected, which can responsively trigger an operation of the fluid pump (e.g., vary the flow rate of the pump, inactivate the fluid pump, maintain the fluid pump activated, or reactivate the fluid pump).

In some embodiments, the flow triggering element does not include a float 1304 and the optical sensor is configured to detect the transition from liquid to air when the reagent contained within the first reservoir 1108 displaces below the optical beam. The receiver 1302b of such an optical sensor may primarily detect transmitted and reflected light. As the liquid level of the reagent drops below the optical beam, the optical beam is no longer transmitted through the liquid, resulting in an increase in light intensity reaching the receiver 1302b. The receiver 1302b can generate an electrical signal based on the light intensity detected and responsively trigger an operation of the fluid pump (e.g., inactivate the fluid pump, maintain the fluid pump activated, or reactivate the fluid pump).

In some embodiments, the flow triggering element does not include a float 1304. In some embodiments, the optical sensor is configured to detect a meniscus of liquid (e.g., the liquid-air interface of the reagent). The receiver 1302b of such an optical sensor may primarily detect transmitted and reflected light. As the liquid interface of the reagent approaches the optical beam, the curvature of the meniscus alters the amount of light transmitted or reflected. The receiver 1302b can detect these changes in light intensity and generate an electrical signal based on the light intensity detected, responsively triggering an operation of the fluid pump (e.g., inactivate the fluid pump, maintain the fluid pump activated, or reactivate the fluid pump).

### System 1400

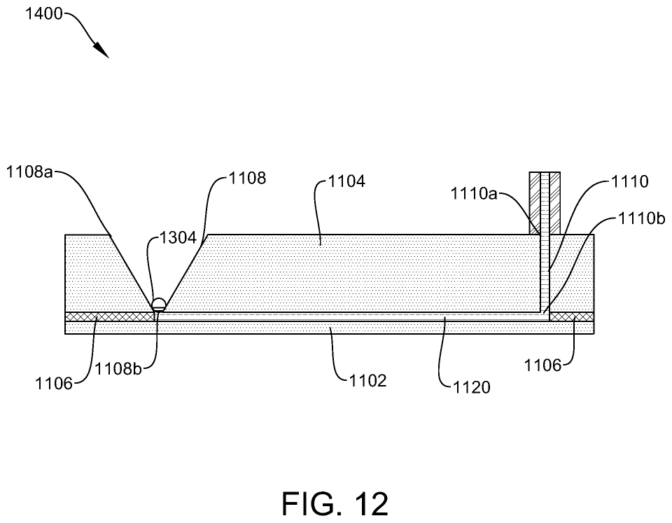

Referring now to FIG. 12, and in brief overview, an exemplary system 1400 includes a bottom layer 1102, a top layer 1104, a gasket 1106 (optional), a fluid pump, and a flow triggering element (including a float 1304). The system 1400 may be implemented substantially similarly to the pseudo flow cells described and illustrated above (e.g., in FIGS. 1A-1B) and may include any combination (or all) of the same components. The fluid pump (e.g., vacuum pump, syringe pump) is downstream and in fluid communication with the fluidic outlet 1110. The fluid pump is configured to flow at least one reagent 1120 from the first reservoir 1108 through the closed flow cell when the system is in a coupled configuration. A float 1304 is disposed within a reagent in the first reservoir 1108 and is configured to float at or near the liquid interface of the reagent.

In some embodiments, the second opening 1108b of the first reservoir 1108 is substantially circular. In some embodiments, the first opening 1108a is circular. In some embodiments, the first opening 1108 has a different shape (rectangular, square, elliptical, etc.). In some embodiments, the float 1304 is substantially spherical (e.g., a sphere, an ellipsoid). In some embodiments, the diameter of the float 1304 is larger than that of the second opening 1108b of the first reservoir 1108. In this way, the float 1304 can plug the second opening 1108b when positioned within it, thereby restricting (e.g., entirely blocking) the flow of the reagent into the closed flow cell when the liquid level of the reagent is proximal to the second opening 1108b of the first reservoir 1108.

In some embodiments, the flow triggering element includes one or more pressure sensors positioned downstream from the first reservoir 1108. In some embodiments, the one or more pressure sensors (e.g., capacitive pressure sensor, piezoresistive pressure sensor, optical pressure sensor, strain gauge pressure sensor, digital pressure sensor) are operably connected to the fluid pump (e.g., through a controller). The pressure sensor is configured to monitor the pressure within the system when it is in the coupled configuration and generates an electrical signal corresponding to the measured pressure. The signal can be transmitted to a controller configured to control operation of the pump based on the pressure readings.

In some embodiments, the flow triggering element includes one or more flow meter sensors positioned downstream from the first reservoir 1108. A flow meter sensor can be operably connected to the fluid pump (through a controller). The flow meter sensor monitors the flow rate within the system when it is in the coupled configuration and generates an electrical signal corresponding to the measured flow rate. The signal can be transmitted to a controller configured to control operation of the pump based on the flow rate readings.

In some embodiments, the float 1304 is formed of a non-rigid material (e.g., silicone rubber, polyurethane, thermoplastic elastomer, soft polyvinyl chloride, polyurethane foam, polyethylene foam, expanded polystyrene, neoprene foam). Additionally or alternatively, the second opening 1108b of the first reservoir 1108 can be circumferentially lined with a non-rigid material.

### Operation of System 1400

In operation, the float 1304 is disposed within a reagent 1120 contained in the first reservoir 1108 and is configured to remain at the liquid interface of the reagent 1120 (e.g., float 1304 is buoyant). The fluid pump flows liquid from the first reservoir 1108, through the closed flow cell, and out through the fluidic outlet 1110, responsively displacing the liquid level of the reagent in the first reservoir 1108, along with the float 1304, towards the second opening 1108b.

When the liquid level of the reagent contained in the first reservoir 1108 is proximal to the second opening 1108b, the float 1304 engages with the opening, effectively plugging it and obstructing the flow of the reagent into the closed flow cell. The float 1304 forms a temporary seal with the second opening 1108b. In some embodiments, a pressure sensor operably connected to the fluid pump detects a decrease in pressure when the float 1304 plugs or blocks (e.g., causes a restriction at) the second opening 1108b. In some embodiments, the fluid pump is automatically inactivated when the pressure decreases below a threshold pressure. In some embodiments, a flow meter operably connected to the fluid pump detects a decrease in the flow rate when the float 1304 plugs or blocks the second opening 1108b. In some embodiments, the fluid pump is automatically inactivated when the flow rate decreases below a threshold flow rate.

In some embodiments, the temporary seal is released when the fluid pump generates a brief positive pressure, forcibly pushing the float 1304 out of the second opening 1108b. In such embodiments, a volume of reagent is dispensed into the fluidic inlet prior to generating the brief positive pressure. In some embodiments, the temporary seal is released when reagent is dispensed in the first reservoir 1108, causing the float 1304 to displace above the second opening 1108b as the liquid level of the reagent rises. A liquid dispensing system (e.g., pipettor, one or more syringe pump with tubing leading to the first reservoir 1108) can be used to dispense a volume of reagent into the first reservoir 1108. When the float 1304 displaces above the second opening 1108b (i.e., releasing the temporary seal), the pressure sensor detects an increase in pressure and the fluid pump is responsively activated, initiating flow of the reagent into the closed flow cell. In some embodiments, the fluid pump can be manually activated after the temporary seal is released.

### System 1500

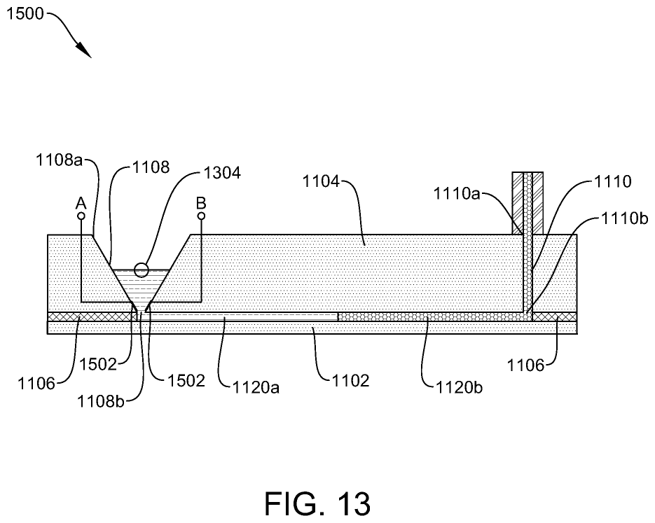

Referring now to FIG. 13, and in brief overview, an exemplary system 1500 includes a bottom layer 1102, a top layer 1104, a gasket 1106 (optional), a fluid pump, and a flow triggering element (including a float 1304 and a pair of conductive plates 1502). The system 1500 may be implemented substantially similarly to the pseudo flow cells described and illustrated above (e.g., in FIGS. 1A-1B) and may include any combination (or all) of the same components. The fluid pump (e.g., vacuum pump, syringe pump) is positioned downstream and in fluid communication with the fluidic outlet 1110. The fluid pump is configured to flow at least one reagent 1120 from the first reservoir 1108 through the closed flow cell when the system is in a coupled configuration. A float 1304 is disposed within a reagent in the first reservoir 1108 and is configured to float at the liquid interface of the reagent.

In some embodiments, the float 1304 and the conductive plates 1502 are formed of the same material or different materials including but not limited to copper, aluminum, stainless steel, graphene, a non-conductive material with metal coating (e.g., a silver coating, a gold coating, a copper coating, etc.) on the outer surface. In some embodiments, the pair of conductive plates 1502 have a shape, such as rectangular, circular, triangular, polygonal, or irregularly shaped (e.g., a grid pattern). In some embodiments, the conductive plates 1502 are disposed on surface of the first reservoir 1108 and positioned so that the plates directly oppose each other (without contacting each other). In some embodiments, the conductive plates 1502 are electrically connected to a power source (supplying a voltage to the circuit) and a controller (e.g., control circuit, microcontroller) configured to monitor the current between the conductive plates 1502. The resistance between the conductive plates 1502 can be high (e.g., due to an air gap), such that minimal current (e.g., effectively no current) flows between the plates, when the float 1304 is not in contact with the plates. Continuity is created when a conductive path is formed between the conductive plates 1502 and the float 1304. When the float 1304 contacts the conductive plates 1502, the resistance changes from high resistance (when the float 1304 is not in contact with the conductive plates 1502) to low resistance (when the float 1304 contacts both plates), allowing current to flow through the circuit.

The fluid pump, which is in fluid communication with the fluidic outlet 1110, is operably connected to the conductive plates 1502 through the controller. In some embodiments, the controller triggers an operation of the fluid pump when the current reaches a specific current level. In some embodiments, the fluid pump is inactivated when the float 1304 contacts both conductive plates 1502. In some embodiments, the fluid pump remains activated or is reactivated when the float 1304 does not contact the conductive plates. The continuity of the circuit indicates when the liquid level of the reagent (contained in the first reservoir 1108) is either proximal to or at the second opening 1108b (i.e., signifying near depletion of the reagent).

### Operation of System 1500

In operation, the conductive float 1304 is disposed within a reagent 1120 contained in the first reservoir 1108 and is configured to remain at the liquid interface of the reagent 1120. The fluid pump flows liquid from the first reservoir 1108, through the closed flow cell, and out through the fluidic outlet 1110, responsively displacing the liquid level of the reagent in the first reservoir 1108, along with the float 1304, towards the second opening 1108b.

The power supply provides a constant voltage to the conductive plates 1502, while the controller continuously monitors the circuit's current. When the float 1304 contacts the conductive plates 1502, a conductive path is defined between the float 1304 and the conductive plates 1502, allowing current to flow through the circuit. The current level reaches a stable high value that triggers the inactivation of the fluid pump, and consequently cessation of the fluid flow into the closed flow cell.

In some embodiments, the float 1304 is displaced above the conductive plates 1502 by dispensing a volume of liquid into the fluidic inlet (e.g., using a liquid dispensing system). When the float 1304 breaks electrical contact with the conductive plates 1502, the current level reaches a low current value (or no current) that triggers activation of the fluid pump, and consequently activation of reagent flow into the closed flow cell.

### System 1600

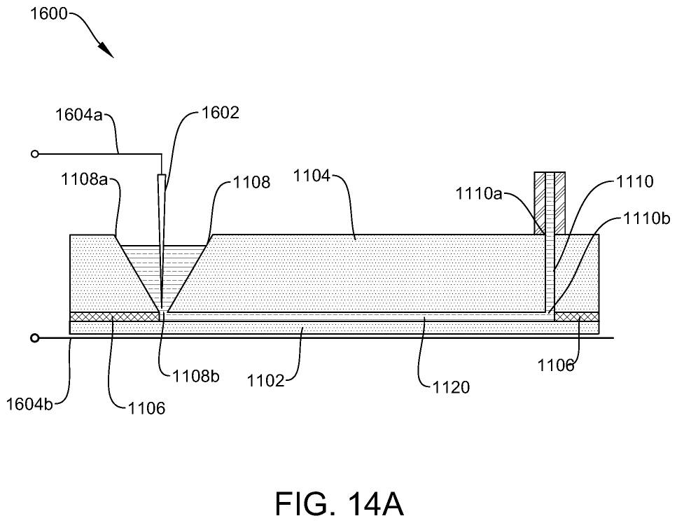

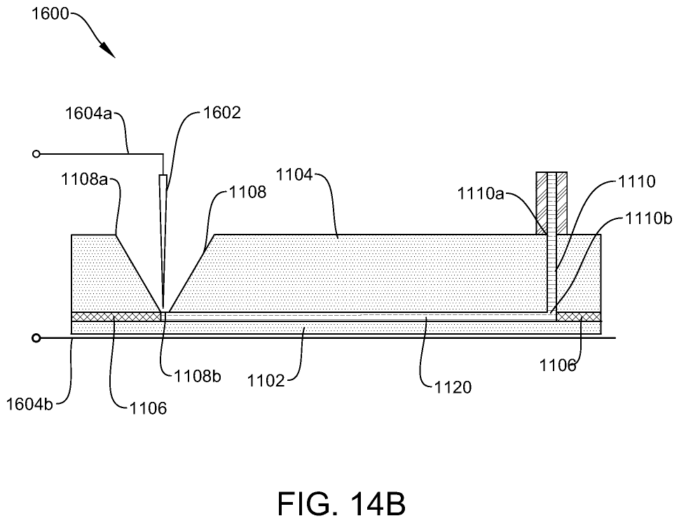

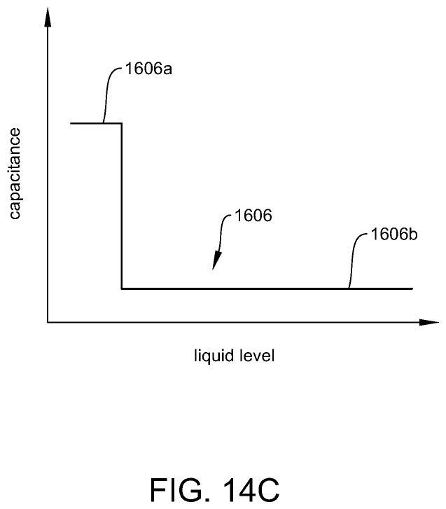

Referring now to FIGS. 14A and 14B, and in brief overview, an exemplary system 1600 includes a bottom layer 1102, a top layer 1104, a gasket 1106 (optional), a fluid pump and a flow triggering element 1602 (e.g., a probe with a conductive tip). The system 1600 may be implemented substantially similarly to the pseudo flow cells described and illustrated above (e.g., in FIGS. 1A-1B) and may include any combination (or all) of the same components. The fluid pump (e.g., vacuum pump, syringe pump) can be positioned downstream and in fluid communication with the fluidic outlet 1110. The fluid pump can be configured to flow at least one reagent 1120 from the first reservoir 1108 through the closed flow cell when the system is in a coupled configuration.

In some embodiments, the flow triggering element 1602 (e.g., a probe with a conductive tip) is formed of one or more materials including, but not limited to, copper, aluminum, stainless steel, graphene, a non-conductive material with metal coating (e.g., a silver coating, a gold coating, a copper coating, etc.). In some embodiments, the flow triggering element 1602 is held stationary and longitudinally extends into the first reservoir 1108. The flow triggering element 1602 has a first end and a second end with a length therebetween. In some embodiments, the first end of the flow triggering element 1602 extends above the top surface of the top layer 1104, while the second end is proximal to the second opening 1108b of the first reservoir 1108. In some embodiments, the second end of the flow triggering element 1602 is configured to prevent the formation of a meniscus and enhance dewetting of the tip when the liquid interface is proximal to the tip. The flow triggering element 1602 can have a tapered shape, in which a first end of the flow triggering element 1602 has a larger diameter than the second end. Additionally or alternatively, the flow triggering element 1602 may have a textured surface, hydrophobic surface treatment, or the like. Mechanical fixtures (e.g., mechanical clamps, brackets, or robotic arm) can be used to hold the flow triggering element 1602 within the first reservoir 1108. The position of the flow triggering element 1602 can be adjusted, for example, longitudinally, allowing the tip to extend or retract within the first reservoir 1108.

In some embodiments, the flow triggering element 1602 is electrically connected to a power source (supplying a voltage to the circuit) and a controller (e.g., control circuit, microcontroller) configured to continuously monitor the capacitance between the flow triggering element 1602 and the surface that the system rests on. For example, the tip can be electrically connected to a power source via circuitry 1604a, 1604b, where circuitry 1604a is coupled to a power line and circuitry 1604b is coupled to ground. The measured capacitance varies in response to changes in the dielectric constant of the material (e.g., air, reagent) surrounding the flow triggering element 1602 and changes in the area of the tip that is wetted/contacting the reagent.

The fluid pump, which is in fluid communication with the fluidic outlet 1110, is operably connected to the flow triggering element 1602 through the controller. In some embodiments, the controller triggers an operation of the fluid pump when the capacitance reaches a threshold capacitance. FIG. 14C shows a graphical representation of the measured capacitance as a function of the liquid level in the first reservoir 1108. The plot shows a qualitative measure of capacitance 1606 that stabilizes at a high level when the liquid level of the reagent (contained in the first reservoir 1108) is nearly depleted. The fluid pump is inactivated, and consequently the flow ceases, when a threshold capacitance is detected in response to an air gap formed between the flow triggering element 1602 and the liquid interface of the reagent. In some embodiments, the fluid pump remains activated or is reactivated when the measured capacitance is below the threshold capacitance in response to the reagent contacting the flow triggering element 1602, thereby allowing flow to resume into the closed flow cell.

### Operation of System 1600

In operation, the flow triggering element 1602 extends longitudinally in the first reservoir 1108. In some embodiments, the flow triggering element 1602 does not contact any part of the top layer 1104. In some embodiments, a liquid dispensing system (e.g., pipettor, one or more syringe pumps with tubing leading to the first reservoir 1108) can be used to dispense a volume of reagent 1120 into the first reservoir 1108. The fluid pump flows liquid from the first reservoir 1108, through the closed flow cell, and out through the fluidic outlet 1110, responsively displacing the liquid level of the reagent in the first reservoir 1108 towards the second opening 1108b.

A voltage is applied between the flow triggering element 1602 and another component via the power source, enabling the generation of an electric field between the tip and the surrounding medium. In some embodiments, the controller continuously monitors capacitance between the flow triggering element 1602 and another component (e.g., a conductive wire on the substrate or on a stage on which the substrate is positioned, etc.). In some embodiments, as the liquid level of the reagent contained in the first reservoir 1108 displaces (and the reagent contacts the flow triggering element 1602), the measured capacitance varies. In some embodiments, as the liquid level of the reagent contained in the first reservoir 1108 displaces (and the reagent contacts the flow triggering element 1602), the measured capacitance remains constant at a first capacitance level 1606a. When the controller detects the first capacitance level 1606a, the controller triggers the flow to resume (i.e., activate the fluid pump if it is not already flowing). When the liquid level displaces below the second end of the flow triggering element 1602 (i.e., an air gap forms between the tip and the reagent), the measured capacitance exhibits a step change and remain constant at a second capacitance level 1606b. When the controller detects the second capacitance level 1606b, the controller triggers the flow to cease (i.e., inactivate the fluid pump). Flow can resume again by dispensing a volume of reagent in the first reservoir 1108 thereby increasing capacitance.

### System 1700

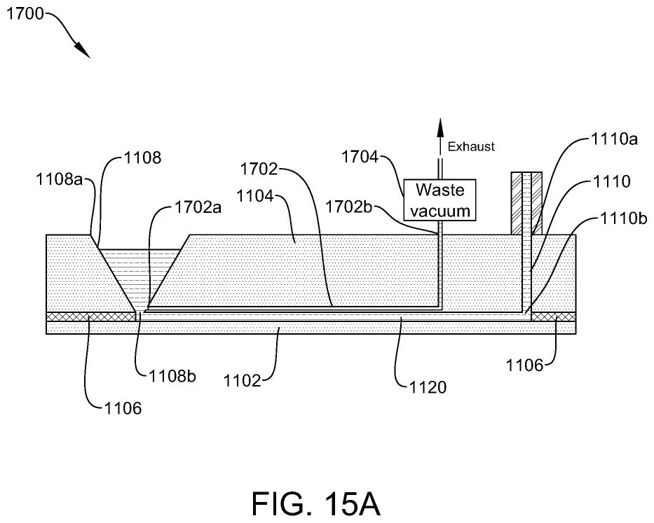

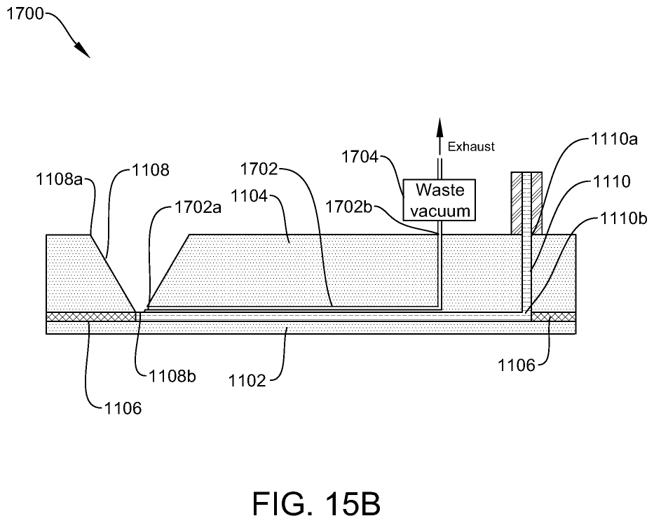

Referring now to FIGS. 15A and 15B, and in brief overview, an exemplary system 1700 includes a bottom layer 1102, a top layer 1104, a gasket 1106 (optional), a first fluid pump, and a flow triggering element (including a fluidic channel 1702 and a second fluid pump 1704). The system 1700 may be implemented substantially similarly to the pseudo flow cells described and illustrated above (e.g., in FIGS. 1A-1B) and may include any combination (or all) of the same components. The first fluid pump (e.g., vacuum pump, one or more syringe pump with tubing leading to the first reservoir 1108) can be downstream and in fluid communication with the fluidic outlet 1110. The first fluid pump is configured to flow at least one reagent 1120 from the first reservoir 1108 through the closed flow cell and out through the fluidic outlet 1110 when the system is in a coupled configuration. In some embodiments, the second fluid pump 1704 is configured to flow at least one reagent from the first reservoir 1108 through the fluidic channel 1702, which is disposed within the top layer 1104, and into a waste container.

In some embodiments, the fluidic channel 1702 has a shape, including but not limited to circular, rectangular, triangular, elliptical, etc. The inlet 1702a of the fluidic channel 1702 is in fluid communication with the first reservoir 1108, while the outlet 1702b of the fluidic channel 1702 can be in fluidic communication with a second fluid pump 1704 (e.g., a waste vacuum pump or other fluid pump). In some embodiments, the fluidic channel 1702 extends from the first reservoir 1108 to the top surface of the top layer 1104, with the inlet 1702a positioned proximal to the second opening 1108b of the first reservoir 1108 and the outlet 1702b at the top surface of the top layer 1104. In some embodiments, the fluidic channel 1702 is L-shaped, with a first portion of the fluidic channel 1702 extending longitudinally through the top layer 1104 and a second portion extending transversally. The height of the second portion of the fluidic channel 1702 can vary, which correspondingly varies the position of the inlet 1702a in the first reservoir 1108. The length of the first portion of the fluidic channel 1702 can vary, which correspondingly varies the position of the channel's outlet 1702b. In some embodiments, the outlet 1702b of the fluidic channel 1702 is proximal to the first opening 1108a of the first reservoir 1108. In some embodiments, the outlet 1702b of the fluidic channel 1702 is proximal to the first opening 1110a of the fluidic outlet 1110. Tube connectors and/or tubing (e.g., flexible tubing) can be used to fluidically couple the second fluid pump 1704 and the outlet of the fluidic channel 1702. In some embodiments, the outlet 1702b of the fluidic channel 1702 provides an interface for connecting with tubing. In some embodiments, the tubing is routed from the outlet 1702b of the fluidic channel 1702 to the second fluid pump 1704, thereby defining a fluidic pathway between the two elements.

The second fluid pump 1704 (e.g., vacuum pump, syringe pump, positive displacement pump, centrifugal pump, axial flow pump, etc.) generates a negative pressure (e.g., a pressure lower than the pressure external to the system 1100, 1200), effectively drawing the liquid reagent from the first reservoir 1108 into the fluidic channel 1702 and into the waste container. The negative pressure generated by the second fluid pump 1704 can be adjusted to control the flow rate of the liquid reagent. In some embodiments, the flow rate of the second fluid pump 1704 is lower than the flow rate of the first fluid pump.

In some embodiments, the flow triggering element includes one or more pressure sensors (e.g., capacitive pressure sensor, piezoresistive pressure sensor, optical pressure sensor, strain gauge pressure sensor, digital pressure sensor) positioned downstream from the outlet 1702b of the fluidic channel 1702 and operably connected to the first fluid pump (through a controller). The pressure sensor monitors the pressure within the fluidic channel 1702 when the system is in the coupled configuration and generates an electrical signal corresponding to the measured pressure. The electrical signal from the pressure sensor is transmitted to a controller configured to control operation of the first fluid pump based on the pressure readings.

In some embodiments, the flow triggering element includes one or more flow meter sensors are operably connected to the first fluid pump (through a controller) and positioned downstream from the outlet 1702b of the fluidic channel 1702. In some embodiments, the flow meter sensor continuously monitors the flow rate within the fluidic channel 1702 when the system is in the coupled configuration and generates an electrical signal corresponding to the measured flow rate. In some embodiments, the flow meter sensor continuously monitors the flow rate of the fluid pump (e.g., vacuum pump) exhaust when the system is in the coupled configuration and generates an electrical signal corresponding to the measured flow rate. The electrical signal is transmitted to a controller configured to control operation of the first fluid pump based on the flow rate readings.

### Operation of System 1700

In operation, the first fluid pump flows the reagent from the first reservoir 1108, through the closed flow cell, and out through the fluidic outlet 1110, responsively displacing the liquid level of the reagent in the first reservoir 1108 towards the second opening 1108b. In some embodiments, the second fluid pump simultaneously flows the reagent from the first reservoir 1108 through the fluidic channel 1702 and into a waste container. In some embodiments, the second fluid pump 1704 has a smaller volumetric flow rate than the volumetric flow rate of the first fluid pump.

In some embodiments, one or more sensors measure a pressure and/or a flow rate (e.g., within the fluidic channel 1702, at the exhaust of a fluid pump) and transmit an electrical signal, corresponding to the measurement, to a controller configured to trigger an operation of the first fluid pump. In some embodiments, in which system 1300 includes one or more pressure sensors within the fluidic channel 1702, the pressure sensor detects a corresponding drop in pressure when the liquid level of the reagent in the first reservoir 1108 depletes below the inlet 1702a of the fluidic channel 1702, indicating air being drawn into the fluidic channel 1702. In some embodiments, the pressure sensor generates an electrical signal corresponding to the drop in pressure and triggers cessation of reagent flow through the closed flow cell.

In some embodiments, in which system 1700 includes one or more flow meter sensors within the fluidic channel 1702, the flow meter sensor detects a corresponding increase in flow rate (due to the lower viscosity of air compared to the liquid reagent) when the liquid level of the reagent in the first reservoir 1108 depletes below the inlet 1702a of the fluidic channel 1702. In some embodiments, in which system 1700 includes one or more flow meter sensors at the exhaust of a fluid pump (e.g., vacuum pump, syringe pump, etc.), the flow meter sensor detects a corresponding increase in exhaust flow rate when the liquid level of the reagent in the first reservoir 1108 depletes below the inlet 1702a of the fluidic channel 1702. When air is in the fluidic channel 1702, the fluid pump (e.g., vacuum pump) exhausts air at a greater flow rate to maintain a pressure in the waste container (and/or torque on the pump motor is decreased). The flow meter sensor generates an electrical signal corresponding to the increase in flow rate and triggers cessation of reagent flow into the closed flow cell. Reagent flow is resumed when a reagent is dispensed into the first reservoir 1108 (e.g., using a liquid dispensing system such as a pipetting system) and the liquid level rises above the inlet 1702a.

### Float 1304

In some embodiments, the float 1304 utilized in any of the systems described herein has a solid body. In some embodiments, the float 1304 has a hollow shell. The float 1304 can be formed of one or more materials, including but not limited to plastic, foam, metal or metal alloy, polyvinyl chloride, nylon, and rubber. The float 1304 can be formed of a material that is non-reactive with reagents. The float 1304 can be formed of a rigid material or a non-rigid material. The float 1304 can be buoyant, allowing it to remain afloat on the surface of the liquid reagent contained in the first reservoir 1108. The float 1304 can have specific optical properties, such as being transparent, translucent, reflective, or opaque. For example and without limitation, the color and opacity of the float 1304 can be used with the optical sensor of the system to determine when to cease pumping operations of reagents through the closed flow cell. The float 1304 can be shaped in various configurations, such as spherical, ellipsoidal, irregularly shaped, or a custom geometry. The shape and size of the float 1304 can depend on the shape and size of the second opening of the first reservoir 1108.

The flow devices of the disclosure may include any suitable material, for example, polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof.

In some embodiments, the present devices may be assembled by alignment and stacking of the slide, tissue sample, fluidic interface layer, gasket, and adapter. For example, the adapter may be aligned with and placed onto the fluidic interface layer, or the adapter can be placed on the slide prior to dispensing the fluidic interface layer of reagent(s). Compression may be applied during assembly such that the fluidic interface layer, gasket, and/or substrate layer are reversibly attached. Assembly, and disassembly, can be performed manually.

### Surface Properties

A surface of the device may include a material, coating, or surface texture that determines the physical properties of the device. In particular, the flow of liquids may be controlled by the surface properties (e.g., wettability of a liquid-contacting surface). In some cases, a portion (e.g., a flow path) may have a surface having a wettability suitable for facilitating liquid flow (e.g., in a flow path).

Wetting, which is the ability of a liquid to maintain contact with a solid surface, may be measured as a function of a water contact angle. A water contact angle of a material can be measured by any suitable method known in the art, such as the static sessile drop method, pendant drop method, dynamic sessile drop method, dynamic Wilhelmy method, single-fiber Wilhelmy method, single-fiber meniscus method, and Washburn's equation capillary rise method.

For example, portions of the device carrying aqueous phases (e.g., a channel or flow path) may have a surface material or coating that is hydrophilic or more hydrophilic than the other parts of the device, e.g., include a material or coating having a water contact angle of less than or equal to about 90°, and/or other components of the device may have a surface material or coating that is hydrophobic or more hydrophobic than the flow path, e.g., include a material or coating having a water contact angle of greater than 70° (e.g., greater than 90°, greater than 95°, greater than 100° (e.g., 95°-120° or 100°-10°)). The system can be designed to have a single type of material or coating throughout. Surface textures may also be employed to control fluid flow.

The surface properties may be those of a native surface (i.e., the surface properties of the bulk material used for fabrication) or of a surface treatment. Non-limiting examples of surface treatments include, e.g., surface coatings and surface textures. In one approach, the surface properties are attributable to one or more surface coatings present in a portion. Hydrophobic coatings may include fluoropolymers (e.g., AQUAPEL® glass treatment), silanes, siloxanes, silicones, or other coatings known in the art. Other coatings include those vapor deposited from a precursor such as henicosyl-1,1,2,2-tetrahydrododecyldimethyltris(dimethylaminosilane); henicosyl-1,1,2,2-tetrahydrododecyltrichlorosilane (C12); heptadecafluoro-1,1,2,2-tetrahydrodecyltrichlorosilane (C10); nonafluoro-1,1,2,2-tetrahydrohexyltris(dimethylamino)silane; 3,3,3,4,4,5,5,6,6-nonafluorohexyltrichlorosilane; tridecafluoro-1,1,2,2-tetrahydrooctyltrichlorosilane (C8); bis(tridecafluoro-1,1,2,2-tetrahydrooctyl)dimethylsiloxymethylchlorosilane; nonafluorohexyltriethoxysilane (C6); dodecyltrichlorosilane (DTS); dimethyldichlorosilane (DDMS); or 10-undecenyltrichlorosilane (V11); pentafluorophenylpropyltrichlorosilane (C5). Hydrophilic coatings include polymers such as polysaccharides, polyethylene glycol, polyamines, and polycarboxylic acids. Hydrophilic surfaces may also be created by oxygen plasma treatment of certain materials.

A coated surface may be formed by depositing a metal oxide onto a surface of the system. Example metal oxides useful for coating surfaces include, but are not limited to, Al2O3, TiO2, SiO2, or a combination thereof. Other metal oxides useful for surface modifications are known in the art. The metal oxide can be deposited onto a surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al2O3 can be deposited on a surface by contacting it with trimethylaluminum (TMA) and water.

In another approach, the surface properties may be attributable to surface texture. For example, a surface may have a nanotexture, e.g., have a surface with nanometer surface features, such as cones or columns, that alters the wettability of the surface. Nanotextured surface may be hydrophilic, hydrophobic, or superhydrophobic, e.g., have a water contact angle greater than 150°. Exemplary superhydrophobic materials include Manganese Oxide Polystyrene (MnO2/PS) nano-composite, Zinc Oxide Polystyrene (ZnO/PS) nano-composite, Precipitated Calcium Carbonate, Carbon nano-tube structures, and a silica nano-coating. Superhydrophobic coatings may also include a low surface energy material (e.g., an inherently hydrophobic material) and a surface roughness (e.g., using laser ablation techniques, plasma etching techniques, or lithographic techniques in which a material is etched through apertures in a patterned mask). Examples of low surface energy materials include fluorocarbon materials, e.g., polytetrafluoroethylene (PTFE), fluorinated ethylene propylene (FEP), ethylene tetrafluoroethylene (ETFE), ethylene chloro-trifluoroethylene (ECTFE), perfluoro-alkoxyalkane (PFA), poly(chloro-trifluoro-ethylene) (CTFE), perfluoro-alkoxyalkane (PFA), and poly(vinylidene fluoride) (PVDF). Other superhydrophobic surfaces are known in the art.

In some cases, the water contact angle of a hydrophilic or more hydrophilic material or coating is less than or equal to about 90°, e.g., less than 80°, 70°, 60°, 50°, 40°, 30°, 20°, or 10°, e.g., 90°, 85°, 80°, 75°, 70°, 65°, 60°, 55°, 50°, 45°, 40°, 35°, 30°, 25°, 20°, 15°, 10°, 9°, 8°, 7°, 6°, 5°, 4°, 3°, 2°, 1°, or 0°. In some cases, the water contact angle of a hydrophobic or more hydrophobic material or coating is at least 70°, e.g., at least 80°, at least 85°, at least 90°, at least 95°, or at least 100° (e.g., about 100°, 101°, 102°, 103°, 104°, 105°, 106°, 107°, 108°, 109°, 110°, 115°, 120°, 125°, 130°, 135°, 140°, 145°, or about 150°.

The difference in water contact angles between that of a hydrophilic or more hydrophilic material or coating and a hydrophobic or more hydrophobic material or coating may be 5°to 100°, e.g., 5° to 80°, 5° to 60°, 5° to 50°, 5° to 40°, 5° to 30°, 5°to 20°, 10° to 75°, 15° to 70°, 20° to 65°, 25° to 60°, 30 to 50°, 35° to 45°, e.g., 5°, 6°, 7°, 8°, 9°, 10°, 15°, 20°, 25°, 30°, 35°, 40°, 45°, 50°, 55°, 60, 65°, 70°, 75°, 80°, 85°, 90°, 95°, or 100°.

Surfaces may also be coated with various functional materials, e.g., metals or other electrically or magnetically conducting materials. For example, a surface may include a metal coating for electrical connectivity, detection, or resistive heating. Alternatively, such elements may be physically incorporated into a device or placed in physical contact with a device.

Surface properties may also be modified after application. Such methods include exposure to UV, ozone, plasma (e.g., oxygen, argon, etc.), UV photografting and UV induced photo-catalytic oxidation. These and other methods can alter the properties of the surface (e.g., wettability such as hydrophilicity, fluorophilicity, or hydrophobicity) or add an additional layer (e.g., biomolecules) to the surface.

The above discussion centers on the water contact angle. It will be understood that liquids employed may not be water, or even aqueous. Accordingly, the actual contact angle of a liquid on a surface may differ from the water contact angle. Furthermore, the determination of a water contact angle of a material or coating can be made on that material or coating when not incorporated into a device.

### Methods of Detection

In some embodiments, the methods described herein include detecting, e.g., tissue, cells, particulate components thereof, or other analytes. A sensor (e.g., optical, electrical, magnetic, impedance, or fluorescent sensor) in the detector may sense a particular feature (e.g., fluorescence, charge) or characteristic (e.g., diameter or volume) of sample (e.g., a cell or group of cells in a tissue sample).

Methods of detection include optical detection, e.g., by visual observation, e.g., using an optical bright-field. In some embodiments, analytes thereof are detectable by light absorbance, scatter, emission, and/or transmission. Additionally, or alternatively, optical detection can include fluorescent detection, e.g., by fluorescent microscopy. In still further embodiments, methods of the disclosure include detection of analytes having electrical or magnetic labels or properties. In some embodiments, the device includes a plurality (e.g., 2, 3, 4, 5, 6, 7, 8, 9, 10, or more) of detectors. Detectors may or may not be integrated with the device. In some embodiments, the substrate layer and/or fluid interface layer may be transparent, or include transparent portions, e.g., to allow for visualization, imaging, or detection. Substrate layers or fluidic interface layers, or portions thereof, may include transparent materials such as glass, quartz, polystyrene, polyethylene terephthalate, etc. The detection methods described herein may be automated, e.g., including robotic systems.

A variety of analytes, e.g., tissue, cell, or particulate component or macromolecular constituent thereof, characteristics can be observed and/or quantified. For example, characteristics such as analyte, e.g., cell, or particulate component or macromolecular constituent thereof, size (e.g., diameter) and shape can be readily observed visually and recorded by image or video acquisition software known in the art. In addition, the number of analytes, e.g., cell or particulate component thereof, can similarly be observed visually, by using detectable labels, or by other optical characteristics (e.g., scatter, absorbance, transmission, emission, such as fluorescence, etc.). In some embodiments, methods of the disclosure include observing the presence and/or intensity of a fluorescently or ionically tagged antigen-binding molecule bound to a biological antigen (e.g., a protein or nucleic acid, e.g., associated with an intact cell).

### Preparation of Samples

A variety of steps can be performed to prepare a biological tissue sample for analysis. In some embodiments, a sample is collected or deposited in the device described herein and prepared using a device described herein. In some embodiments, a prepared sample is placed on a substrate layer described herein. Except where indicated otherwise, the preparative steps described below can generally be combined in any manner to appropriately prepare a particular sample for analysis. In some aspects, any of the preparative or processing steps described can be performed on a sample using a device described herein, e.g., to deliver reagents via a fluid source. For example, the preparing or processing may include but is not limited to steps for fixing, embedding, staining, crosslinking, permeabilizing the sample, providing and/or removing reagents (e.g., probes, enzymes, buffers, etc.) or any combinations thereof.

A biological tissue sample can be harvested from a subject (e.g., via surgical biopsy, whole subject sectioning), grown in vitro on a growth substrate or culture dish as a population of cells, or prepared as a tissue slice or tissue section. Grown samples may be sufficiently thin for analysis without further processing steps. Alternatively, grown samples, and samples obtained via biopsy or sectioning, can be prepared as thin tissue sections using a mechanical cutting apparatus such as a vibrating blade microtome. As another alternative, in some embodiments, a thin tissue section can be prepared by applying a touch imprint of a biological sample to a suitable substrate material.

The thickness of the tissue section can be a fraction of (e.g., less than 0.9, 0.8, 0.7, 0.6, 0.5, 0.4, 0.3, 0.2, or 0.1) the maximum cross-sectional dimension of a cell. However, tissue sections having a thickness that is larger than the maximum cross-section cell dimension can also be used. For example, cryostat sections can be used, which can be, e.g., from about 10 μm to about 20 μm thick.

More generally, the thickness of a tissue section typically depends on the method used to prepare the section and the physical characteristics of the tissue, and therefore sections having a wide variety of different thicknesses can be prepared and used. For example, the thickness of the tissue section can be at least 0.1, 0.2, 0.3, 0.4, 0.5, 0.7, 1.0, 1.5, 2, 3, 4, 5, 6, 7, 8, 9, 10, 12, 13, 14, 15, 20, 30, 40, or 50 μm. Thicker sections can also be used if desired or convenient, e.g., at least 70, 80, 90, or 100 μm or more. Typically, the thickness of a tissue section is about 1-100 μm, 1-50 μm, 1-30 μm, 1-25 μm, 1-20 μm, 1-15 μm, 1-10 μm, 2-8 μm, 3-7 μm, or 4-6 μm, but as mentioned above, sections with thicknesses larger or smaller than these ranges can also be analyzed.

Multiple sections can also be obtained from a single biological sample. For example, multiple tissue sections can be obtained from a surgical biopsy sample by performing serial sectioning of the biopsy sample using a sectioning blade. Spatial information among the serial sections can be preserved in this manner, and the sections can be analyzed successively to obtain three-dimensional information about the biological sample.

In some embodiments, the biological tissue sample (e.g., a tissue section as described above) can be prepared by deep freezing at a temperature suitable to maintain or preserve the integrity (e.g., the physical characteristics) of the tissue structure. Such a temperature can be, e.g., less than −20° C., or less than −25° C., −30° C., −40° C., −50° C., −60°C., −70° C., 80° C. −90° C., −100° C., −110° C., −120° C., −130° C., −140° C., −150° C., −160° C., −170° C., −180° C., −190° C., or −200° C. The frozen tissue sample can be sectioned, e.g., thinly sliced, onto a substrate surface using any number of suitable methods. For example, a tissue sample can be prepared using a chilled microtome (e.g., a cryostat) set at a temperature suitable to maintain both the structural integrity of the tissue sample and the chemical properties of the nucleic acids in the sample. Such a temperature can be, e.g., less than −15° C., less than −20° C., or less than −25° C. A sample can be snap frozen in isopentane and liquid nitrogen. Frozen samples can be stored in a sealed container prior to embedding.

### Fixation and Postfixation

In some embodiments, the biological sample can be prepared using formalin-fixation and paraffin-embedding (FFPE), which are established methods. In some embodiments, cell suspensions and other non-tissue samples can be prepared using formalin-fixation and paraffin-embedding. Following fixation of the sample and embedding in a paraffin or resin block, the sample can be sectioned as described above. Prior to analysis, the paraffin-embedding material can be removed from the tissue section (e.g., deparaffinization) by incubating the tissue section in an appropriate solvent (e.g., xylene) followed by a rinse (e.g., 99.5% ethanol for 2 minutes, 96% ethanol for 2 minutes, and 70% ethanol for 2 minutes).

As an alternative to formalin fixation described above, a biological sample can be fixed in any of a variety of other fixatives to preserve the biological structure of the sample prior to analysis. For example, a sample can be fixed via immersion in ethanol, methanol, acetone, paraformaldehyde (PFA)-Triton, and combinations thereof.

In some embodiments, acetone fixation is used with fresh frozen samples, which can include, but are not limited to, cortex tissue, mouse olfactory bulb, human brain tumor, human post-mortem brain, and breast cancer samples. When acetone fixation is performed, pre-permeabilization steps (described below) may not be performed. Alternatively, acetone fixation can be performed in conjunction with permeabilization steps.

In some embodiments, the methods provided herein includes one or more post-fixing (also referred to as postfixation) steps. In some embodiments, one or more post-fixing step is performed after contacting a sample with a polynucleotide disclosed herein, e.g., one or more probes such as a circular or padlock probe. In some embodiments, one or more post-fixing step is performed after a hybridization complex including a probe and a target is formed in a sample. In some embodiments, one or more post-fixing step is performed prior to a ligation reaction disclosed herein, such as the ligation to circularize a padlock probe.

In some embodiments, one or more post-fixing step is performed after contacting a sample with a binding or labelling agent (e.g., an antibody or antigen binding fragment thereof) for a non-nucleic acid analyte such as a protein analyte. The labelling agent can include a nucleic acid molecule (e.g., reporter oligonucleotide) including a sequence corresponding to the labelling agent and therefore corresponds to (e.g., uniquely identifies) the analyte. In some embodiments, the labelling agent can include a reporter oligonucleotide including one or more barcode sequences.

A post-fixing step may be performed using any suitable fixation reagent disclosed herein, for example, 3% (w/v) paraformaldehyde in DEPC-PBS.

### Embedding

As an alternative to paraffin embedding described above, a biological sample can be embedded in any of a variety of other embedding materials to provide structural substrate to the sample prior to sectioning and other handling steps. In some cases, the embedding material can be removed e.g., prior to analysis of tissue sections obtained from the sample. Suitable embedding materials include, but are not limited to, waxes, resins (e.g., methacrylate resins), epoxies, and agar.

In some embodiments, the biological sample can be embedded in a matrix (e.g., a hydrogel matrix). Embedding the sample in this manner typically involves contacting the biological sample with a hydrogel such that the biological sample becomes surrounded by the hydrogel. For example, the sample can be embedded by contacting the sample with a suitable polymer material, and activating the polymer material to form a hydrogel. In some embodiments, the hydrogel is formed such that the hydrogel is internalized within the biological sample.

In some embodiments, the biological sample is immobilized in the hydrogel via cross-linking of the polymer material that forms the hydrogel. Cross-linking can be performed chemically and/or photochemically, or alternatively by any other hydrogel-formation method known in the art.

The composition and application of the hydrogel-matrix to a biological sample typically depends on the nature and preparation of the biological sample (e.g., sectioned, non-sectioned, type of fixation). As one example, where the biological sample is a tissue section, the hydrogel-matrix can include a monomer solution and an ammonium persulfate (APS) initiator/tetramethylethylenediamine (TEMED) accelerator solution. As another example, where the biological sample consists of cells (e.g., cultured cells or cells disassociated from a tissue sample), the cells can be incubated with the monomer solution and APS/TEMED solutions. For cells, hydrogel-matrix gels are formed in compartments, including but not limited to devices used to culture, maintain, or transport the cells. For example, hydrogel-matrices can be formed with monomer solution plus APS/TEMED added to the compartment to a depth ranging from about 0.1 μm to about 2 mm.

Additional methods and aspects of hydrogel embedding of biological samples are described for example in Chen et al., Science 347(6221):543-548, 2015, the entire contents of which are incorporated herein by reference.

### Staining and Immunohistochemistry (INC)

To facilitate visualization, biological samples can be stained using a wide variety of stains and staining techniques. In some embodiments, for example, a sample can be stained using any number of stains and/or immunohistochemical reagents. One or more staining steps may be performed to prepare or process a biological sample for an assay described herein or may be performed during and/or after an assay. In some instances, the provided methods and devices for the reversible assembly and use of a flowcell allow access to the sample after performing fluidic operations. In some cases, the provided flowcell can be sealed then access can be gained to the sample without disrupting the sample (e.g., to perform staining or IHC after performing other fluidic steps of an assay). In some embodiments, the sample can be contacted with one or more nucleic acid stains, membrane stains (e.g., cellular or nuclear membrane), cytological stains, or combinations thereof. In some examples, the stain may be specific to proteins, phospholipids, DNA (e.g., dsDNA, ssDNA), RNA, an organelle or compartment of the cell. The sample may be contacted with one or more labeled antibodies (e.g., a primary antibody specific for the analyte of interest and a labeled secondary antibody specific for the primary antibody). In some embodiments, cells in the sample can be segmented using one or more images taken of the stained sample.

In some embodiments, the stain is performed using a lipophilic dye. In some examples, the staining is performed with a lipophilic carbocyanine or aminostyryl dye, or analogs thereof (e.g., Dil, DiO, DiR, DiD). Other cell membrane stains may include FM and RH dyes or immunohistochemical reagents specific for cell membrane proteins. In some examples, the stain may include but is not limited to, acridine orange, acid fuchsin, Bismarck brown, carmine, coomassie blue, cresyl violet, DAPI, eosin, ethidium bromide, acid fuchsine, haematoxylin, Hoechst stains, iodine, methyl green, methylene blue, neutral red, Nile blue, Nile red, osmium tetroxide, ruthenium red, propidium iodide, rhodamine (e.g., rhodamine B), or safranine, or derivatives thereof. In some embodiments, the sample may be stained with haematoxylin and eosin (H&E).

In some embodiments, biological samples can be destained. Methods of destaining or discoloring a biological sample are known in the art, and generally depend on the nature of the stain(s) applied to the sample. For example, in some embodiments, one or more immunofluorescent stains are applied to the sample via antibody coupling. Such stains can be removed using techniques such as cleavage of disulfide linkages via treatment with a reducing agent and detergent washing, chaotropic salt treatment, treatment with antigen retrieval solution, and treatment with an acidic glycine buffer. Methods for multiplexed staining and destaining are described, for example, in Bolognesi et al., J. Histochem. Cytochem. 2017; 65(8): 431-444, Lin et al., Nat Commun. 2015; 6:8390, Pirici et al., J. Histochem. Cytochem. 2009; 57:567-75, and Glass et al., J. Histochem. Cytochem. 2009; 57:899-905, the entire contents of each of which are incorporated herein by reference.

### Isometric Expansion

In some embodiments, a biological sample embedded in a matrix (e.g., a hydrogel) can be isometrically expanded. Isometric expansion methods that can be used include hydration, a preparative step in expansion microscopy, as described in Chen et al., Science 347(6221):543-548, 2015.

Isometric expansion can be performed by anchoring one or more components of a biological sample (e.g., nucleic acids, proteins) to a gel, followed by gel formation, proteolysis, and swelling. In some embodiments, analytes in the sample, products of the analytes, and/or probes associated with analytes in the sample can be anchored to the matrix (e.g., hydrogel). Isometric expansion of the biological sample can occur prior to immobilization of the biological sample on a substrate, or after the biological sample is immobilized to a substrate. In some embodiments, the isometrically expanded biological sample can be removed from the substrate prior to contacting the substrate with probes disclosed herein.

Isometric expansion of the sample can increase the spatial resolution of the subsequent analysis of the sample. The increased resolution in spatial profiling can be determined by comparison of an isometrically expanded sample with a sample that has not been isometrically expanded.

In some embodiments, a biological sample is isometrically expanded to a size at least 2×, 2.1×, 2.2×, 2.3×, 2.4×, 2.5×, 2.6×, 2.7×, 2.8×, 2.9×, 3×, 3.1×, 3.2×, 3.3×, 3.4×, 3.5×, 3.6×, 3.7×, 3.8×, 3.9×, 4×, 4.1×, 4.2×, 4.3×, 4.4×, 4.5×, 4.6×, 4.7×, 4.8×, or 4.9× its non-expanded size. In some embodiments, the sample is isometrically expanded to at least 2× and less than 20× of its non-expanded size.

### Crosslinking and De-Crosslinking

In some embodiments, the biological sample is reversibly cross-linked. In some aspects, the analytes, polynucleotides and/or product of an analyte or a probe bound thereto can be anchored to a polymer matrix. For example, the polymer matrix can be a hydrogel. In some embodiments, portions of the sample can be modified to contain functional groups that can be used as an anchoring site to attach the polynucleotide probes and/or amplification product to a polymer matrix. In some embodiments, a modified probe including oligo dT may be used to bind to mRNA molecules of interest, followed by reversible crosslinking of the mRNA molecules.

In some embodiments, a hydrogel can include hydrogel subunits, such as, but not limited to, acrylamide, bis-acrylamide, polyacrylamide and derivatives thereof, poly(ethylene glycol) and derivatives thereof (e.g. PEG-acrylate (PEG-DA), PEG-RGD), gelatin-methacryloyl (GeIMA), methacrylated hyaluronic acid (MeHA), polyaliphatic polyurethanes, polyether polyurethanes, polyester polyurethanes, polyethylene copolymers, polyamides, polyvinyl alcohols, polypropylene glycol, polytetramethylene oxide, polyvinyl pyrrolidone, polyacrylamide, poly(hydroxyethyl acrylate), and poly(hydroxyethyl methacrylate), collagen, hyaluronic acid, chitosan, dextran, agarose, gelatin, alginate, protein polymers, methylcellulose, and the like, and combinations thereof.

In some embodiments, a hydrogel includes a hybrid material, e.g., the hydrogel material includes elements of both synthetic and natural polymers. Examples of suitable hydrogels are described, for example, in U.S. Pat. Nos. 6,391,937, 9,512,422, and 9,889,422, and in U.S. Patent Application Publication Nos. 2017/0253918, 2018/0052081 and 2010/0055733, the entire contents of each of which are incorporated herein by reference.

In some embodiments, the hydrogel can form the substrate. In some embodiments, the substrate includes a hydrogel and one or more second materials. In some embodiments, the hydrogel is placed on top of one or more second materials. For example, the hydrogel can be pre-formed and then placed on top of, underneath, or in any other configuration with one or more second materials. In some embodiments, hydrogel formation occurs after contacting one or more second materials during formation of the substrate. Hydrogel formation can also occur within a structure (e.g., wells, ridges, projections, and/or markings) located on a substrate.

In some embodiments, hydrogel formation on a substrate occurs before, contemporaneously with, or after the sample is in the device. For example, hydrogel formation can be performed on the sample on the substrate layer.

In some embodiments, hydrogel formation occurs within a biological sample. In some embodiments, a biological sample (e.g., tissue section) is embedded in a hydrogel. In some embodiments, hydrogel subunits are infused into the biological sample, and polymerization of the hydrogel is initiated by an external or internal stimulus.

In embodiments in which a hydrogel is formed within a biological sample, functionalization chemistry can be used. In some embodiments, functionalization chemistry includes hydrogel-tissue chemistry (HTC). Any hydrogel-tissue backbone (e.g., synthetic or native) suitable for HTC can be used for anchoring biological macromolecules and modulating functionalization. Non-limiting examples of methods using HTC backbone variants include CLARITY, PACT, ExM, SWITCH and ePACT. In some embodiments, hydrogel formation within a biological sample is permanent. For example, biological macromolecules can permanently adhere to the hydrogel allowing multiple rounds of interrogation. In some embodiments, hydrogel formation within a biological sample is reversible.

In some embodiments, a method disclosed herein includes de-crosslinking the reversibly cross-linked biological sample. The de-crosslinking does not need to be complete. In some embodiments, only a portion of crosslinked molecules in the reversibly cross-linked biological sample are de-crosslinked and allowed to migrate.

### Tissue Permeabilization and Treatment

In some embodiments, a biological sample can be permeabilized to facilitate transfer of analytes out of the sample, and/or to facilitate transfer of species (such as probes) into the sample. If a sample is not permeabilized sufficiently, the amount of analyte captured from the sample may be too low to enable adequate analysis. Conversely, if the tissue sample is too permeable, the relative spatial relationship of the analytes within the tissue sample can be lost. Hence, a balance between permeabilizing the tissue sample enough to obtain good signal intensity while still maintaining the spatial resolution of the analyte distribution in the sample is desirable.

In general, a biological sample can be permeabilized by exposing the sample to one or more permeabilizing agents. Suitable agents for this purpose include, but are not limited to, organic solvents (e.g., acetone, ethanol, and methanol), cross-linking agents (e.g., paraformaldehyde), detergents (e.g., saponin, Triton X100™ or Tween-20™), and enzymes (e.g., trypsin, proteases). In some embodiments, the biological sample can be incubated with a cellular permeabilizing agent to facilitate permeabilization of the sample. Additional methods for sample permeabilization are described, for example, in Jamur et al., Method Mol. Biol. 588:63-66, 2010, the entire contents of which are incorporated herein by reference. Any suitable method for sample permeabilization can generally be used in connection with the samples described herein.

In some embodiments, the biological sample can be permeabilized by adding one or more lysis reagents to the sample. Examples of suitable lysis agents include, but are not limited to, bioactive reagents such as lysis enzymes that are used for lysis of different cell types, e.g., gram positive or negative bacteria, plants, yeast, mammalian, such as lysozymes, achromopeptidase, lysostaphin, labiase, kitalase, lyticase, and a variety of other commercially available lysis enzymes.

Other lysis agents can additionally or alternatively be added to the biological sample to facilitate permeabilization. For example, surfactant-based lysis solutions can be used to lyse sample cells. Lysis solutions can include ionic surfactants such as, for example, sarcosyl and sodium dodecyl sulfate (SDS). More generally, chemical lysis agents can include, without limitation, organic solvents, chelating agents, detergents, surfactants, and chaotropic agents.

In some embodiments, the biological sample can be permeabilized by non-chemical permeabilization methods. Non-chemical permeabilization methods are known in the art. For example, non-chemical permeabilization methods that can be used include, but are not limited to, physical lysis techniques such as electroporation, mechanical permeabilization methods (e.g., bead beating using a homogenizer and grinding balls to mechanically disrupt sample tissue structures), acoustic permeabilization (e.g., sonication), and thermal lysis techniques such as heating to induce thermal permeabilization of the sample.

Additional reagents can be added to a biological sample to perform various functions prior to analysis of the sample. In some embodiments, Dnase and Rnase inactivating agents or inhibitors such as proteinase K, and/or chelating agents such as EDTA, can be added to the sample. For example, a method disclosed herein may include a step for increasing accessibility of a nucleic acid for binding, e.g., a denaturation step to opening up DNA in a cell for hybridization by a probe. For example, proteinase K treatment may be used to free up DNA with proteins bound thereto.

### Analytes

The methods and compositions disclosed herein can be used to detect and analyze a wide variety of different analytes. In some aspects, an analyte can include any biological substance, structure, moiety, or component to be analyzed. In some aspects, a target disclosed herein may similarly include any analyte of interest. In some examples, a target or analyte can be directly or indirectly detected.

Analytes can be derived from a specific type of cell and/or a specific sub-cellular region. For example, analytes can be derived from cytosol, from cell nuclei, from mitochondria, from microsomes, and more generally, from any other compartment, organelle, or portion of a cell. Permeabilizing agents that specifically target certain cell compartments and organelles can be used to selectively release analytes from cells for analysis, and/or allow access of one or more reagents (e.g., probes for analyte detection) to the analytes in the cell or cell compartment or organelle.

The analyte may include any biomolecule or chemical compound, including a macromolecule such as a protein or peptide, a lipid or a nucleic acid molecule, or a small molecule, including organic or inorganic molecules. The analyte may be a cell or a microorganism, including a virus, or a fragment or product thereof. An analyte can be any substance or entity for which a specific binding partner (e.g., an affinity binding partner) can be developed. Such a specific binding partner may be a nucleic acid probe (for a nucleic acid analyte) and may lead directly to the generation of a product. Alternatively, the specific binding partner may be coupled to a nucleic acid, which may be detected.

Analytes of particular interest may include nucleic acid molecules, such as DNA (e.g., genomic DNA, mitochondrial DNA, plastid DNA, viral DNA, etc.) and RNA (e.g., mRNA, microRNA, rRNA, snRNA, viral RNA, etc.), and synthetic and/or modified nucleic acid molecules, (e.g., including nucleic acid domains including or consisting of synthetic or modified nucleotides such as LNA, PNA, morpholino, etc.), proteinaceous molecules such as peptides, polypeptides, proteins or prions or any molecule which includes a protein or polypeptide component, etc., or fragments thereof, or a lipid or carbohydrate molecule, or any molecule which include a lipid or carbohydrate component. The analyte may be a single molecule or a complex that contains two or more molecular subunits, e.g., including but not limited to protein-DNA complexes, which may or may not be covalently bound to one another, and which may be the same or different. Thus, in addition to cells or microorganisms, such a complex analyte may also be a protein complex or protein interaction. Such a complex or interaction may thus be a homo- or hetero-multimer. Aggregates of molecules, e.g., proteins may also be target analytes, for example aggregates of the same protein or different proteins. The analyte may also be a complex between proteins or peptides and nucleic acid molecules such as DNA or RNA, e.g., interactions between proteins and nucleic acids, e.g., regulatory factors, such as transcription factors, and DNA or RNA.

### Endogenous Analytes

In some embodiments, an analyte herein is endogenous to a biological sample and can include nucleic acid analytes and non-nucleic acid analytes. Methods and compositions disclosed herein can be used to analyze nucleic acid analytes (e.g., using a nucleic acid probe or probe set that directly or indirectly hybridizes to a nucleic acid analyte) and/or non-nucleic acid analytes (e.g., using a labelling agent that includes a reporter oligonucleotide and binds directly or indirectly to a non-nucleic acid analyte) in any suitable combination.

Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral coat proteins, extracellular and intracellular proteins, antibodies, and antigen binding fragments.

Examples of nucleic acid analytes include DNA analytes such as single-stranded DNA (ssDNA), double-stranded DNA (dsDNA), genomic DNA, methylated DNA, specific methylated DNA sequences, fragmented DNA, mitochondrial DNA, in situ synthesized PCR products, and RNA/DNA hybrids. The DNA analyte can be a transcript of another nucleic acid molecule (e.g., DNA or RNA such as mRNA) present in a tissue sample.

Examples of nucleic acid analytes also include RNA analytes such as various types of coding and non-coding RNA. Examples of the different types of RNA analytes include messenger RNA (mRNA), including a nascent RNA, a pre-mRNA, a primary-transcript RNA, and a processed RNA, such as a capped mRNA (e.g., with a 5′ 7-methyl guanosine cap), a polyadenylated mRNA (poly-A tail at the 3′ end), and a spliced mRNA in which one or more introns have been removed. Also included in the analytes disclosed herein are non-capped mRNA, a non-polyadenylated mRNA, and a non-spliced mRNA. The RNA analyte can be a transcript of another nucleic acid molecule (e.g., DNA or RNA such as viral RNA) present in a tissue sample. Examples of a non-coding RNAs (ncRNA) that is not translated into a protein include transfer RNAs (tRNAs) and ribosomal RNAs (rRNAs), as well as small non-coding RNAs such as microRNA (miRNA), small interfering RNA (siRNA), Piwi-interacting RNA (piRNA), small nucleolar RNA (snoRNA), small nuclear RNA (snRNA), extracellular RNA (exRNA), small Cajal body-specific RNAs (scaRNAs), and the long ncRNAs such as Xist and HOTAIR.

In some embodiments described herein, an analyte may be a denatured nucleic acid, wherein the resulting denatured nucleic acid is single-stranded. The nucleic acid may be denatured, for example, optionally using formamide, heat, or both formamide and heat. In some embodiments, the nucleic acid is not denatured for use in a method disclosed herein.

In certain embodiments, an analyte can be extracted from a live cell. Processing conditions can be adjusted to ensure that a biological sample remains live during analysis, and analytes are extracted from (or released from) live cells of the sample. Live cell-derived analytes can be obtained only once from the sample or can be obtained at intervals from a sample that continues to remain in viable condition.

Methods and compositions disclosed herein can be used to analyze any number of analytes. For example, the number of analytes that are analyzed can be at least about 2, at least about 3, at least about 4, at least about 5, at least about 6, at least about 7, at least about 8, at least about 9, at least about 10, at least about 11, at least about 12, at least about 13, at least about 14, at least about 15, at least about 20, at least about 25, at least about 30, at least about 40, at least about 50, at least about 100, at least about 1,000, at least about 10,000, at least about 100,000 or more different analytes present in a region of the sample or within an individual feature of the substrate.

In any embodiment described herein, the analyte includes a target sequence. In some embodiments, the target sequence may be endogenous to the sample, generated in the sample, added to the sample, or associated with an analyte in the sample. In some embodiments, the target sequence is a single-stranded target sequence (e.g., a sequence in a rolling circle amplification product). In some embodiments, the analytes include one or more single-stranded target sequences. In one aspect, a first single-stranded target sequence is not identical to a second single-stranded target sequence. In another aspect, a first single-stranded target sequence is identical to one or more second single-stranded target sequence. In some embodiments, the one or more second single-stranded target sequence is included in the same analyte (e.g., nucleic acid) as the first single-stranded target sequence. Alternatively, the one or more second single-stranded target sequence is included in a different analyte (e.g., nucleic acid) from the first single-stranded target sequence.

### Labelling Agents

In some embodiments, provided herein are methods and compositions for analyzing endogenous analytes (e.g., RNA, ssDNA, and cell surface or intracellular proteins and/or metabolites) in a sample using one or more labelling agents. In some embodiments, an analyte labelling agent may include an agent that interacts with an analyte (e.g., an endogenous analyte in a sample). In some embodiments, the labelling agents can include a reporter oligonucleotide that is indicative of the analyte or portion thereof interacting with the labelling agent. For example, the reporter oligonucleotide may include a barcode sequence that permits identification of the labelling agent. In some cases, the sample contacted by the labelling agent can be further contacted with a probe (e.g., a single-stranded probe sequence), that hybridizes to a reporter oligonucleotide of the labelling agent, in order to identify the analyte associated with the labelling agent. In some embodiments, the analyte labelling agent includes an analyte binding moiety and a labelling agent barcode domain including one or more barcode sequences, e.g., a barcode sequence that corresponds to the analyte binding moiety and/or the analyte. An analyte binding moiety barcode includes a barcode that is associated with or otherwise identifies the analyte binding moiety. In some embodiments, by identifying an analyte binding moiety by identifying its associated analyte binding moiety barcode, the analyte to which the analyte binding moiety binds can also be identified. An analyte binding moiety barcode can be a nucleic acid sequence of a given length and/or sequence that is associated with the analyte binding moiety. An analyte binding moiety barcode can generally include any of the variety of aspects of barcodes described herein.

In some embodiments, the method includes one or more post-fixing (also referred to as post-fixation) steps after contacting the sample with one or more labelling agents.

In the methods and devices described herein, one or more labelling agents capable of binding to or otherwise coupling to one or more features may be used to characterize analytes, cells and/or cell features. In some instances, cell features include cell surface features. Analytes may include, but are not limited to, a protein, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, a gap junction, an adherens junction, or any combination thereof. In some instances, cell features may include intracellular analytes, such as proteins, protein modifications (e.g., phosphorylation status or other post-translational modifications), nuclear proteins, nuclear membrane proteins, or any combination thereof.

In some embodiments, an analyte binding moiety may include any molecule or moiety capable of binding to an analyte (e.g., a biological analyte, e.g., a macromolecular constituent). A labelling agent may include, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. The labelling agents can include (e.g., are attached to) a reporter oligonucleotide that is indicative of the cell surface feature to which the binding group binds. For example, the reporter oligonucleotide may include a barcode sequence that permits identification of the labelling agent. For example, a labelling agent that is specific to one type of cell feature (e.g., a first cell surface feature) may have coupled thereto a first reporter oligonucleotide, while a labelling agent that is specific to a different cell feature (e.g., a second cell surface feature) may have a different reporter oligonucleotide coupled thereto. For a description of exemplary labelling agents, reporter oligonucleotides, and methods of use, see, e.g., U.S. Pat. No. 10,550,429; U.S. Pat. Pub. 20190177800; and U.S. Pat. Pub. 20190367969, which are each incorporated by reference herein in their entirety.

In some embodiments, an analyte binding moiety includes one or more antibodies or antigen binding fragments thereof. The antibodies or antigen binding fragments including the analyte binding moiety can specifically bind to a target analyte. In some embodiments, the analyte is a protein (e.g., a protein on a surface of the biological sample (e.g., a cell) or an intracellular protein). In some embodiments, a plurality of analyte labelling agents including a plurality of analyte binding moieties bind a plurality of analytes present in a biological sample. In some embodiments, the plurality of analytes includes a single species of analyte (e.g., a single species of polypeptide). In some embodiments in which the plurality of analytes includes a single species of analyte, the analyte binding moieties of the plurality of analyte labelling agents are the same. In some embodiments in which the plurality of analytes includes a single species of analyte, the analyte binding moieties of the plurality of analyte labelling agents are the different (e.g., members of the plurality of analyte labelling agents can have two or more species of analyte binding moieties, wherein each of the two or more species of analyte binding moieties binds a single species of analyte, e.g., at different binding sites). In some embodiments, the plurality of analytes includes multiple different species of analyte (e.g., multiple different species of polypeptides).

In other instances, e.g., to facilitate sample multiplexing, a labelling agent that is specific to a particular cell feature may have a first plurality of the labelling agent (e.g., an antibody or lipophilic moiety) coupled to a first reporter oligonucleotide and a second plurality of the labelling agent coupled to a second reporter oligonucleotide.

In some aspects, these reporter oligonucleotides may include nucleic acid barcode sequences that permit identification of the labelling agent which the reporter oligonucleotide is coupled to. The selection of oligonucleotides as the reporter may provide advantages of being able to generate significant diversity in terms of sequence, while also being readily attachable to most biomolecules, e.g., antibodies, etc., as well as being readily detected, e.g., using sequencing or array technologies.

Attachment (coupling) of the reporter oligonucleotides to the labelling agents may be achieved through any of a variety of direct or indirect, covalent or non-covalent associations or attachments. For example, oligonucleotides may be covalently attached to a portion of a labelling agent (such a protein, e.g., an antibody or antibody fragment) using chemical conjugation techniques (e.g., Lightning-Link® antibody labelling kits available from Innova Biosciences), as well as other non-covalent attachment mechanisms, e.g., using biotinylated antibodies and oligonucleotides (or beads that include one or more biotinylated linker, coupled to oligonucleotides) with an avidin or streptavidin linker. Antibody and oligonucleotide biotinylation techniques are available. See, e.g., Fang, et al., “Fluoride-Cleavable Biotinylation Phosphoramidite for 5′-end-Labelling and Affinity Purification of Synthetic Oligonucleotides,” Nucleic Acids Res. Jan. 15, 2003; 31(2):708-715, which is entirely incorporated herein by reference for all purposes. Likewise, protein and peptide biotinylation techniques have been developed and are readily available. See, e.g., U.S. Pat. No. 6,265,552, which is entirely incorporated herein by reference for all purposes. Furthermore, click reaction chemistry may be used to couple reporter oligonucleotides to labelling agents. Commercially available kits, such as those from Thunderlink and Abcam, and techniques common in the art may be used to couple reporter oligonucleotides to labelling agents as appropriate. In another example, a labelling agent is indirectly (e.g., via hybridization) coupled to a reporter oligonucleotide including a barcode sequence that identifies the label agent. For instance, the labelling agent may be directly coupled (e.g., covalently bound) to a hybridization oligonucleotide that includes a sequence that hybridizes with a sequence of the reporter oligonucleotide. Hybridization of the hybridization oligonucleotide to the reporter oligonucleotide couples the labelling agent to the reporter oligonucleotide. In some embodiments, the reporter oligonucleotides are releasable from the labelling agent, such as upon application of a stimulus. For example, the reporter oligonucleotide may be attached to the labeling agent through a labile bond (e.g., chemically labile, photolabile, thermally labile, etc.) as generally described for releasing molecules from supports elsewhere herein. In some instances, the reporter oligonucleotides described herein may include one or more functional sequences that can be used in subsequent processing, such as an adapter sequence, a unique molecular identifier (UMI) sequence, a sequencer specific flow cell attachment sequence (such as an P5, P7, or partial P5 or P7 sequence), a primer or primer binding sequence, a sequencing primer or primer binding sequence (such as an R1, R2, or partial R1 or R2 sequence).

In some cases, the labelling agent can include a reporter oligonucleotide and a label. A label can be fluorophore, a radioisotope, a molecule capable of a colorimetric reaction, a magnetic particle, or any other suitable molecule or compound capable of detection. The label can be conjugated to a labelling agent (or reporter oligonucleotide) either directly or indirectly (e.g., the label can be conjugated to a molecule that can bind to the labelling agent or reporter oligonucleotide). In some cases, a label is conjugated to a first oligonucleotide that is complementary (e.g., hybridizes) to a sequence of the reporter oligonucleotide.

In some embodiments, multiple different species of analytes (e.g., polypeptides) from the biological sample can be subsequently associated with the one or more physical properties of the biological sample. For example, the multiple different species of analytes can be associated with locations of the analytes in the biological sample. Such information (e.g., proteomic information when the analyte binding moiety(ies) recognizes a polypeptide(s)) can be used in association with other spatial information (e.g., genetic information from the biological sample, such as DNA sequence information, transcriptome information (i.e., sequences of transcripts), or both). For example, a cell surface protein of a cell can be associated with one or more physical properties of the cell (e.g., a shape, size, activity, or a type of the cell). The one or more physical properties can be characterized by imaging the cell. The cell can be bound by an analyte labelling agent including an analyte binding moiety that binds to the cell surface protein and an analyte binding moiety barcode that identifies that analyte binding moiety. Results of protein analysis in a sample (e.g., a tissue sample or a cell) can be associated with DNA and/or RNA analysis in the sample.

Products of Endogenous Analyte and/or Labelling Agent

In some embodiments, provided herein are methods and compositions for analyzing one or more products of an endogenous analyte and/or a labelling agent in a biological sample. In some embodiments, an endogenous analyte (e.g., a viral or cellular DNA or RNA) or a product (e.g., a hybridization product, a ligation product, an extension product (e.g., by a DNA or RNA polymerase), a replication product, a transcription/reverse transcription product, and/or an amplification product thereof is analyzed. In some aspects, the generation and/or processing of the analytes may be performed in the device and/or the analysis of the analytes may be performed in the device, such as by delivering reagents to a sample via a fluid source. For example, the generation, processing, and analysis may include but is not limited to reactions including hybridizations, ligations, binding, extension, amplifications, or other enzymatic reactions. In some embodiments, a labelling agent that directly or indirectly binds to an analyte in the biological sample is analyzed. In some embodiments, a product (e.g., a hybridization product, a ligation product, an extension product (e.g., by a DNA or RNA polymerase), a replication product, a transcription/reverse transcription product, and/or an amplification product of a labelling agent that directly or indirectly binds to an analyte in the biological sample is analyzed. In some embodiments, the reactions for generating any of the products (e.g., ligation, amplification, extension, hybridization) provided herein are performed in the devices provided herein.

### Hybridization

In some embodiments, a product of an endogenous analyte and/or a labelling agent is a hybridization product including the pairing of substantially complementary or complementary nucleic acid sequences within two different molecules, one of which is the endogenous analyte or the labelling agent (e.g., reporter oligonucleotide attached thereto). The other molecule can be another endogenous molecule or another labelling agent such as a probe. Pairing can be achieved by any process in which a nucleic acid sequence joins with a substantially or fully complementary sequence through base pairing to form a hybridization complex. For purposes of hybridization, two nucleic acid sequences are “substantially complementary” if at least 60% (e.g., at least 70%, at least 80%, or at least 90%) of their individual bases are complementary to one another.

Various probes and probe sets can be hybridized to an endogenous analyte and/or a labelling agent and each probe may include one or more barcode sequences. Exemplary barcoded probes or probe sets may be based on a padlock probe, a gapped padlock probe, a SNAIL (Splint Nucleotide Assisted Intramolecular Ligation) probe set, a PLAYR (Proximity Ligation Assay for RNA) probe set, a PLISH (Proximity Ligation in situ Hybridization) probe set, and RNA-templated ligation probes. The specific probe or probe set design can vary.

### Ligation

In some embodiments, a product of an endogenous analyte and/or a labelling agent is a ligation product. In some embodiments, the ligation product is formed between two or more endogenous analytes. In some embodiments, the ligation product is formed between an endogenous analyte and a labelling agent. In some embodiments, the ligation product is formed between two or more labelling agent. In some embodiments, the ligation product is an intramolecular ligation of an endogenous analyte. In some embodiments, the ligation product is an intramolecular ligation of a labelling agent, for example, the circularization of a circularizable probe or probe set upon hybridization to a target sequence. The target sequence can be included in an endogenous analyte (e.g., nucleic acid such as a genomic DNA or mRNA) or a product thereof (e.g., cDNA from a cellular mRNA transcript), or in a labelling agent (e.g., the reporter oligonucleotide) or a product thereof.

In some embodiments, the ligation involves chemical ligation. In some embodiments, the ligation involves template dependent ligation. In some embodiments, the ligation involves template independent ligation. In some embodiments, the ligation involves enzymatic ligation.

In some embodiments, the enzymatic ligation involves use of a ligase. In some aspects, the ligase used herein includes an enzyme that is commonly used to join polynucleotides together or to join the ends of a single polynucleotide. An RNA ligase, a DNA ligase, or another variety of ligase can be used to ligate two nucleotide sequences together. Ligases include ATP-dependent double-strand polynucleotide ligases, NAD-i-dependent double-strand DNA or RNA ligases and single-strand polynucleotide ligases, for example any of the ligases described in EC 6.5.1.1 (ATP-dependent ligases), EC 6.5.1.2 (NAD+-dependent ligases), EC 6.5.1.3 (RNA ligases). Specific examples of ligases include bacterial ligases such as E. coli DNA ligase, Tth DNA ligase, Thermococcus sp. (strain 9° N) DNA ligase (9° N™ DNA ligase, New England Biolabs), Taq DNA ligase, Ampligase™ (Epicentre Biotechnologies) and phage ligases such as T3 DNA ligase, T4 DNA ligase and T7 DNA ligase and mutants thereof. In some embodiments, the ligase is a T4 RNA ligase. In some embodiments, the ligase is a splintR ligase. In some embodiments, the ligase is a single stranded DNA ligase. In some embodiments, the ligase is a T4 DNA ligase. In some embodiments, the ligase is a ligase that has an DNA-splinted DNA ligase activity. In some embodiments, the ligase is a ligase that has an RNA-splinted DNA ligase activity.

In some embodiments, the ligation herein is a direct ligation. In some embodiments, the ligation herein is an indirect ligation. “Direct ligation” means that the ends of the polynucleotides hybridize immediately adjacently to one another to form a substrate for a ligase enzyme resulting in their ligation to each other (intramolecular ligation). Alternatively, “indirect” means that the ends of the polynucleotides hybridize non-adjacently to one another, i.e., separated by one or more intervening nucleotides or “gaps”. In some embodiments, said ends are not ligated directly to each other, but instead occurs either via the intermediacy of one or more intervening (so-called “gap” or “gap-filling” (oligo)nucleotides) or by the extension of the 3′ end of a probe to “fill” the “gap” corresponding to said intervening nucleotides (intermolecular ligation). In some cases, the gap of one or more nucleotides between the hybridized ends of the polynucleotides may be “filled” by one or more “gap” (oligo)nucleotide(s) which are complementary to a splint, padlock probe, or target nucleic acid. The gap may be a gap of 1 to 60 nucleotides or a gap of 1 to 40 nucleotides or a gap of 3 to 40 nucleotides. In specific embodiments, the gap may be a gap of about 1, 2, 3, 4, 5, 6, 7, 8, 9, or 10 or more nucleotides, of any integer (or range of integers) of nucleotides in between the indicated values. In some embodiments, the gap between said terminal regions may be filled by a gap oligonucleotide or by extending the 3′ end of a polynucleotide. In some cases, ligation involves ligating the ends of the probe to at least one gap (oligo)nucleotide, such that the gap (oligo)nucleotide becomes incorporated into the resulting polynucleotide. In some embodiments, the ligation herein is preceded by gap filling. In other embodiments, the ligation herein does not require gap filling.

In some embodiments, ligation of the polynucleotides produces polynucleotides with melting temperature higher than that of unligated polynucleotides. Thus, in some aspects, ligation stabilizes the hybridization complex containing the ligated polynucleotides prior to subsequent steps, including amplification and detection.

In some aspects, a high fidelity ligase, such as a thermostable DNA ligase (e.g., a Taq DNA ligase), is used. Thermostable DNA ligases are active at elevated temperatures, allowing further discrimination by incubating the ligation at a temperature near the melting temperature (Tm) of the DNA strands. This selectively reduces the concentration of annealed mismatched substrates (expected to have a slightly lower Tm around the mismatch) over annealed fully base-paired substrates. Thus, high-fidelity ligation can be achieved through a combination of the intrinsic selectivity of the ligase active site and balanced conditions to reduce the incidence of annealed mismatched dsDNA.

In some embodiments, the ligation herein is a proximity ligation of ligating two (or more) nucleic acid sequences that are in proximity with each other, e.g., through enzymatic means (e.g., a ligase). In some embodiments, proximity ligation can include a “gap-filling” step that involves incorporation of one or more nucleic acids by a polymerase, based on the nucleic acid sequence of a template nucleic acid molecule, spanning a distance between the two nucleic acid molecules of interest (see, e.g., U.S. Pat. No. 7,264,929, the entire contents of which are incorporated herein by reference). A wide variety of different methods can be used for proximity ligating nucleic acid molecules, including (but not limited to) “sticky-end” and “blunt-end” ligations. Additionally, single-stranded ligation can be used to perform proximity ligation on a single-stranded nucleic acid molecule. Sticky-end proximity ligations involve the hybridization of complementary single-stranded sequences between the two nucleic acid molecules to be joined, prior to the ligation event itself. Blunt-end proximity ligations generally do not include hybridization of complementary regions from each nucleic acid molecule because both nucleic acid molecules lack a single-stranded overhang at the site of ligation.

### Primer Extension and Amplification

In some embodiments, a product is a primer extension product of an analyte, a labelling agent, a probe or probe set bound to the analyte (e.g., a circularizable probe bound to genomic DNA, mRNA, or cDNA), or a probe or probe set bound to the labelling agent (e.g., a circularizable probe bound to one or more reporter oligonucleotides from the same or different labelling agents).

A primer is generally a single-stranded nucleic acid sequence having a 3′ end that can be used as a substrate for a nucleic acid polymerase in a nucleic acid extension reaction. RNA primers are formed of RNA nucleotides, and are used in RNA synthesis, while DNA primers are formed of DNA nucleotides and used in DNA synthesis. Primers can also include both RNA nucleotides and DNA nucleotides (e.g., in a random or designed pattern). Primers can also include other natural or synthetic nucleotides described herein that can have additional functionality. In some examples, DNA primers can be used to prime RNA synthesis and vice versa (e.g., RNA primers can be used to prime DNA synthesis). Primers can vary in length. For example, primers can be about 6 bases to about 120 bases. For example, primers can include up to about 25 bases. A primer, may in some cases, refer to a primer binding sequence. A primer extension reaction generally refers to any method where two nucleic acid sequences become linked (e.g., hybridized) by an overlap of their respective terminal complementary nucleic acid sequences (i.e., for example, 3′ termini). Such linking can be followed by nucleic acid extension (e.g., an enzymatic extension) of one, or both termini using the other nucleic acid sequence as a template for extension. Enzymatic extension can be performed by an enzyme including, but not limited to, a polymerase and/or a reverse transcriptase.

In some embodiments, a product of an endogenous analyte and/or a labelling agent is an amplification product of one or more polynucleotides, for instance, a circular probe or circularizable probe or probe set. In some embodiments, the amplifying is achieved by performing rolling circle amplification (RCA). In other embodiments, a primer that hybridizes to the circular probe or circularized probe is added and used as such for amplification. In some embodiments, the RCA includes a linear RCA, a branched RCA, a dendritic RCA, or any combination thereof.

In some embodiments, the amplification is performed at a temperature between or between about 20° C. and about 60° C. In some embodiments, the amplification is performed at a temperature between or between about 30° C. and about 40° C. In some aspects, the amplification step, such as the rolling circle amplification (RCA) is performed at a temperature between at or about 25° C. and at or about 50° C., such as at or about 25° C., 27° C., 29° C., 31° C., 33° C., 35° C., 37° C., 39° C., 41° C., 43° C., 45° C., 47° C., or 49° C.

In some embodiments, upon addition of a DNA polymerase in the presence of appropriate dNTP precursors and other cofactors, a primer is elongated to produce multiple copies of the circular template. This amplification step can utilize isothermal amplification or non-isothermal amplification.

### Target Sequences

A target sequence for a probe disclosed herein may be included in any analyte disclose herein, including an endogenous analyte (e.g., a viral or cellular nucleic acid), a labelling agent, or a product of an endogenous analyte and/or a labelling agent.

In some aspects, one or more of the target sequences includes one or more barcode(s), e.g., at least two, three, four, five, six, seven, eight, nine, ten, or more barcodes. Barcodes can spatially-resolve molecular components found in biological samples, for example, within a cell or a tissue sample. A barcode can be attached to an analyte or to another moiety or structure in a reversible or irreversible manner. A barcode can be added to, for example, a fragment of a deoxyribonucleic acid (DNA) or ribonucleic acid (RNA) sample before or during sequencing of the sample. Barcodes can allow for identification and/or quantification of individual sequencing-reads (e.g., a barcode can be or can include a unique molecular identifier or “UMI”). In some aspects, a barcode includes about 4, 5, 6, 7, 8, 9, 10, 11, 12, 13, 14, 15, 16, 17, 18, 19, 20, 21, 22, 23, 24, 25, 26, 27, 28, 29, 30, or more than 30 nucleotides.

In some embodiments, a barcode includes two or more sub-barcodes that together function as a single barcode. For example, a polynucleotide barcode can include two or more polynucleotide sequences (e.g., sub-barcodes) that are separated by one or more non-barcode sequences. In some embodiments, the one or more barcode(s) can also provide a platform for targeting functionalities, such as oligonucleotides, oligonucleotide-antibody conjugates, oligonucleotide-streptavidin conjugates, modified oligonucleotides, affinity purification, detectable moieties, enzymes, enzymes for detection assays or other functionalities, and/or for detection and identification of the polynucleotide.

In some embodiments, in a barcode sequencing method, barcode sequences are detected for identification of other molecules including nucleic acid molecules (DNA or RNA) longer than the barcode sequences themselves, as opposed to direct sequencing of the longer nucleic acid molecules. In some embodiments, a N-mer barcode sequence includes 4N complexity given a sequencing read of N bases, and a much shorter sequencing read may be required for molecular identification compared to non-barcode sequencing methods such as direct sequencing. For example, 1024 molecular species may be identified using a 5-nucleotide barcode sequence (45=1024), whereas 8 nucleotide barcodes can be used to identify up to 65,536 molecular species, a number greater than the total number of distinct genes in the human genome. In some embodiments, the barcode sequences contained in the probes or RCPs are detected, rather than endogenous sequences, which can be an efficient read-out in terms of information per cycle of sequencing. Because the barcode sequences are pre-determined, they can also be designed to feature error detection and correction mechanisms, see, e.g., U.S. Pat. Pub. 20190055594 and WO2019199579A1, which are hereby incorporated by reference in their entirety.

### Assays

The methods described herein may be useful for analysis methods in which specific reagents are added to a sample. In some embodiments, reagents are added to the sample in the device which include but are not limited to oligonucleotides (e.g., probes, dNTPs, primers), enzymes (e.g., endonucleases to fragment DNA, DNA polymerase enzymes, RNA polymerase, transposase, ligase, proteinase K, reverse transcriptase enzymes, including enzymes with terminal transferase activity, and DNAse), buffers and washes. In some embodiments, optical labels or dyes are added to the sample. In some embodiments, a sample can be collected from the device after performing steps of the assay described herein. In some embodiments, the device is used to perform or prepare sample for in situ analysis methods which include, e.g., in situ hybridization and in situ sequencing. In situ hybridization is a hybridization process in which labeled nucleic acids that are complementary to a specific nucleic acid (e.g., DNA or RNA) sequence in a biological sample hybridize to a portion or section of the sample (e.g., tissue) in which the nucleic acid is present. The methods described herein may be useful for array-based methods in which specific reagents are contacted with a sample. In some embodiments, the surface of the fluidic interface layer or substrate layer may have an array of bound reagents. In some embodiments, a device is used to deliver reagents to the sample which is deposited on the array.

The labeled nucleic acids, also referred to as probes, are generally short oligonucleotides in which at least a portion of the oligonucleotide is a reverse complement to a target nucleic acid of interest. The probes may include additional components in addition to the hybridization portion. For example, the probes may include additional sequences (e.g., barcode sequences), that are unique labels or identifiers to convey information about the nucleic acid being detected. The probes may further include a label attached thereto, directly or indirectly. The label may be, e.g., an optical label, a molecular label (e.g., an antigen), a radiolabel, or a field attractable label (e.g., electric or magnetic). In some embodiments the optical label is a fluorescent label, e.g., as used in fluorescence in situ hybridization (FISH). A fluorescent label can be detected by routine optical detection methods known in the art.

Optical detection may be performed by any detector capable of measuring light (e.g., the emitted, scattered, or attenuated light) from the label. Suitable detectors include, but are not limited to, a spectrometer, a light meter, a photometer, a photodiode, a photomultiplier tube, a CCD array, a CMOS sensor, or a photovoltaic device.

In situ methods may first include fixing and/or permeabilizing a biological sample (e.g., tissue). The biological sample may be provided in the device, e.g., on a substrate layer. The sample may be permeabilized by adding a fluid, such as a solvent (e.g., acetone and methanol) or a detergent (e.g., TRITON X-100, NP-40, TWEEN 20, saponin, digitonin, and Leucoperm), to the sample. Permeabilization may allow or enhance access of the probes for the intracellular space of the sample.

In some embodiments, a plurality of probes is used, e.g., for ease of detection and/or signal amplification, such as any probes described herein. For example, a first probe may include a nucleic acid sequence that hybridizes to a target nucleic acid in the sample. A secondary probe that includes a label (e.g., optical label, e.g., fluorescent label) may then be added that hybridizes to the first probe. In some embodiments, a plurality of secondary or higher order (e.g., tertiary, quaternary) detection probes are added. Each probe may be provided by a separate fluid source. Each probe may be provided by a single fluid source that includes a plurality of distinct probes.

When a probe that includes a detection label is added, the unbound probes with detection labels can be washed away and the signal can be detected, e.g., via fluorescence microscopy.

In some embodiments, the signal or template target nucleic acid is amplified. In some embodiments, an analyte (e.g., target nucleic acid) can be amplified using an enzyme, e.g., by polymerase chain reaction (PCR) or rolling circle amplification (RCA). The target nucleic acid may be replicated, e.g., by using the probe as a primer to initiate DNA or RNA synthesis. In such an embodiment, one or more fluids are added (e.g., sequentially) to the sample to provide the reagents for nucleic acid synthesis. Suitable reagents include, but are not limited to, probes, primers, nucleotide triphosphates (NTPs, e.g., dNTPs), sequencing terminators, dyes, polymerases, ligases, transcriptases (e.g., reverse transcriptases), labels, and the like.

In some embodiments, the methods described herein includes in situ sequencing or sequence detection. One such process includes temporal multiplexing of barcoded probes. In some embodiments, a primary probe or set of primary probes (e.g., 24 primary probes) hybridize to a target nucleic acid (e.g., mRNA) in the sample. Each probe may contain a barcode attached thereto. The barcodes may then be detected by contacting with one or more probes each labeled with a fluorescent label which emits a signal. Each round of barcoding may be initiated by flowing the desired probe from a new fluid source. The labels may be detected using different excitation wavelengths (e.g., 640 nm, 561 nm, or 488 nm) during different barcoding rounds. By compiling the spatiotemporal patterns of each fluorescent signal at a location, the unique set of ordered barcode sequences that corresponds to a particular gene can be determined. Such a method may allow multiplex sequencing of a large number of (e.g., of 100, 1,000, 10,000, or more) nucleic acids, e.g., up to 90,000 transcripts per cell. This method also allows for efficient quantification of low-copy number nucleic acids.

In some embodiments, the in situ detection and/or in situ sequencing is performed in three dimensions. In this embodiment, the biological sample may be sequence by using a probe that includes a unique gene identifier. The probe may be ligated, thereby allowing extension and amplification of the target sequence. In some embodiments, the amplification product can then be modified with a chemical moiety that polymerizes in the presence of a polymerization initiator. In some embodiments, an amplified product may be embedded within a polymerized matrix (e.g., a hydrogel), thereby creating spatially fixed three-dimensional target analytes of the biological sample.

In some embodiments, the in situ sequencing includes sequencing by ligation. In this embodiment, fluorescently labeled probes with two known bases followed by degenerate or universal bases hybridize to a temple. A ligase immobilizes the complex and the biological sample is imaged to detect the label on the probe. Following detection, the fluorophore is cleaved from the probe along with several bases, revealing a free 5′ phosphate. This process of hybridization, ligation, imaging, and cleavage can be repeating in multiple rounds, thereby allowing identification of, e.g., 2 out of every 5 bases. After a round of probe extension, all probes and anchors are removed and the cycle can begin again with an offset anchor, thus allowing sequencing of a new register of the target.

In another embodiment, sequencing by ligation includes labeled probes with a known base (e.g., A, C, T, or G) flanked on each side of the known base by degenerate or universal bases that hybridize to a template (e.g., three or four bases on each side). Each probe contains a different fluorescent label corresponding to each individual base. Each round of sequencing includes hybridizing a probe with a known base, ligation of the probe, detection, and optionally, cleavage of the fluorescent label. Sequencing can be performed in a plus or minus direction, and rounds of sequencing can begin again with an offset anchor, thus allowing sequencing of a new register of the target.

In some embodiments, detection of one or more analytes (e.g., protein analytes) can be performed using one or more analyte capture agents. In some embodiment, the devices described herein may include one or more analyte capture agents, e.g., an array of oligonucleotides. In some aspects, the array may include a bead array. As used herein, an “analyte capture agent” refers to an agent that interacts with an analyte (e.g., an analyte in a biological sample) and with a capture probe (e.g., a capture probe attached to a substrate or a feature) to identify the analyte. In some embodiments, the analyte capture agent includes: (i) an analyte binding moiety (e.g., that binds to an analyte), for example, an antibody or antigen-binding fragment thereof; (ii) analyte binding moiety barcode; and (iii) an analyte capture sequence. As used herein, the term “analyte binding moiety barcode” refers to a barcode that is associated with or otherwise identifies the analyte binding moiety. As used herein, the term “analyte capture sequence” refers to a region or moiety configured to hybridize to, bind to, couple to, or otherwise interact with a capture domain of a capture probe. In some cases, an analyte binding moiety barcode (or portion thereof) may be able to be removed (e.g., cleaved) from the analyte capture agent. Additional description of analyte capture agents can be found in Section (II)(b)(ix) of WO 2020/176788 and/or Section (II)(b)(viii) U.S. Patent Application Publication No. 2020/0277663.

There are at least two methods to associate a spatial barcode with one or more neighboring cells, such that the spatial barcode identifies the one or more cells, and/or contents of the one or more cells, as associated with a particular spatial location. One method is to promote analytes or analyte proxies (e.g., intermediate agents) out of a cell and towards a spatially-barcoded array (e.g., including spatially-barcoded capture probes). Another method is to cleave spatially-barcoded capture probes from an array and promote the spatially-barcoded capture probes towards and/or into or onto the biological sample.

In some cases, capture probes may be configured to prime, replicate, and consequently yield optionally barcoded extension products from a template (e.g., a DNA or RNA template, such as an analyte or an intermediate agent (e.g., a ligation product or an analyte capture agent), or a portion thereof), or derivatives thereof (see, e.g., Section (II)(b)(vii) of WO 2020/176788 and/or U.S. Patent Application Publication No. 2020/0277663 regarding extended capture probes). In some cases, capture probes may be configured to form ligation products with a template (e.g., a DNA or RNA template, such as an analyte or an intermediate agent, or portion thereof), thereby creating ligations products that serve as proxies for a template.

As used herein, an “extended capture probe” refers to a capture probe having additional nucleotides added to the terminus (e.g., 3′ or 5′ end) of the capture probe thereby extending the overall length of the capture probe. For example, an “extended 3′ end” indicates additional nucleotides were added to the most 3′ nucleotide of the capture probe to extend the length of the capture probe, for example, by polymerization reactions used to extend nucleic acid molecules including templated polymerization catalyzed by a polymerase (e.g., a DNA polymerase or a reverse transcriptase). In some embodiments, extending the capture probe includes adding to a 3′ end of a capture probe a nucleic acid sequence that is complementary to a nucleic acid sequence of an analyte or intermediate agent specifically bound to the capture domain of the capture probe. In some embodiments, the capture probe is extended using reverse transcription. In some embodiments, the capture probe is extended using one or more DNA polymerases. The extended capture probes include the sequence of the capture probe and the sequence of the spatial barcode of the capture probe.

In some embodiments, extended capture probes are amplified (e.g., in bulk solution or on the array) to yield quantities that are sufficient for downstream analysis, e.g., via DNA sequencing. In some embodiments, extended capture probes (e.g., DNA molecules) act as templates for an amplification reaction (e.g., a polymerase chain reaction).

Additional variants of spatial analysis methods, including in some embodiments, an imaging step, are described in Section (II)(a) of WO 2020/176788 and/or U.S. Patent Application Publication No. 2020/0277663. Analysis of captured analytes (and/or intermediate agents or portions thereof), for example, including sample removal, extension of capture probes, sequencing (e.g., of a cleaved extended capture probe and/or a cDNA molecule complementary to an extended capture probe), sequencing on the array (e.g., using, for example, in situ hybridization or in situ ligation approaches), temporal analysis, and/or proximity capture, is described in Section (II)(g) of WO 2020/176788 and/or U.S. Patent Application Publication No. 2020/0277663. Some quality control measures are described in Section (II)(h) of WO 2020/176788 and/or U.S. Patent Application Publication No. 2020/0277663.

Spatial information can provide information of biological and/or medical importance. For example, the methods and compositions described herein can allow for: identification of one or more biomarkers (e.g., diagnostic, prognostic, and/or for determination of efficacy of a treatment) of a disease or disorder; identification of a candidate drug target for treatment of a disease or disorder; identification (e.g., diagnosis) of a subject as having a disease or disorder; identification of stage and/or prognosis of a disease or disorder in a subject; identification of a subject as having an increased likelihood of developing a disease or disorder; monitoring of progression of a disease or disorder in a subject; determination of efficacy of a treatment of a disease or disorder in a subject; identification of a patient subpopulation for which a treatment is effective for a disease or disorder; modification of a treatment of a subject with a disease or disorder; selection of a subject for participation in a clinical trial; and/or selection of a treatment for a subject with a disease or disorder.

Spatial information can provide information of biological importance. For example, the methods and compositions described herein can allow for: identification of transcriptome and/or proteome expression profiles (e.g., in healthy and/or diseased tissue); identification of multiple analyte types in close proximity (e.g., nearest neighbor analysis); determination of up- and/or down-regulated genes and/or proteins in diseased tissue; characterization of tumor microenvironments; characterization of tumor immune responses; characterization of cells types and their co-localization in tissue; and identification of genetic variants within tissues (e.g., based on gene and/or protein expression profiles associated with specific disease or disorder biomarkers).

Typically, for spatial array-based methods, a substrate layer (e.g., as described herein) functions as a support for direct or indirect attachment of capture probes to features of the array. A “feature” is an entity that acts as a support or repository for various molecular entities used in spatial analysis. In some embodiments, some or all of the features in an array are functionalized for analyte capture. Exemplary substrates are described in Section (II)(c) of WO 2020/176788 and/or U.S. Patent Application Publication No. 2020/0277663. Exemplary features and geometric attributes of an array can be found in Sections (II)(d)(i), (II)(d)(iii), and (II)(d)(iv) of WO 2020/176788 and/or U.S. Patent Application Publication No. 2020/0277663.

Generally, analytes and/or intermediate agents (or portions thereof) can be captured when contacting a biological sample with a substrate including capture probes (e.g., a substrate with capture probes embedded, spotted, printed, fabricated on the substrate, or a substrate with features (e.g., beads, wells) including capture probes). As used herein, “contact,” “contacted,” and/or “contacting,” a biological sample with a substrate refers to any contact (e.g., direct or indirect) such that capture probes can interact (e.g., bind covalently or non-covalently (e.g., hybridize)) with analytes from the biological sample. Capture can be achieved actively (e.g., using electrophoresis) or passively (e.g., using diffusion). Analyte capture is further described in Section (II)(e) of WO 2020/176788 and/or U.S. Patent Application Publication No. 2020/0277663.

In some cases, spatial analysis can be performed by attaching and/or introducing a molecule (e.g., a peptide, a lipid, or a nucleic acid molecule) having a barcode (e.g., a spatial barcode) to a biological sample (e.g., to a cell in a biological sample). In some embodiments, a plurality of molecules (e.g., a plurality of nucleic acid molecules) having a plurality of barcodes (e.g., a plurality of spatial barcodes) are introduced to a biological sample (e.g., to a plurality of cells in a biological sample) for use in spatial analysis. In some embodiments, after attaching and/or introducing a molecule having a barcode to a biological sample, the biological sample can be physically separated (e.g., dissociated) into single cells or cell groups for analysis. Some such methods of spatial analysis are described in Section (III) of WO 2020/176788 and/or U.S. Patent Application Publication No. 2020/0277663.

In some embodiments, the macromolecular components (e.g., analytes) of individual biological samples (e.g., cells) can be identified or detected with unique identifiers (e.g., barcodes) such that upon characterization of those macromolecular components, such that any given component (e.g., bioanalyte) may be traced to the biological sample (e.g., cell) from which it was obtained. The ability to attribute characteristics to individual biological samples or groups of biological samples is provided by the assignment of unique identifiers specifically to an individual biological sample or groups of biological samples. Unique identifiers, for example, in the form of nucleic acid barcodes, can be assigned or associated with individual biological samples (e.g., cells) or populations of biological samples (e.g., cells), or genes (e.g., mRNA transcripts, in order to tag or label the biological sample's macromolecular components (and as a result, its characteristics) with the unique identifiers. These unique identifiers can then be used to attribute the biological sample's components and characteristics to an individual biological sample or group of biological samples.

In some aspects, the unique identifiers are provided in the form of oligonucleotides that include nucleic acid barcode sequences that may be attached to or otherwise associated with the nucleic acid contents of individual biological sample, or to other components of the biological sample, and particularly to fragments of those nucleic acids.

The nucleic acid barcode sequences can include from 6 to about 20 or more nucleotides within the sequence of the oligonucleotides. In some cases, the length of a barcode sequence may be 6, 7, 8, 9, 10, 11, 12, 13, 14, 15, 16, 17, 18, 19, 20 nucleotides or longer. In some cases, the length of a barcode sequence may be at least 6, 7, 8, 9, 10, 11, 12, 13, 14, 15, 16, 17, 18, 19, 20 nucleotides or longer. In some cases, the length of a barcode sequence may be at most 6, 7, 8, 9, 10, 11, 12, 13, 14, 15, 16, 17, 18, 19, 20 nucleotides or shorter. These nucleotides may be completely contiguous, i.e., in a single stretch of adjacent nucleotides, or they may be separated into two or more separate subsequences that are separated by 1 or more nucleotides. In some cases, separated barcode subsequences can be from about 4 to about 16 nucleotides in length. In some cases, the barcode subsequence may be 4, 5, 6, 7, 8, 9, 10, 11, 12, 13, 14, 15, 16 nucleotides or longer. In some cases, the barcode subsequence may be at least 4, 5, 6, 7, 8, 9, 10, 11, 12, 13, 14, 15, 16 nucleotides or longer. In some cases, the barcode subsequence may be at most 4, 5, 6, 7, 8, 9, 10, 11, 12, 13, 14, 15, 16 nucleotides or shorter.

Moieties (e.g., oligonucleotides) used in the methods described herein can also include other functional sequences useful in processing of nucleic acids from biological samples contained in the droplet. These sequences include, for example, targeted or random/universal amplification primer sequences for amplifying the genomic DNA from the individual biological samples within the droplets while attaching the associated barcode sequences, sequencing primers or primer recognition sites, hybridization or probing sequences, e.g., for identification of presence of the sequences or for pulling down barcoded nucleic acids, or any of a number of other potential functional sequences.

The methods described herein may include providing molecular labels, e.g., via a fluid source. The molecular labels may include barcodes (e.g., nucleic acid barcodes). The molecular labels can be provided to the biological sample based on a number of different methods including, without limitation, microinjection, electroporation, liposome-based methods, nanoparticle-based methods, and lipophilic moiety-barcode conjugate methods. For instance, a lipophilic moiety conjugated to a nucleic acid barcode may be contacted with cells or particulate components of interest. The lipophilic moiety may insert into the plasma membrane of a cell thereby labeling the cell with the barcode. The devices and methods of the present disclosure may result in molecular labels being present on (i) the interior of a cell or particulate component and/or (ii) the exterior of a cell or particulate component (e.g., on or within the cell membrane). These and other suitable methods will be appreciated by those skilled in the art (see U.S. Pub. Nos. U.S. 20190177800, U.S. 20190323088, U.S. 20190338353, and U.S. 20200002763, each of which is incorporated herein by reference in its entirety).

In an example, a fluid is provided that includes large numbers of the above-described barcoded oligonucleotides releasably attached to a label. In some cases, a fluid will provide a diverse barcode sequence library that includes at least about 1,000 different barcode sequences, at least about 5,000 different barcode sequences, at least about 10,000 different barcode sequences, at least about 50,000 different barcode sequences, at least about 100,000 different barcode sequences, at least about 1,000,000 different barcode sequences, at least about 5,000,000 different barcode sequences, or at least about 10,000,000 different barcode sequences, or more.

Oligonucleotides may be releasable from the labels (e.g., optical label, e.g., fluorescent label) upon the application of a particular stimulus. In some cases, the stimulus may be a photo-stimulus, e.g., through cleavage of a photo-labile linkage that releases the oligonucleotides. In other cases, a thermal stimulus may be used, where increase in temperature will result in cleavage of a linkage or other release of the oligonucleotides from the label. In still other cases, a chemical stimulus is used that cleaves a linkage of the oligonucleotides to the label, or otherwise results in release of the oligonucleotides from the label, e.g., beads.

### Methods of Device Manufacture

The devices of the present disclosure may be fabricated in any of a variety of conventional ways. These structures may be fabricated in whole or in part from polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof.

A gasket of the present disclosure may be made in whole or in part from, e.g., a polymer, e.g., a silicone (e.g., silicone rubbers, e.g., PDMS), fluorosilicone, FKM, FFKM, COC elastomer, etc. The gasket may include an elastomeric polymer, e.g., be cut or formed from an elastomeric material, or precursors thereof, e.g., to allow the gasket to be compressible. A gasket may be a composite of compressible and incompressible materials, e.g., an elastomeric polymer bonded to a non-elastomeric polymer, e.g., formed by bonding (e.g., thermally or with adhesive) two or more materials together. Gaskets may include thermoset or thermoplastic polymers, or a combination thereof. A gasket may be coated, e.g., to include a one-sided adhesive, a double-sided adhesive, a polymer coating, or a hydrophobic coating. A hydrophobic coating on the gasket may act to improve sealing (e.g., to prevent leaks), and/or to reduce adhesion between the gasket and the fluidic interface layer and/or substrate layer, e.g., to allow for easier removal.

A gasket of the disclosure may be formed in place on the fluidic interface layer. For example, a gasket may be printed in place, e.g., using screen printing, CNC controlled nozzle deposition, 3D printing of elastomers on the surface, UV curable processes (e.g., stereolithography), etc. In some embodiments, a gasket may be formed on the fluidic interface by dispensing beads of curable elastomers, e.g., moisture or UV curable elastomers, or, e.g., two-part RTV elastomers. In some embodiments, a gasket may be produced by laser cutting of a continuous gasket layer already laminated on to the substrate layer or fluidic interface layer.

The fluidic interface layer and substrate layers may be made in whole or in part from glass, polymer (e.g., polystyrene, polycarbonate, polyethylene terephthalate, polypropylene, polyethylene, PTFE, COC, PMMA, etc.), plastic, ceramic, metal, or a combination thereof. The fluidic interface may be constructed of multiple layers, e.g., a top layer and a bottom layer.

Polymeric device components may be fabricated using any of a number of processes including soft lithography, embossing techniques, micromachining, e.g., laser machining, or, in some aspects, injection molding of the layer components that include the defined channels as well as other structures, e.g., reservoirs, integrated functional components, etc. In such cases, a laminating layer may be adhered to the molded structured part through readily available methods, including thermal lamination, solvent based lamination, sonic welding, or the like.

As will be appreciated, structures included of inorganic materials also may be fabricated using known techniques. For example, structures such as channels or reservoirs may be micro-machined into surfaces or etched into the surfaces using standard photolithographic techniques. In some aspects, the devices or components thereof may be fabricated using three-dimensional printing techniques to fabricate the channel or other structures of the devices and/or their discrete components.

### Methods for Surface Modifications

The disclosure features methods for producing a flow device (e.g., a microfluidic device) that has a surface modification, e.g., a surface with a modified water contact angle. The methods may be employed to modify the surface of a device such that a liquid can “wet” the surface by altering the contact angle the liquid makes with the surface.

Devices to be modified with surface coating agents may be primed, e.g., pre-treated, before coating processes occur. In certain embodiments, the first contact angle is greater than the water contact angle of the primed surface. In other embodiments, the first contact angle is greater than the water contact angle of the device component surface. Thus, the method allows for the differential coating of surfaces within or on the device.

A surface may be primed by depositing a metal oxide onto it. Example metal oxides useful for priming surfaces include, but are not limited to, Al2O3, TiO2, SiO2, or a combination thereof. Other metal oxides useful for surface modifications are known in the art. The metal oxide can be applied to the surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al2O3 can be prepared on a surface by depositing trimethylaluminum (TMA) and water.

In some cases, the coating agent may create a surface that has a water contact angle greater than 90°, e.g., hydrophobic or fluorophillic, or may create a surface with a water contact angle of less than 90°, e.g., hydrophilic. For example, a fluorophillic surface may be created by flowing fluorosilane (e.g., H3FSi) through a primed device surface, e.g., a surface coated in a metal oxide. The priming of the surfaces of the device enhances the adhesion of the coating agents to the surface by providing appropriate surface functional groups. In some cases, the coating agent used to coat the primed surface may be a liquid reagent.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A device comprising:
a flow cell body comprising a bottom layer and a top layer defining a fluidic channel therebetween, the fluidic channel extending along the flow cell body and having an inlet at a first side of the flow cell body and an outlet at a second side of the flow cell body, and a central portion disposed therebetween, wherein the central portion has a height of about 20 μm to about 300 μm and a volume of about 50 μl to about 200 μl wherein the inlet has a first width;
a first reservoir disposed proximate to and in fluidic communication with the inlet, the first reservoir including at least one sidewall formed in a portion of the top layer of the flow cell body and defining an opening configured to receive at least one reagent, wherein the opening has a second width that is larger than the first width, wherein the first reservoir has a volume of about 1 ml to about 5 ml;
a second reservoir formed in the top layer, wherein the second reservoir comprises a base that is optically clear, wherein the second reservoir has a volume of about 0.2 ml to about 10 ml, wherein the base comprises an optically clear area of about 2 cm² to about 10 cm²; and
the bottom layer being configured to receive a substrate having a biological sample disposed thereon such that the biological sample is positioned within the central portion of the fluidic channel.

2. The device of claim 1, wherein at least a portion of the top layer of the flow cell body defines a planar surface.

3. The device of claim 1, wherein the base of the second reservoir defines a planar surface.

4. The device of claim 1, wherein the first reservoir is disposed above the inlet.

5. The device of claim 1, wherein a volume of the fluidic channel is about equal to a volume of the first reservoir.

6. The device of claim 1, wherein the reservoir is configured to at least partially receive a pipettor, the pipettor dispensing the at least one reagent.

7. The device of claim 1, wherein the outlet is disposed above the central portion of the fluidic channel.

8. The device of claim 1, wherein the outlet is oriented substantially parallel to the inlet.

9. The device of claim 1, wherein the outlet is horizontally aligned with the central portion of the fluidic channel.

10. The device of claim 1, wherein the top layer of the flow cell body is removably coupled to the bottom layer of the flow cell body.

11. The device of claim 1, further comprising a sensor disposed along the fluidic channel.

12. A system comprising:
a flow cell body comprising a bottom layer and a top layer defining a fluidic channel therebetween, the fluidic channel extending along the flow cell body and having an inlet at a first side of the flow cell body and an outlet at a second side of the flow cell body, and a central portion disposed therebetween, wherein the central portion has a height of about 20 μm to about 300 μm and a volume of about 50 μl to about 200 μl wherein the inlet has a first width;
a first reservoir disposed proximate to and in fluidic communication with the inlet, the first reservoir including at least one sidewall formed in a portion of the top layer of the flow cell body and defining an opening configured to receive at least one reagent, wherein the opening has a second width that is larger than the first width, wherein the first reservoir has a volume of about 1 ml to about 5 ml;
a second reservoir formed in the top layer, wherein the second reservoir comprises a base that is optically clear, wherein the second reservoir has a volume of about 0.2 ml to about 10 ml, wherein the base comprises an optically clear area of about 2 cm² to about 10 cm²; and
the bottom layer being configured to receive a substrate having a biological sample disposed thereon such that the biological sample is positioned within the central portion of the fluidic channel;
a reagent displacement mechanism configured to flow the at least one reagent from the inlet through the fluidic channel to the outlet.

13. The system of claim 12, further comprising a reagent dispensing mechanism configured to dispense the at least one reagent into the first reservoir.

14. The system of claim 13, wherein the reagent dispensing mechanism comprises a pipette.

15. The system of claim 12, wherein the reagent displacement mechanism comprises a peristaltic pump.

16. The system of claim 12, wherein the reagent displacement mechanism is disposed downstream from and in fluidic communication with the outlet.

17. The system of claim 12, wherein the reagent displacement mechanism includes a pivot table, the pivot table configured to incline the inlet of the flow cell body relative to the outlet of the flow cell body at an inclination angle, such that gravitational force assists the flow of the at least one reagent from the inlet to the outlet.

18. The system of claim 17, wherein the inclination angle is from about 0 degrees to about 90 degrees.

19. The system of claim 12, further comprising a waste container in fluidic communication with the reagent displacement mechanism, the waste container disposed downstream of the outlet and configured to receive the at least one reagent.

20. The system of claim 12, further comprising an imaging device comprising an objective lens, wherein the objective lens is configured to image the biological sample from above the flow cell body.
